(19) United States
(12) Patent Application Publication
(10) Pub. No.: US 2025/0030590 A1
(43) Pub. Date: Jan. 23, 2025

(54) APPARATUS AND METHOD FOR POSITIONING USING SEVERAL FREQUENCY COMPONENTS FOR UPLINK, DOWNLINK AND SIDELINK

(71) Applicant: Fraunhofer-Gesellschaft zur Förderung der angewandten Forschung e.V., München (DE)

(72) Inventors: Birendra GHIMIRE, Erlangen (DE); Mohammad ALAWIEH, Erlangen (DE); Ernst EBERLEIN, Großenseebach (DE); Norbert FRANKE, Erlangen (DE); Dietmar LIPKA, Erlangen (DE); Melanie LIPKA, Erlangen (DE); Bastian PERNER, Erlangen (DE)

(73) Assignee: Fraunhofer-Gesellschaft zur Förderung der angewandten Forschung e.V., München (DE)

(21) Appl. No.: 18/757,509

(22) Filed: Jun. 28, 2024

Related U.S. Application Data
(63) Continuation of application No. PCT/EP2022/087796, filed on Dec. 23, 2022.

(30) Foreign Application Priority Data
Dec. 29, 2021 (EP) 21218237.2

(51) Int. Cl. H04L 27/38; H04L 27/26

(52) U.S. Cl. CPC H04L 27/3818; H04L 27/2662

(57) ABSTRACT

An apparatus of a wireless communication system according to an embodiment is provided. For each frequency component of two or more frequency components, a transmitter of the wireless communication system is configured to transmit, within said frequency component, a transmit signal of said frequency component. A receiver of the wireless communication system is configured to receive, within said frequency component, the transmit signal of said frequency component, which has been transmitted by the transmitter, as a received signal of said frequency component. Each frequency component of the two or more frequency components represents a bandwidth limited signal, which comprises one or more signal portions, and which exhibits a center frequency, wherein the center frequency of each of the two or more frequency components is different from the center frequency of any other one of the two or more frequency components.

### CROSS-REFERENCE TO RELATED APPLICATIONS

This application is a continuation of copending International Application No. PCT/EP2022/087796, filed Dec. 23, 2022, which is incorporated herein by reference in its entirety, and additionally claims priority from European Application No. EP 21218237.2, filed Dec. 29, 2021, which is also incorporated herein by reference in its entirety.

The present invention relates to the field of wireless communication systems or networks, more specifically to an apparatus and a method for providing a modified OFDM frame structure.

### BACKGROUND OF THE INVENTION

FIG. 1A and FIG. 1B are schematic representations of an example of a terrestrial wireless network 100 including, as is shown in FIG. 1A, the core network and one or more radio access networks RAN₁, RAN₂, . . . RAN_{N} (RAN=Radio Access Network). FIG. 1A is a schematic representation of an example of a radio access network RANₙ that may include one or more base stations gNB₁ to gNB₅ (gNB=next generation Node B), each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT (Internet of Things) devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, (UE=User Equipment) also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 1122. The respective base stations gNB₁ to gNB₅ may be connected to the core network 102, e.g. via the S1 interface, via respective backhaul links 114₁ to 114₅, which are schematically represented in FIG. 1B by the arrows pointing to “core”. The core network 102 may be connected to one or more external networks. The external network may be the Internet or a private network, such as an intranet or any other type of campus networks, e.g. a private WiFi or 4G or 5G mobile communication system. Further, some or all of the respective base stations gNB₁ to gNB₅ may be connected, e.g. via the S1 or X2 interface or the XN interface in NR (New Radio), with each other via respective backhaul links 116₁ to 116₅, which are schematically represented in FIG. 1B by the arrows pointing to “gNBs”. A sidelink channel allows direct communication between UEs, also referred to as device-to-device, D2D (Device to Device), communication. The sidelink interface in 3GPP (3G Partnership Project) is named PC5 (Proximity-based Communication 5).

For data transmission a physical resource grid may be used. The physical resource grid may comprise a set of resource elements to which various physical channels and physical signals are mapped. For example, the physical channels may include the physical downlink, uplink and sidelink shared channels, PDSCH (Physical Downlink Shared CHannel), PUSCH (Physical Uplink Shared Channel), PSSCH (Physical Sidelink Shared Channel), carrying user specific data, also referred to as downlink, uplink and sidelink payload data, the physical broadcast channel, PBCH (Physical Broadcast Channel), carrying for example a master information block, MIB, and one or more of a system information block, SIB, one or more sidelink information blocks, SLIBs, if supported, the physical downlink, uplink and sidelink control channels, PDCCH (Physical Downlink Control Channel), PUCCH (Physical Uplink Control CHannel), PSCCH (Physical Sidelink Control Channel), the downlink control information, DCI, the uplink control information, UCI, and the sidelink control information, SCI, and physical sidelink feedback channels, PSFCH (Physical sidelink feedback channel), carrying PC5 feedback responses. Note, the sidelink interface may support a 2-stage SCI (Speech Call Items). This refers to a first control region comprising some parts of the SCI, and, optionally, a second control region, which comprises a second part of control information.

For the uplink, the physical channels may further include the physical random-access channel, PRACH (Packet Random Access Channel) or RACH (Random Access Channel), used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols (OFDM=Orthogonal Frequency-Division Multiplexing) depending on the cyclic prefix, CP, length. A frame may also include of a smaller number of OFDM symbols, e.g. when utilizing a shortened transmission time interval, sTTI (slot or subslot transmission time interval), or a mini-slot/non-slot-based frame structure comprising just a few OFDM symbols.

The wireless communication system may be any single-tone or multicarrier system using frequency-division multiplexing, like orthogonal frequency-division multiplexing, OFDM, or orthogonal frequency-division multiple access, OFDMA (Orthogonal frequency-division multiple access), or any other IFFT-based signal (IFFT=Inverse Fast Fourier Transformation) with or without CP, e.g. DFT-s-OFDM (DFT=discrete Fourier transform). Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1A and FIG. 1B may be a heterogeneous network having distinct overlaid networks, e.g., a network of macro cells with each macro cell including a macro base station, like base stations gNB₁ to gNB₅, and a network of small cell base stations, not shown in FIG. 1A and FIG. 1B, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1A and FIG. 1B, for example in accordance with the LTE-Advanced Pro standard or the 5G or NR, new radio, standard.

In mobile communication networks, for example in a network like that described above with reference to FIG. 1A and FIG. 1B, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, or roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

In a wireless communication network, like the one depicted in FIG. 1A and FIG. 1B, it may be desired to locate a UE with a certain accuracy, e.g., determine a position of the UE in a cell. Several positioning approaches are known, like satellite-based positioning approaches, e.g., autonomous and assisted global navigation satellite systems, A-GNSS, such as GPS, mobile radio cellular positioning approaches, e.g., observed time difference of arrival, OTDOA, and enhanced cell ID, E-CID, or combinations thereof.

FIG. 2 depicts a wireless communication system, in particular, a wireless positioning communication system. In FIG. 2, devices and different links between the devices of the wireless communication system are illustrated. A positioning application may, for example, estimate the distance (“range”) between two devices or may calculate the position in a local or global coordinate system. The current standards support ranging-based architectures (“multiRTT”) and TDOA (Time Difference of Arrival) architectures, where differences between TOA values estimated at different nodes are formed.

The Base station can wirelessly communicate and exchange messages with one or more UEs 104,108,109 and/or one or more reference devices 104. The Base stations can directly communicate and exchange information with other Base stations 106, 110, the other base station may be from the technology, and/or same or different generation or even a different technology. The mobile target UEs and/or reference devices (e.g., at a fixed location) may perform wireless signaling for the purpose of positioning or synchronization 112 to 116. The BS may include the distributed units connected via the F1 interface 106 to the respective central unit or BS, in turn or over a non-standard interface. Two central BS(s) may also be connected via the XN/X2 interface(s) or over a non-standard interface.

The network entity may be part of the core network includes the location management function, LMF, and the Access and Mobility Management Function, AMF, which communicate using the Network Layer Signaling protocol, NLs. The network entity may be part of the core network includes the location server communicating over a control or a user plane interface with the other entities and devices of the network.

For positioning and ranging, different concepts are known in the art. According to a Measurement of the distance between two devices by measurement of the time-of-flight between two devices. This can be performed by measurement of the round-trip-time (RTT), for example, using triangulation/trilateration, wherein the position of a device relative to other devices with known position (“anchors”) is calculated using “time-difference of arrival” (TDOA) method, or, for example, using an angle based method, wherein the position is derived from angle-of-arrival (AoA) or angle-of-departure (AoD) is measured or combinations of angle measurements and RTT/TDOA measurements.

For many applications the achieved accuracy with existing solutions or current standards may be not sufficient. The feasible accuracy may be a trade-off between needed resources (e.g., needed signal bandwidth and/or occupied resource elements), complexity (antenna array size for angle-based methods, for example) and latency (if many information has to be exchanged in a network and/or post-processing of the measured data (e.g. averaging or filtering) is needed.

The measurement of the distance between two devices (e.g. between BS and UE or between two UEs) is the basis for several positioning technologies, for example, for triangulation/trilateration based on RTT measurements. Moreover, a (low latency) “ranging” between two devices (1-dimensional distance determination) may, e.g., be sufficient for many applications, like automotive use cases or IoT applications.

In 5G, the transmit signals may, e.g., be optimized for auto-correlation properties. Examples for signals defined by 3GPP and supported by the 5G standards are, e.g., SRS, DL-PRS and CSI-RS, etc. In principle any transmit signal with known content can be used. Or it may be even possible to reconstruct transmitted signal by decoding and reencoding, if the error correction can correct transmission errors. The receiver calculates the channel response or the cross-correlation between the transmit signal and the received signal. The resulting cross-correlation represents convolution of the auto-correlation function of the (bandwidth limited) transmit signal with the channel impulse response. From the cross correlation the ToA, relative to a device clock, can be estimated.

Several concepts for the measurements of the distance between two devices are known.

A first example it the calculation of the distance between two devices using the position of each device and calculating the position difference. This method may suffer from the limited position accuracy of one or both devices.

Direct distance measurements may offer higher accuracy and lower latency.

For direct distance measurements, (passive) reflection (radar, optical systems using laser, etc.) may, e.g., be employed, wherein a signal transmitted from one device is reflected. From the time-of-arrival (ToA) of the reflected signal and time-of-transmit (ToT) of the transmitted signal the distance can be calculated.

Other approaches employ active reflectors. For many cases the reflected signal may be very weak. One possible solution is an “active reflector”. A first device transmits a signal. The second device receives this signal and retransmits the signal with a known delay. This known delay can be taken into account for the distance calculation.

A RTT (round trip time) procedure is standardized by 3GPP. A second device does not answer with a constant time-offset relative to the received signal and the return signal may be a different signal. Using observable timing of transmission and reception (e.g., timestamps) of both devices the ToT and ToA the time-of-flight can be calculated. An example is provided in TS38.305. FIG. 3 illustrates Time-of-Flight (ToF) measurements based on TS38.305.

For the measurements itself correlation techniques or measurement of the phase relationship between transmitted and reflected signal, etc. are state-of-the-art.

Beside the distance the (relative) angle of the other device may be of interest. This can be achieved by combining the distance measurements with the estimation of the angle-of-arrival (AoA) or the angle-of-departure (AoD).

The 3GPP standards support different methods for positioning, for example, Multi-RTT, OTDOA, UL-TDOA, etc. One or more devices may, e.g., transmit a reference signal. One or more receivers will receive the signal and determine the time-of-arrival (ToA) or the time-difference-of-arrival (TDOA). The sidelink is not specified to support positioning in 3GPP. Other systems, like Ultra-Wide-Band- (UWB-) based systems already implement ranging between user devices using wide bandwidth (e.g. 500 MHz and above) in one piece on a commercial basis.

An increase of accuracy for distance measurements can be achieved by an increase of carrier bandwidth, and/or by employing carrier aggregation, and/or by employing the carrier phase, and/or by combining two or more positioning techniques, such as angle-based technologies and time-of-arrival-based technologies.

Regarding the carrier bandwidth, for FR1 the standard supports up to 100 MHz for UL and DL, for FR2 the standard allows 800 MHz bandwidth (for UL and DL), and for SL the supported bandwidth is 40 MHz (see [Rel 16, TBC]).

When carrier aggregation is employed, several component carriers (CC) are used. The CC may be adjacent or not adjacent. The carrier may be coherent or non-coherent. Especially if the related base stations (BS) for each CC are co-located and/or the UE support higher bandwidth coherent transmission and/or reception is feasible. Using advanced synchronization technologies, the precise synchronization of several BS may be also feasible.

For improving the accuracy of distance measurements, the carrier phase can be taken into account. An example is given in [RedFIR]. This system calculated the complex valued correlation function. The phase of the correlation peak represents the phase relationship between the reference signal and the received signal [R1-1901186]. The system described in [RedFIR] applies a combination of correlation techniques and phase measurements. The detection of the ToA using correlation may provide a first ToA estimate. For further processing the phase of the correlation peak is taken into account.

In some applications, a measurement of a phase difference or the change of a phase difference between two antenna ports is conducted. A change of the phase difference of sequential (in time) measurements represents a position change. The phase difference of the signal arriving at different antennas represent the (relative) distance difference to the different antennas, and may, e.g., be employed for angle-estimation. FIG. 4 illustrates receiving phases due to different receive antenna positions. Using the phase difference between several (distributed) antennas directly for positioning is, for example, proposed by [Lipka. 2019]. Beamformer and AoA/AoD measurements are also based on the phase difference of signals for different antenna elements.

Instead of using a PN sequence or other sequences with good auto correlation properties a set of tones can also be transmitted. Generally speaking, the phase rotation from transmitter to the receiving antenna is depending on the signal frequency and the distance between the both nodes. So, one option is to use multiple frequencies (either distributed or a single signal with sufficient bandwidth) and exploit the received phases yielding information about the distance in wavelength, as can be seen in FIG. 7.

It is noted that the information in the above section is only for enhancing the understanding of the background of the invention and, therefore, it may comprise information that does not form conventional technology that is already known to a person of ordinary skill in the art.

It would be appreciated, if improved concepts for positioning in wireless communication systems would be provided.

### SUMMARY

An embodiment may have an apparatus of a wireless communication system, wherein, for each frequency component of two or more frequency components, a transmitter of the wireless communication system is configured to transmit, within said frequency component, a transmit signal of said frequency component, wherein the transmit signal is a reference signal or is a control signal or is a data signal or is a portion of the reference signal or of the control signal or of the data signal, and wherein a receiver of the wireless communication system is configured to receive, within said frequency component, the transmit signal of said frequency component, which has been transmitted by the transmitter, as a received signal of said frequency component, wherein each frequency component of the two or more frequency components represents a bandwidth limited signal, which includes one or more signal portions, and which exhibits a center frequency, wherein the center frequency of each of the two or more frequency components is different from the center frequency of any other one of the two or more frequency components, wherein the apparatus is configured to receive and/or to process and/or to transmit phase relationship information, wherein the phase relationship information includes information on a transmitter-specific phase relationship between the two or more frequency components and/or includes information on a receiver-specific phase relationship between the two or more frequency components, and wherein the apparatus is configured to use the phase-relationship information for determining positioning information, or is configured to report the phase-relationship information or information derived from the phase-relationship information to another apparatus of the wireless communication system for determining the positioning information; wherein the positioning information includes information on a distance and/or a distance change between the transmitter and the receiver and/or a position of the transmitter and/or a position of the receiver.

Another embodiment may have an apparatus of a wireless communication system, wherein the apparatus includes a transmitter, wherein, in each frequency component of two or more frequency components, the transmitter is configured to transmit a transmit signal in said frequency component, such that a receiver of the wireless communication system receives a signal as a received signal in said frequency component, wherein the received signal includes signal portions originating from the transmitting of the transmit signal in said frequency component by the transmitter, wherein each of the two or more frequency components is a bandwidth limited signal having a center frequency, wherein the center frequency of each of the two or more frequency components is different from the center frequency of any other one of the two or more frequency components, wherein the transmit signal is a reference signal or a control signal or a data signal, wherein the transmitter is configured to transmit phase-relationship information or information derived from the phase-relationship information to the receiver or to another apparatus of the wireless communication system for supporting to determine, at the other apparatus, information on a distance and/or a distance change between the transmitter and the receiver and/or a position of the transmitter and/or a position of the receiver; wherein the phase relationship information includes information on a transmitter-specific phase relationship between the two or more frequency components; or, if the phase-relationship information is not known, the phase relationship information includes one or more default values to indicate a default phase relationship or includes an indication that the phase-relationship information is not known.

According to another embodiment, a system may have: an first inventive apparatus, and a second inventive apparatus, wherein, in each frequency component of two or more frequency components, the second inventive apparatus is configured to transmit a transmit signal in said frequency component, and the first inventive apparatus is configured to receive a signal as a received signal in said frequency component, wherein the received signal includes signal portions originating from the transmitting of the transmit signal in said frequency component by the transmitter.

Another embodiment may have a method, wherein, for each frequency component of two or more frequency components, a transmitter of the wireless communication system transmits, within said frequency component, a transmit signal of said frequency component, wherein the transmit signal is a reference signal or is a control signal or is a data signal or is a portion of the reference signal or of the control signal or of the data signal, and wherein a receiver of the wireless communication system receives, within said frequency component, the transmit signal of said frequency component, which has been transmitted by the transmitter, as a received signal of said frequency component, wherein each frequency component of the two or more frequency components represents a bandwidth limited signal, which includes one or more signal portions, and which exhibits a center frequency, wherein the center frequency of each of the two or more frequency components is different from the center frequency of any other one of the two or more frequency components, wherein the method includes receiving and/or processing and/or transmitting phase relationship information, wherein the phase relationship information includes information on a transmitter-specific phase relationship between the two or more frequency components and/or includes information on a receiver-specific phase relationship between the two or more frequency components, and wherein the method includes using the phase-relationship information for determining positioning information, or includes reporting the phase-relationship information or information derived from the phase-relationship information to another apparatus of the wireless communication system for determining the positioning information; wherein the positioning information includes information on a distance and/or a distance change between the transmitter and the receiver and/or a position of the transmitter and/or a position of the receiver.

Another embodiment may have a method, wherein, in each frequency component of two or more frequency components, the method includes transmitting, by a transmitter, a transmit signal in said frequency component, such that a receiver of the wireless communication system receives a signal as a received signal in said frequency component, wherein the received signal includes signal portions originating from the transmitting of the transmit signal in said frequency component by the transmitter, wherein each of the two or more frequency components is a bandwidth limited signal having a center frequency, wherein the center frequency of each of the two or more frequency components is different from the center frequency of any other one of the two or more frequency components, wherein the transmit signal is a reference signal or a control signal or a data signal, wherein the method includes transmitting phase-relationship information or information derived from the phase-relationship information to the receiver or to another apparatus of the wireless communication system for supporting to determine, at the other apparatus, information on a distance and/or a distance change between the transmitter and the receiver and/or a position of the transmitter and/or a position of the receiver; wherein the phase relationship information includes information on a transmitter-specific phase relationship between the two or more frequency components; or, if the phase-relationship information is not known, the phase relationship information includes one or more default values to indicate a default phase relationship or includes an indication that the phase-relationship information is not known.

Another embodiment may have a non-transitory digital storage medium having a computer program stored thereon to perform any of the inventive methods, when said computer program is run by a computer.

An apparatus of a wireless communication system according to an embodiment is provided. For each frequency component of two or more frequency components, a transmitter of the wireless communication system is configured to transmit, within said frequency component, a transmit signal of said frequency component, wherein the transmit signal is a reference signal or is a control signal or is a data signal or is a portion of the reference signal or of the control signal or of the data signal. A receiver of the wireless communication system is configured to receive, within said frequency component, the transmit signal of said frequency component, which has been transmitted by the transmitter, as a received signal of said frequency component. Each frequency component of the two or more frequency components represents a bandwidth limited signal, which comprises one or more signal portions, and which exhibits a center frequency, wherein the center frequency of each of the two or more frequency components is different from the center frequency of any other one of the two or more frequency components. The apparatus is configured to receive and/or to process and/or to transmit phase relationship information, wherein the phase relationship information comprises information on a transmitter-specific phase relationship between the two or more frequency components and/or comprises information on a receiver-specific phase relationship between the two or more frequency components. Moreover, the apparatus is configured to use the phase-relationship information for determining positioning information, or is configured to report the phase-relationship information or information derived from the phase-relationship information to another apparatus of the wireless communication system for determining the positioning information. The positioning information comprises information on a distance and/or a distance change between the transmitter and the receiver and/or a position of the transmitter and/or a position of the receiver.

Moreover, an apparatus of a wireless communication system according to another embodiment is provided. The apparatus comprises a transmitter. In each frequency component of two or more frequency components, the transmitter is configured to transmit a first signal in said frequency component, such that a receiver of the wireless communication system receives a signal as a received signal in said frequency component. The received signal comprises signal portions originating from the transmitting of the first signal in said frequency component by the transmitter, wherein each of the two or more frequency components is a bandwidth limited signal having a center frequency, wherein the center frequency of each of the two or more frequency components is different from the center frequency of any other one of the two or more frequency components. The first signal is a reference signal or a control signal or a data signal. The transmitter is configured to transmit phase-relationship information or information derived from the phase-relationship information to the receiver or to another apparatus of the wireless communication system for supporting to determine, at the other apparatus, information on a distance and/or a distance change between the transmitter and the receiver and/or a position of the transmitter and/or a position of the receiver. The phase relationship information comprises information on a transmitter-specific phase relationship between the two or more frequency components; or, if the phase-relationship information is not known, the phase relationship information comprises one or more default values to indicate a default phase relationship or comprises an indication that the phase-relationship information is not known.

Furthermore, a method according to an embodiment is provided. For each frequency component of two or more frequency components, a transmitter of the wireless communication system transmits, within said frequency component, a transmit signal of said frequency component, wherein the transmit signal is a reference signal or is a control signal or is a data signal or is a portion of the reference signal or of the control signal or of the data signal, and wherein a receiver of the wireless communication system receives, within said frequency component, the transmit signal of said frequency component, which has been transmitted by the transmitter, as a received signal of said frequency component. Each frequency component of the two or more frequency components represents a bandwidth limited signal, which comprises one or more signal portions, and which exhibits a center frequency, wherein the center frequency of each of the two or more frequency components is different from the center frequency of any other one of the two or more frequency components. The method comprises receiving and/or processing and/or transmitting phase relationship information, wherein the phase relationship information comprises information on a transmitter-specific phase relationship between the two or more frequency components and/or comprises information on a receiver-specific phase relationship between the two or more frequency components. Moreover, the method comprises using the phase-relationship information for determining positioning information, or comprises reporting the phase-relationship information or information derived from the phase-relationship information to another apparatus of the wireless communication system for determining the positioning information; wherein the positioning information comprises information on a distance and/or a distance change between the transmitter and the receiver and/or a position of the transmitter and/or a position of the receiver.

Moreover, a method according to another embodiment is provided. In each frequency component of two or more frequency components, the method comprises transmitting, by a transmitter, a first signal in said frequency component, such that a receiver of the wireless communication system receives a signal as a received signal in said frequency component. The received signal comprises signal portions originating from the transmitting of the first signal in said frequency component by the transmitter. Each of the two or more frequency components is a bandwidth limited signal having a center frequency, wherein the center frequency of each of the two or more frequency components is different from the center frequency of any other one of the two or more frequency components, wherein the first signal is a reference signal or a control signal or a data signal. The method comprises transmitting phase-relationship information or information derived from the phase-relationship information to the receiver or to another apparatus of the wireless communication system for supporting to determine, at the other apparatus, information on a distance and/or a distance change between the transmitter and the receiver and/or a position of the transmitter and/or a position of the receiver. The phase relationship information comprises information on a transmitter-specific phase relationship between the two or more frequency components; or, if the phase-relationship information is not known, the phase relationship information comprises one or more default values to indicate a default phase relationship or comprises an indication that the phase-relationship information is not known.

Moreover, a computer program for implementing one of the above-described methods, when the computer program is executed by a computer or signal processor, is provided.

Regarding the usage of the carrier phase (see, e.g., [RedFIR] and [R1-1901186]), mainly the phase difference between receivers or received signals and/or phase changes are detected. Generally speaking, the phase represents the delay with a periodicity of the wavelength. Hence, phase only algorithms need complementary measurements to solve the ambiguity and/or advanced algorithms to solve this ambiguity. The effort depends also on the phase measurement accuracy. Furthermore, implementation effects (e.g., group delay of components) or frequency offsets may also impact the phase of the signal.

Accordingly, if the phase of the received signal is taken into account, the measured phase or phase difference (between frequency components) or the measured phase changes is/are a composite of propagation effects, the phase response characteristics of the transmitter and the phase response characteristics of the receiver. Furthermore, frequency offsets may cause a phase variation. Hence, the measured phase and phase changes may depend on movements of the transmitter and/or the receiver and/or frequency offsets and/or the characteristics of the transmitter, the characteristics of the receiver.

Using additional signaling may allow to compensate some of the effects.

Typically the transmitter and receiver can be characterized by the frequency response. The frequency response may include:
The magnitude versus frequency.
The phase or the group delay versus frequency.

According to embodiments, for the signaling the magnitude and/or phase and/or group delay may be normalized or given relative to a reference point. Examples are:
The phase response is given relative to the center frequency of a device.
The group delay variation relative to the center frequency of a device is given.
A phase or group delay variation relative to an ideal device with linear phase is reported.

Further particular embodiments are provided in the dependent claims.

### BRIEF DESCRIPTION OF THE DRAWINGS

Embodiments of the present invention will be detailed subsequently referring to the appended drawings, in which:

FIG. 1A and FIG. 1B illustrate schematic representations of an example of a terrestrial wireless network.

FIG. 2 illustrates a wireless communication positioning network.

FIG. 3 illustrates Time-of-Flight (ToF) measurements according the RTT method.

FIG. 4 illustrates receiving phases due to different receive antenna positions.

FIG. 5 illustrates an apparatus of a wireless communication system according to an embodiment.

FIG. 6 illustrates an apparatus of a wireless communication system according to another embodiment.

FIG. 7 illustrates three different receiving phases for three different frequency components each exhibiting a different center frequency.

FIG. 8A and FIG. 8B illustrate an example from a measurement for a non-ideal frequency response of a device, wherein FIG. 8A illustrates the magnitude of the measured frequency response, and FIG. 8B illustrates the phase deviation from a linear phase of the frequency response.

FIG. 9A and FIG. 9B illustrate an impact of manufacturing tolerances and/or a temperature impact on three units with identical designs, wherein FIG. 9A illustrates the magnitude of the measured frequency response, and

FIG. 9B illustrates the phase deviation from a linear phase of the frequency response for the three units.

FIG. 10A and FIG. 10B illustrate carrier aggregation of two 10 MHz carrier versus a wideband signal and one frequency component.

FIG. 11A and FIG. 11B illustrate an impact of the phase to the combined signal.

FIG. 12 illustrates example configurations for frequency allocation according to an embodiment.

FIG. 13A and FIG. 13B illustrates an example for a frequency response/correlation resulting from cyclic correlation according to an embodiment, wherein FIG. 13A illustrates the frequency response with respect to magnitude and phase in the frequency domain, and wherein FIG. 13B illustrates the correlation in the time domain.

FIG. 14 illustrates a zoom of the first arriving path of FIG. 13A and FIG. 13B according to an embodiment.

FIG. 15A and FIG. 15B illustrate the channel response with multipath according to an embodiment, wherein FIG. 15A depicts the frequency domain representation, and FIG. 15B depicts the time domain representation of the channel response.

FIG. 16A and FIG. 16B illustrate an I/Q diagram of the correlation function, wherein FIG. 16A depicts the no multipath scenario, and wherein FIG. 16B depicts the multipath scenario.

FIG. 17 illustrates an apparatus according to an embodiment comprising a receiver, wherein frequency components are combined using wideband demodulator.

FIG. 18 illustrates an apparatus according to another embodiment comprising a receiver, wherein frequency components are combined using two demodulators.

FIG. 19 illustrates an example for an allocation of two frequency components.

FIG. 20 illustrates a correlator output in a time domain according to an embodiment.

FIG. 21 illustrates a zoom of the correlation peak of FIG. 20 according to an embodiment.

FIG. 22 illustrates an example for the correlator output with a non-ideal combining in case of phase offsets.

FIG. 23A and FIG. 23B illustrate a correlation function of frequency components at an intermediate frequency, with a frequency component configuration of FIG. 19 according to an embodiment.

FIG. 24A and FIG. 24B illustrates a configuration with three frequency components according to an embodiment, wherein FIG. 24A depicts the frequency allocation, and wherein FIG. 24B depicts the correlation.

FIG. 25A and FIG. 25B illustrates a wideband carrier according to an embodiment, which is split in nine contiguous frequency components.

FIG. 26 illustrates an example for a frequency allocation pattern with frequency hopping/staggering according to an embodiment.

FIG. 27A and FIG. 27B illustrate a combined correlation with multipath according to an embodiment, wherein FIG. 27A depicts the frequency domain, and wherein FIG. 27B depicts the time domain.

FIG. 28 illustrates a zoom of the correlation peaks related to the expected time of arrival of the first arriving path according to an embodiment.

FIG. 29 illustrates an example for non-coherent combining according to an embodiment.

FIG. 30 illustrates a zoom into FIG. 29.

FIG. 31 illustrates a positioning procedure using multi-RTT as an example according to an embodiment.

FIG. 32 illustrates an example of a computer system on which units or modules as well as the steps of the methods described in accordance with the inventive approach may execute.

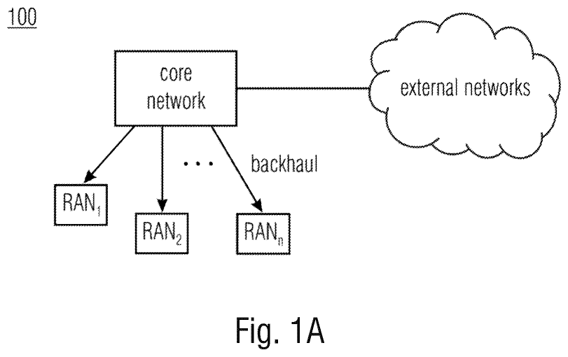

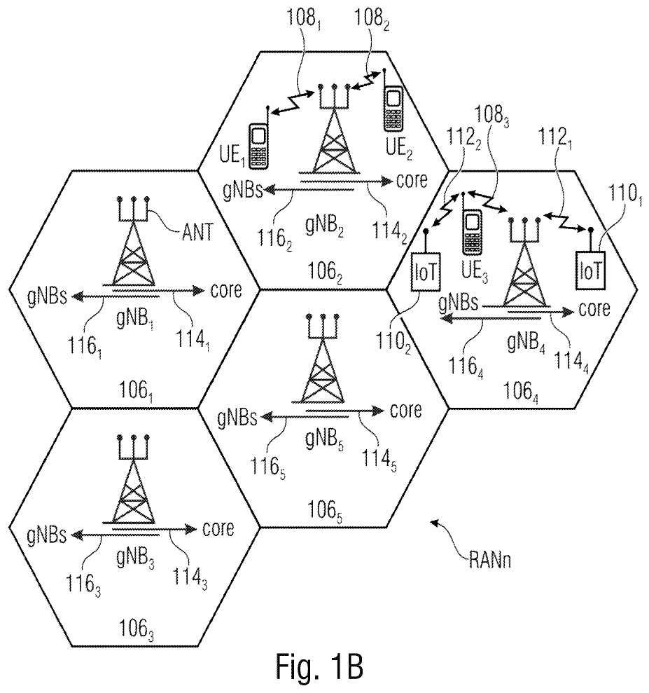

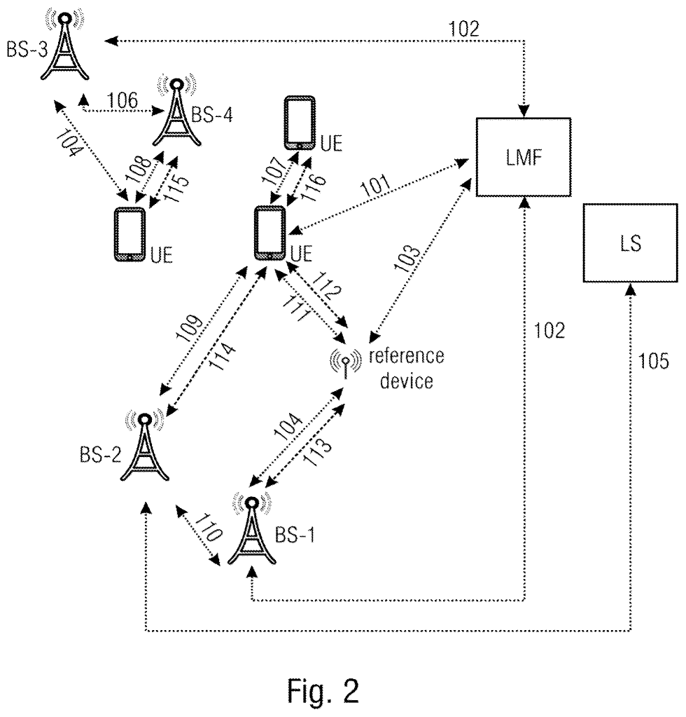

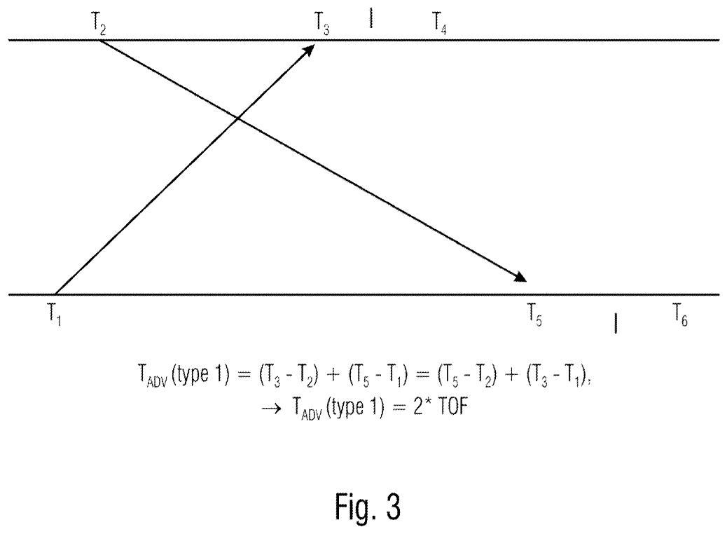

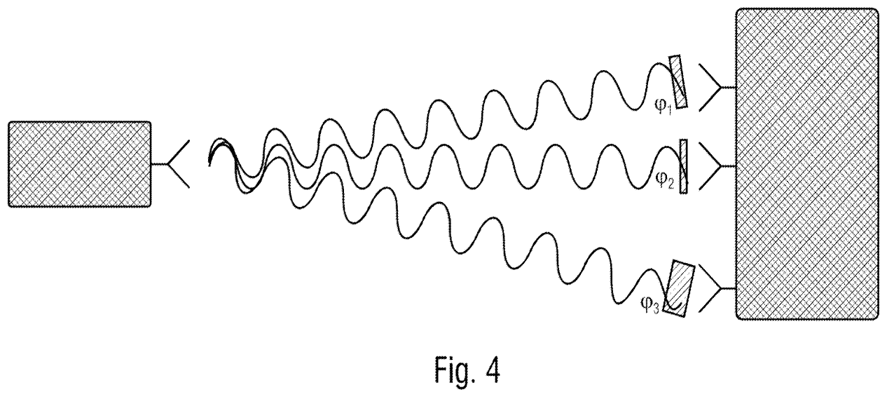

### DETAILED DESCRIPTION OF THE INVENTION

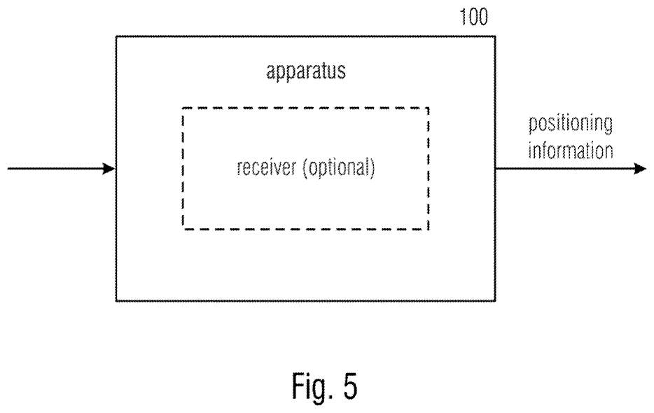

FIG. 5 illustrates an apparatus 100 of a wireless communication system.

For each frequency component of two or more frequency components, a transmitter of the wireless communication system is configured to transmit, within said frequency component, a transmit signal of said frequency component, wherein the transmit signal is a reference signal or is a control signal or is a data signal or is a portion of the reference signal or of the control signal or of the data signal. A receiver of the wireless communication system is configured to receive, within said frequency component, the transmit signal of said frequency component, which has been transmitted by the transmitter, as a received signal of said frequency component.

Each frequency component of the two or more frequency components represents a bandwidth limited signal, which comprises one or more signal portions, and which exhibits a center frequency, wherein the center frequency of each of the two or more frequency components is different from the center frequency of any other one of the two or more frequency components.

The apparatus 100 is configured to receive and/or to process and/or to transmit phase relationship information, wherein the phase relationship information comprises information on a transmitter-specific phase relationship between the two or more frequency components and/or comprises information on a receiver-specific phase relationship between the two or more frequency components.

Moreover, the apparatus 100 is configured to use the phase-relationship information for determining positioning information, or is configured to report the phase-relationship information or information derived from the phase-relationship information to another apparatus of the wireless communication system for determining the positioning information. The positioning information comprises information on a distance and/or a distance change between the transmitter and the receiver and/or a position of the transmitter and/or a position of the receiver.

According to an embodiment, the one or more signal portions of the frequency component of each of the two or more frequency components may, e.g., be a plurality of orthogonal signal portions of said frequency component which exhibit the center frequency of said frequency component.

According to an embodiment, the receiver may, e.g., be configured to receive the information on the transmitter-specific phase relationship from the transmitter.

In an embodiment, the receiver may, e.g., comprise a first receiver unit for receiving the received signal of each of the two or more frequency components, and may, e.g., comprise a second receiver unit for receiving the information on the transmitter-specific phase relationship. The second receiver unit may, e.g., also be configured to receive configuration and/or control information.

According to embodiments, different concepts may be considered for the reporting of the phase relationship information:

The phase relationship of two or more frequency components may depend on the building blocks of the transmitter and/or receiver. Assuming a frequency component represents a portion of the transmitted signal, the phase relationship between these portions may be provided as additional information. This phase relationship may be constant, may change slightly over time (e.g., a change of temperature or aging of the devices may cause changes).

It may also be possible that the frequency components may be transmitted by different RF chains or antennas. Accordingly, the frequency relationship may depend on the frequency offsets or angle-of-arrival (AoA) or angle-of-departure (AoD) of the signal. Accordingly the information may be constant, time variant or may depend on AoA or AoD of the signal.

The phase relationship information may be encoded as:
One phase value per frequency component, wherein the phase value may represent the mean value of the frequency response of the bandwidth limited signal.
Several phase values per frequency component.
Phase difference value between frequency components
One or several group delay values per frequency component
Group delay relative to a reference point, wherein the reference point may be the group delay of another frequency component.

Optionally, the phase or group delay can be also converted into a distance (or distance offset) taking into account the wavelength of the signal. A phase of 360 degree corresponds to a distance of a wavelength. An example is the “phase center information”. The phase center typically represents the effective position of the antenna. For non-ideal antennas the phase center for each frequency component may be different. Hence, it may be also possible to encode the phase relationship information as a position offset or a distance offset or as individual antenna position for each frequency component

In an embodiment, the information on the transmitter-specific phase relationship comprises transmitter status information, wherein the transmitter status information comprises at least one of:
information that the transmitter-specific phase relationship is not known and may change,
information that a phase difference between the two or more frequency components is not known, but is constant,
information that the phase difference between the two or more frequency components is known and constant and can be reported,
information that the phase difference between the two or more frequency components is known and may change versus time and can be reported,
information that the phase between the two or more frequency components is known and compensated before the transmit signal of the two or more frequency components leaves the transmitter,
information which indicates that the transmitter-specific phase relationship is defined by a transmit signal specification, if no compensation of the transmitter-specific phase relationship is needed.

According to an embodiment, the information on the receiver-specific phase relationship comprises receiver status information, wherein the receiver status information comprises at least one of:
information that the receiver-specific phase relationship is not known and may change,
information that a phase between the two or more frequency components is not known, but is constant,
information that the phase between the two or more frequency components is known and constant and can be reported,
information that the phase difference between the two or more frequency components is known and may change versus time and can be reported,
information that the phase difference between the two or more frequency components is known and is taken into account for further processing.

In an embodiment, the apparatus 100 may, e.g., be configured to report the receiver status information to another apparatus 100 of the wireless communication system.

According to an embodiment, the apparatus 100 may, e.g., be configured to determine a combined correlation depending on the transmit signal, depending on the received signal of each of the two or more frequency components, and depending on the phase relationship information. The apparatus 100 may, e.g., be configured to use the combined correlation for determining the positioning information, or is configured to report the combined correlation to the other apparatus of the wireless communication system for determining the positioning information.

In an embodiment, for each frequency component of the two or more frequency components, the apparatus 100 may, e.g., be configured to determine a phase-offset corrected version of the transmit signal and/or a phase-offset corrected version of the received signal of said frequency component depending on the phase relationship information. Furthermore, the apparatus 100 may, e.g., be configured to determine a transmit combination signal by summing the transmit signal or the phase-offset corrected version of the transmit signal of each of the two or more frequency components. Moreover, the apparatus 100 may, e.g., be configured to determine a receive combination signal by summing the received signal or the phase-offset corrected version of the received signal of each of the two or more frequency components. Furthermore, the apparatus 100 may, e.g., be configured to determine the combined correlation in the time domain or in the frequency domain by correlating the transmit combination signal and the receive combination signal.

According to an embodiment, for each frequency component of the two or more frequency components, the apparatus 100 may, e.g., be configured to determine a phase-offset corrected version of the transmit signal and/or a phase-offset corrected version of the received signal of said frequency component depending on the phase relationship information. Moreover, the apparatus 100 may, e.g., be configured to determine a correlation signal for said frequency component by correlating the transmit signal or the phase-offset corrected version of the transmit signal of said frequency component and the received signal or a phase-offset corrected version of said frequency component. Furthermore, the apparatus 100 may, e.g., be configured to determine the combined correlation in the time domain or in the frequency domain by summing or weighted summing the correlation signal of each of the two or more frequency components. Using a weighted sum may take into account different power levels of the signals in each frequency component.

In an embodiment, for each of the two or more frequency components, the apparatus 100 may, e.g., be configured to determine the correlation signal of said frequency component in a frequency domain such that said correlation signal comprises an indication of a phase response in the frequency domain.

According to an embodiment, for each of the two or more frequency components, the apparatus 100 may, e.g., be configured to calculate the correlation in the time domain or to transform the correlation signal of each of the two or more frequency components from the frequency domain to a time domain such that said correlation signal in the time domain comprises an indication of a channel response in the time domain.

In an embodiment, the apparatus 100 may, e.g., be configured to combine the correlation signals, being represented in the time domain, of the two or more frequency components to obtain the combined correlation.

In an embodiment, the apparatus 100 may, e.g., be configured to determine time-of-arrival information from the combined correlation being represented in the time domain by identifying a local maximum or a local minimum or a global maximum or a global minimum of the magnitude of the correlation signal, wherein the position of the local maximum or the local minimum depends on a time duration from a first point-in-time when the transmit signal of one of the two or more frequency components may, e.g., be transmitted by the transmitter until a second point-in-time when the received signal of said one of the two or more frequency components, which comprises the signal components originating from the transmission of said transmit signal in said frequency component, may, e.g., be received by the receiver.

According to an embodiment, the apparatus 100 may, e.g., be configured to determine time-of-arrival information from the combined correlation being represented in the time domain by conducting rising edge detection.

In an embodiment, the apparatus 100 may, e.g., be configured to use the combined correlation to determine the distance and/or the distance change between the transmitter and the receiver and/or the position of the transmitter and/or the position of the receiver.

According to an embodiment, if the transmitter-specific phase relationship may, e.g., be known or can be measured, the apparatus 100 may, e.g., be configured to receive phase information on the transmitter-specific phase relationship for at least one frequency component of the two or more frequency components from the transmitter.

In an embodiment, the phase information on the transmitter-specific phase relationship for the at least one frequency component comprises a phase difference between each of the at least one frequency component and another one of the two or more frequency components, or comprises a phase difference of each of the at least one frequency component and a predefined phase.

According to an embodiment, if the apparatus 100 does not receive the phase information, the apparatus 100 is configured to make the assumption that the received signal of the two or more frequency components are transmitted from a single antenna.

According to an embodiment, the phase information on the transmitter-specific phase relationship for the at least one frequency component varies over time. The phase information on the transmitter-specific phase relationship for the at least one frequency component comprises, for a plurality of points-in-time, more than one phase differences between each of the at least one frequency component and another one of the two or more frequency components, or comprises more than one phase differences of each of the at least one frequency component and a predefined phase.

In an embodiment, the apparatus 100 may, e.g., be configured to use the phase information on the transmitter-specific phase relationship to determine the correlation signal for at least one frequency component of the two or more frequency components.

According to an embodiment, if the receiver-specific phase relationship may, e.g., be known or can be measured, the apparatus 100 may, e.g., be configured to transmit the receiver-specific phase information for at least one frequency component of the two or more frequency components to the other apparatus of the wireless communication system for determining the positioning information.

In an embodiment, the phase information on the receiver-specific phase relationship for the at least one frequency component comprises a phase difference between each of the at least one frequency component and another one of the two or more frequency components, or comprises a phase difference of each of the at least one frequency component and a predefined phase.

According to an embodiment, the apparatus 100 may, e.g., be configured to use the phase information on the receiver-specific phase relationship to determine the correlation signal for at least one frequency component of the two or more frequency components and/or for generating the combined correlation for the two or more frequency components.

In an embodiment, to determine the positioning information, the apparatus 100 may, e.g., be configured to determine a time of arrival for each frequency component of the plurality of frequency components depending on the transmit signal or a phase-offset-corrected version of the transmit signal and depending on the received signal or a phase-offset-corrected version of the received signal of each of the two or more frequency components.

According to an embodiment, the apparatus 100 may, e.g., be configured determine the positioning information using the phase-relationship information.

In an embodiment, the apparatus 100 may, e.g., be configured to determine the distance and/or the distance change between the transmitter and the receiver and/or the position of the transmitter and/or the position of the receiver, by determining a first estimation thereof depending on a round trip time concept and by determining the distance and/or the distance change between the transmitter and the receiver and/or the position of the transmitter and/or the position of the receiver by using one or several frequency components or by using the combined version thereof.

For example, when time of arrival based concepts are employed, a plurality of measurements may, e.g., be conducted. In particular, in case of multipath, it may, e.g., be advantageous to conduct the measurements in a plurality of subbands and also in a wideband signal.

When, for example, distance change concepts are employed, it may, e.g., be sufficient to only determine the phase, and a narrowband signal may, for example, be sufficient to determine the phase.

According to an embodiment, the apparatus 100 comprises the receiver and may, e.g., be configured to receive a reporting on at least one of
capabilities with respect to a parallel transmission of the transmitter on at least two of the two or more frequency components,
capabilities for high accuracy frequency recovery and/or for achieving or for securing a stability of the transmitter
a frequency offset resulting from Doppler shift,
latency between an frequency component switching and a coherent timing maintenance,
support of parallel transmission of several sounding reference signals within one Orthogonal Frequency Division Multiplexing symbol, e.g., N-band transmissions.

The apparatus 100 may, e.g., be configured to determine the combined information depending on the reporting.

In an embodiment, the apparatus 100 may, e.g., comprise the receiver and may, e.g., not comprise the transmitter.

In an embodiment, the receiver may, e.g., comprise two or more oscillators. The phase relationship information may, e.g., comprise information on a receiver-specific phase relationship between the two or more oscillators of the receiver used to demodulate the two or more frequency components.

According to an embodiment, the apparatus 100 may, e.g., be a user equipment.

In an embodiment, the apparatus 100 may, e.g., comprise a transceiver, which may, e.g., comprise the receiver and another transmitter being different from said transmitter, wherein the other transmitter is configured for a plurality of transmission purposes.

For example, in an embodiment, the other transmitter may, e.g., be configured to transmit the phase-relationship information or the information derived from the phase-relationship information to another apparatus of the wireless communication system.

Or, for example, according to an embodiment, the other transmitter may, e.g., be configured to transmit another transmit signal to the receiver to allow or support positioning. The other transmit signal may, e.g., be a reference signal or may, e.g., be a control signal or may, e.g., be a data signal.

In an embodiment, the apparatus 100 may, e.g., be a location management server or is configured to implement a location management function.

According to an embodiment, the apparatus 100 may, e.g., be a base station.

In an embodiment, the apparatus 100 may, e.g., implement a subset of a base station, wherein the apparatus 100 may, e.g., implement one or more location measurement functions.

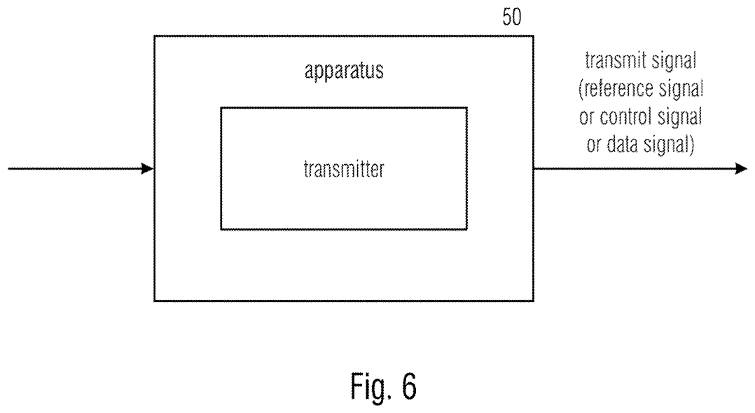

FIG. 6 illustrates an apparatus 50 of a wireless communication system according to another embodiment. The apparatus 50 comprises a transmitter.

In each frequency component of two or more frequency components, the transmitter is configured to transmit a transmit signal in said frequency component, such that a receiver of the wireless communication system receives a signal as a received signal in said frequency component. The received signal comprises signal portions originating from the transmitting of the transmit signal in said frequency component by the transmitter, wherein each of the two or more frequency components is a bandwidth limited signal having a center frequency, wherein the center frequency of each of the two or more frequency components is different from the center frequency of any other one of the two or more frequency components. The transmit signal is a reference signal or a control signal or a data signal.

The transmitter is configured to transmit phase-relationship information or information derived from the phase-relationship information to the receiver or to another apparatus of the wireless communication system for supporting to determine, at the other apparatus, information on a distance and/or a distance change between the transmitter and the receiver and/or a position of the transmitter and/or a position of the receiver.

The phase relationship information comprises information on a transmitter-specific phase relationship between the two or more frequency components; or, if the phase-relationship information is not known, the phase relationship information comprises one or more default values to indicate a default phase relationship or comprises an indication that the phase-relationship information is not known.

In an embodiment, if the apparatus 50 does not provide information on a synchronization status, the apparatus 50 is expected to have a single transmission antenna for the two or more frequencies. The assumption for a single-chain transmission architecture is that PRS/SRS resources to be aggregated are transmitted from a single transmission antenna.

According to an embodiment, the transmitter may, e.g., be configured to transmit the information on the transmitter-specific phase relationship to the receiver.

In an embodiment, the information on the transmitter-specific phase relationship comprises transmitter status information, wherein the transmitter status information comprises at least one of:
information that the transmitter-specific phase relationship may, e.g., be not known and may change,
information that a phase difference for the two or more frequency components is not known, but is constant,
information that the phase difference for the two or more frequency components is known and constant and can be reported,
information that the phase difference for the two or more frequency components is known and may change versus time and the phase relationship versus time may be reported,
information that the phase difference for the two or more frequency components is known and considered as nearly ideal and/or compensated before the transmit signal of the two or more frequency components leaves the transmitter.

According to an embodiment, if the transmitter-specific phase relationship may, e.g., be known or can be measured, the apparatus 50 may, e.g., be configured to transmit phase information on the transmitter-specific phase relationship for at least one frequency component of the two or more frequency components to the receiver.

In an embodiment, the phase information on the transmitter-specific phase relationship for the at least one frequency component comprises a phase difference between each of the at least one frequency component and another one of the two or more frequency components, or comprises a phase difference of each of the at least one frequency component and a predefined phase.

According to an embodiment, the phase information on the transmitter-specific phase relationship for the at least one frequency component varies over time. The phase information on the transmitter-specific phase relationship for the at least one frequency component comprises, for a plurality of points-in-time, more than one phase differences between each of the at least one frequency component and another one of the two or more frequency components, or comprises more than one phase differences of each of the at least one frequency component and a predefined phase.

In an embodiment, the apparatus 50 may, e.g., be a base station. The apparatus 50 comprises a transceiver, which comprises the transmitter and another receiver being different from the receiver. According to an embodiment, an apparatus 100 of FIG. 5 may, e.g., comprise the receiver.

In an embodiment, the apparatus 50 may, e.g., implement a subset of a base station, wherein the apparatus 50 may, e.g., implement one or more location measurement functions. The apparatus 50 may, e.g., comprise a transceiver, which comprises the transmitter and another receiver being different from the receiver.

According to an embodiment, the apparatus 50 may, e.g., be a user equipment.

In an embodiment, the apparatus 50 may, e.g., comprise a transceiver, which may, e.g., comprise the transmitter and another receiver being different from said receiver, wherein the other receiver is configured for a plurality of receiving purposes.

For example, according to an embodiment, the other receiver may, e.g., be configured to receive another transmit signal from the transmitter for positioning, wherein the other transmit signal is a reference signal or is a control signal or is a data signal.

In an embodiment, the transmitter may, e.g., comprise two or more oscillators. The transmitter may, e.g., be configured to report the transmitter-specific phase relationship between the two or more oscillators of the transmitter used to modulate the two or more frequency components to the receiver or to another apparatus of the wireless communication system.

In an embodiment, the transmit signal and the received signal of at least one of the two or more frequency components may, e.g., be a sounding reference signal or may, e.g., be a downlink positioning reference signal or may, e.g., be a channel state information reference signal.

According to an embodiment, the transmit signal of each of the two or more transmit signals may, e.g., be to be modulated by an Orthogonal Frequency Division Multiplexing modulator of the transmitter. The received signal of each of the two or more received signals may, e.g., be to be demodulated by an Orthogonal Frequency Division Multiplexing demodulator According to an embodiment, at least two frequency components of the two or more frequency components may, e.g., be assigned to at least two adjacent component carriers and each of the at least two adjacent component carriers may, e.g., comprise one or more of the at least two frequency components.

In an embodiment, at least one frequency component of the two or more frequency components may, e.g., be related to a not adjacent component carrier and the gap between the frequency components may, e.g., be assigned to other component carrier and may be used for other purpose. E.g., the gap between the frequency components is used for a purpose being different from a purpose for positioning.

According to an embodiment, the two or more frequency components are transmitted fully synchronized in frequency and phase.

In an embodiment, the two or more frequency components are not synchronized, or the two or more frequency components are partially synchronized, for example, only synchronized in frequency. For example, oscillator phase-noise may cause a fluctuating phase relationship such that synchronization may, in such situations, only be established with respect to frequency. E.g., oscillator-phase noise may, e.g., cause a fluctuating phase relationship on a transmitter side and/or on a receiver side.

According to an embodiment, a system may, e.g., be provided. The system comprises the apparatus 100 of FIG. 5 and the apparatus 50 of FIG. 6. In each frequency component of two or more frequency components, the apparatus 50 according of FIG. 6 may, e.g., be configured to transmit a transmit signal in said frequency component. The apparatus 100 of FIG. 5 may, e.g., be configured to receive a signal as a received signal in said frequency component, wherein the received signal comprises signal portions originating from the transmitting of the transmit signal in said frequency component by the transmitter.

In an embodiment, the apparatus 100 of FIG. 5 may, e.g., be a user equipment, and the apparatus 50 of FIG. 6 may, e.g., be a base station.

In an embodiment, the apparatus 100 of FIG. 5 may, e.g., be a base station, and the apparatus 50 of FIG. 6 may, e.g., be a user equipment.

According to an embodiment, the apparatus 100 of FIG. 5 may, e.g., be a first user equipment, and the apparatus 50 according of FIG. 6 may, e.g., be a second user equipment.

In an embodiment, the system further comprises a location management server or another apparatus implementing a location management function. The location management server or said other apparatus, which implements the location management function, may, e.g., be configured to request positioning information from the apparatus 100 of FIG. 5. Moreover, the apparatus 100 of FIG. 5 may, e.g., be configured to use the phase-relationship information for determining the positioning information, and may, e.g., be configured to transmit the positioning information to the location management server or to said other apparatus, which implements the location management function.

Embodiments of the present invention are now described in more detail with reference to the accompanying drawings, in which the same or similar elements have the same reference signs assigned.

At first, some considerations on which embodiments of the present invention are based are described.

Moreover, the receiving phases depend on the frequency of the frequency component.

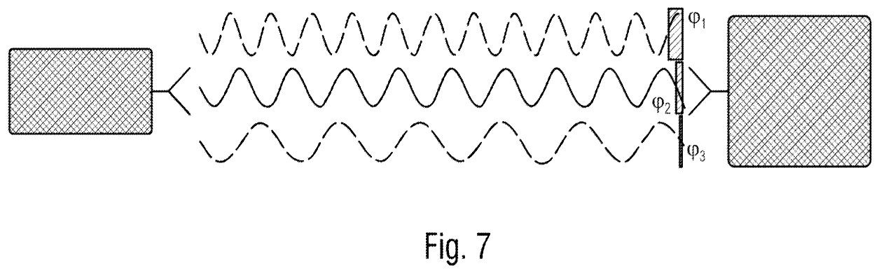

FIG. 7 illustrates three different receiving phases φ₁, φ₂, φ₃ for three different frequency components each exhibiting a different center frequency. The three different receiving phases are caused by the different frequencies of the three different frequency components.

Assuming a signal including several frequency components (FCs) is transmitted. For each FC the phase can be measured. The received phase φ_{RX,i} of a frequency component FCi is

$${φ}_{RX , i} = {φ}_{TX , i} - ( \frac{d}{{λ}_{i}} - ⌊ \frac{d}{{λ}_{i}} ⌋ ) \cdot 2 π$$

φ_{TX,i} is the phase of the FCi (e.g., relative to another FCi or to the mean over φ_{TX,i} of several FCi) at the output of the antenna of the transmitter
d is the distance between the device (the distance measurement applies to the “phase center” of the antenna)
λᵢ is the wavelength of the FCi

$$⌊ \frac{d}{{λ}_{i}} ⌋ = {n}_{i}$$

is an integer value representing the integer (rounded toward zero) number of wavelength periods

From the difference between φ_{TX,i} and φ_{RX,i} the distance d can be calculated with an ambiguity of nᵢ−λᵢ.

In embodiments, two or more different frequency components are used for distance measurement, wherein the different frequency components exhibit different wavelengths λᵢ. By a careful selection of the related carrier frequencies (e.g., by avoiding that a center frequency of a second selected frequency component is an exact integer multiple of a first selected integer multiple), the ambiguity can be solved or can at least be reduced. Hence, the distance can be calculated or a only reduced number of distance hypothesis remain.

The number of remaining hypotheses depends on the measurement accuracy of φ_{TX,i} and φ_{RX,i} and on the selection of the FC parameter (number of FCs, center frequencies of the FCs, etc.).

In general, combining two or more frequency components does not cause issues, if the two or more frequency components are fully coherent, the modulator and demodulator phases are linear and the related oscillators are fully locked such that a common phase ramp results. In that case, the two or more frequency components can be combined, for example added in the time domain or frequency domain.

However, usually, transmitting devices, more particularly, the components of a transmitting chain, and receiving devices, more particularly, the components of a receiving chain exhibit non-ideal, non-linear phase responses.

An example of the implementation effects is a non-ideal frequency recovery.

Moreover, importantly, another example for the implementation effects is that in case of phase based processing the phase offset relative to an (ideal) linear phase response becomes relevant.

Embodiments of the present invention provide a complementary reporting of correction factors for achieving to obtain a high accuracy of a positioning measurement. The correction factors may, for example, be derived from calibration measurements or may, for example, be derived from other measurements.

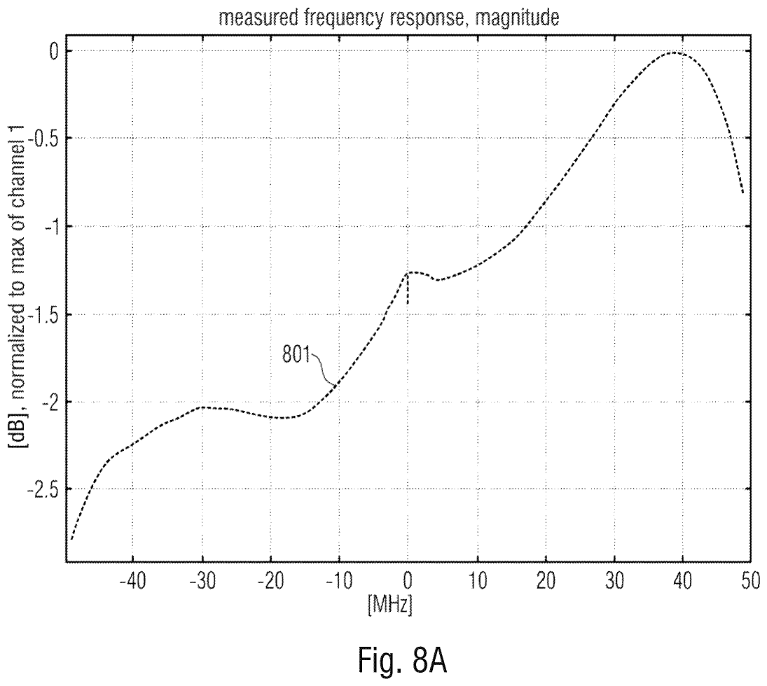

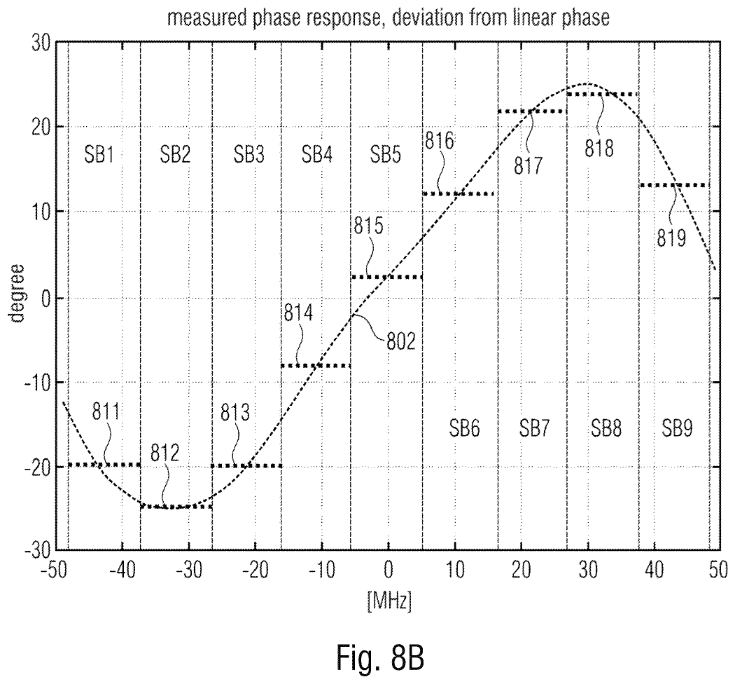

FIG. 8A and FIG. 8B illustrate an example from a measurement for a non-ideal frequency response of a device. In particular, FIG. 8A illustrates the magnitude of the measured frequency response, and FIG. 8B illustrates the phase deviation from a linear phase of the frequency response.

In particular, FIG. 8A and FIG. 8B depict the measured frequency response of an equipment supporting 100 MHz bandwidth. FIG. 8A shows the magnitude response 801, FIG. 8B shows the phase response 802, and the deviation of the phase from an ideal linear phase.

Assuming the bandwidth is split in nine equal subbands (SB 1, SB 2, SB 3, SB 4, SB 5, SB 6, SB 7, SB 8, SB 9), the effective average phase deviation (phase offset) per subband is indicated by dashes 811, 812, 813, 814, 815, 816, 817, 818, 819 in FIG. 8B. If only parts of the bandwidth are used a fully coherent combining is only feasible if the phase offset resulting from non-ideal implementation is taken into account.

The example given in FIG. 8A and FIG. 8B includes only effects until the antenna input. If also the antenna is taken into account further effects may result.

It may be difficult or even impossible to correct all effects before transmission. Embodiments of the present invention propose to report information on these effects, in particular, information on a phase offset, to the receiver, to compensate or to reduce or to at least take this effect into account for increasing the precision of positioning.

Beside the deviation resulting from the characteristic manufacturing tolerances and temperature drifts may become relevant.

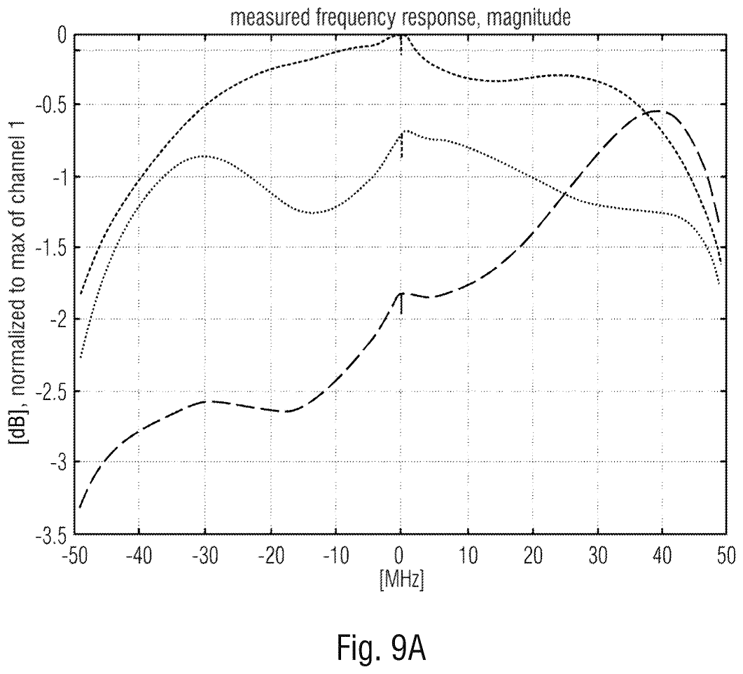

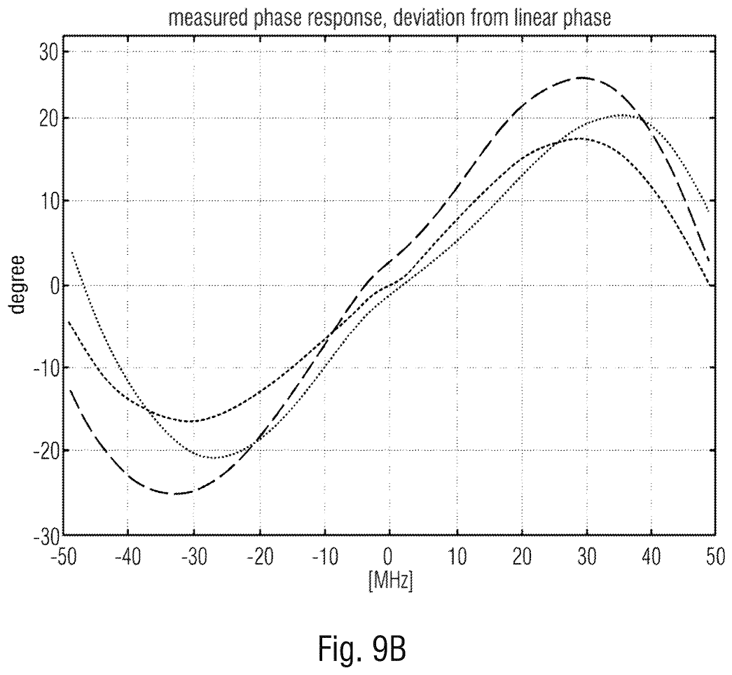

FIG. 9A and FIG. 9B illustrate an impact of manufacturing tolerances and/or a temperature impact on three units with identical designs, wherein FIG. 9A illustrates the magnitude of the measured frequency response, and FIG. 9B illustrates the phase deviation from a linear phase of the frequency response for the three units. The observed deviations result from manufacturing tolerances and/or temperature impact.

Summarizing the above, embodiments of the present invention are based on the finding that using different frequency components may allow to use the carrier phase for (e.g., one way) distance measurements. For many applications the distance is determined by round-trip measurements (a signal is transmitted in both direction). “One way” distance measurements means that a first device acts as transmitter and the second device can determine the distance without further data. For example, the receiver evaluates the relative phase of different frequency components (FCs) and derives from the relative phase the distance.

Moreover, embodiments are based on the finding that using two or more signals with limited bandwidth each, may provide similar resolution and accuracy as signal with high bandwidth. This may significantly reduce the needed resources per transmission. The spectrum useful for positioning reference signals may be “fragmented” and different parts (FCs) are jointly processed. Depending on the embodiments the FCs may be processed coherent or non-coherent.

Furthermore, if several FCs are used, the FCs can be combined and the resulting measured channel response may allow the estimation of the ToA with higher accuracy.

In embodiments, measurements per frequency component may, e.g., be reported

If the phase is used for positioning the frequency offset has a high impact to the phase. With appropriate measurements and reporting it may be possible to compensate these effects to allow a fully coherent combining of the signals transmitted sequentially.

Information may, e.g., be included or added in the reports defining the relationship. This additional relationship may include information such as, for example, “frequency coherence status” with the following meanings.

For example, information on the frequency coherence status may indicate that
the frequency components are transmitted non-coherent (e.g., the frequency recovery for each FC is independent and a unknown frequency offset between the FCs may result).
the frequency components are synchronized to a common frequency, but the phase relationship is unknown
the frequency components are fully synchronized and the phase relationship is known or the phase offset is compensated.

For example, if the frequency components are fully synchronized and the phase relationship is known by a transmitter, according to an embodiment, the transmitter may, for example, transmit the phase offsets for each frequency bands to the receiver such that the receiver can compensate the phase offsets.

E.g., in the example of FIG. 8B, the transmitter may, e.g., be configured to transmit a value indicating the average phase deviation/phase offset 811, 812, 813, 814, 815, 816, 817, 818, 819 for each of the nine subbands SB 1, SB 2, SB 3, SB 4, SB 5, SB 6, SB 7, SB 8, SB 9 may, e.g., be transmitter to the receiver.

In another example, the phase offset may, e.g., vary overtime. When the phase offset varies over time, the transmitter may, e.g., be configured to transmit a value indicating the average phase deviation/phase offset 811, 812, 813, 814, 815, 816, 817, 818, 819 for each of the nine subbands SB 1, SB 2, SB 3, SB 4, SB 5, SB 6, SB 7, SB 8, SB 9 may, e.g., be transmitter to the receiver for each point-in-time of a sequence of points-in-time.

Regarding the phase offsets, the face offsets for a particular device may, e.g., be determining by measuring the frequency response of the device after production, and the phase offsets may, e.g., be stored in a memory of the device.

Or, the phase offsets of at least one representative sample of the device may, e.g., be determined by measuring the frequency response of the device after production, and the phase offsets of the representative device may, e.g., be stored in other devices of the same type. Although using a representative device is not as exact as determining the phase offset for every single device individually, using a representative device is a more efficient approach for estimating the phase offsets, and still provides acceptable accuracy.

Another method may be the installation of reference transmitters or reference receivers. These reference transmitters or receivers may be at a known position and can be used to calibrate the measurements.

Furthermore, details on the (bandwidth limited) correlation functions may, for example, be reported. If the bandwidth of the frequency component is lower than the carrier bandwidth according to the Nyquist sampling theorem a reduced sampling frequency may, e.g., be used to represent the estimated (bandwidth limited) channel impulse response.

Phase values and phase offset values for the transmitter and for the receiver may, e.g., be measured relative to a reference frequency.

If the transmitter and receivers are not fully synchronized, e.g., a small frequency offset between transmitter and receiver may remain, and the phase difference can be used.

Instead of using the (absolute) phase, the phase difference φ_{RX,i}−φ_{RX,j} with i≠j between several φ_{RX,i} and a phase φ_{RX,j} of a first FC, which is used as reference, may, e.g., be calculated and, e.g., be reported. Instead of selecting one FC as reference, the mean value can, for example, be used.

The same principle can be applied to φ_{TX,j}, and the phase difference φ_{TX,i}−φ_{TX,j} with i≠j between several φ_{TX,i} and a phase φ_{TX,j} of a first FC, which is used as reference, may, e.g., be calculated and, e.g., be reported. Again instead of selecting one FC as reference, the mean value can, for example, be used.

Following from the above findings, in embodiments, several frequency components are used for positioning. The frequency components may, e.g., be different parts (e.g. BWP) of a wideband carrier, or may, e.g., be adjacent component carriers (CC) or parts of adjacent CC, or, may, e.g., be other CC (non-adjacent) or parts of it.

For each FC the “coherency status information” may, e.g., be provided. The indicated coherency status may, e.g., be at least one of the following:
frequency, time and phase coherent
frequency and time coherent
frequency coherent
no coherency or no coherency indicated

Moreover, the indicated coherency status may, e.g., comprise the coherency status between two or more DL-PRS reference signals and/or the coherency between two or more UL-PRS reference signals and/or coherency between two or more sidelink reference and/or any combination thereof. The configuration of reference signals may, e.g., be indicated by higher layer signaling, where the information is structured into hierarchical layers, where configuration information is provided by specifying in resource and resource sets.

Depending on the coherency status, further phase information (e.g. phase offsets between the FCs resulting from implementation) can be reported by the RX and/or TX.

For the FCs, separate reports or combined reports may, e.g., be provided.

The measurements for each FC may, e.g., be combined according the coherency status information.

The phase relationship for the transmitted signal may, e.g., be reported, if the transmitter knows or measures this relationship.

From the phase difference of several FCs (using different carrier frequencies and hence having different wavelength) the distance between the TX and RX can be estimated. For example, a one way ranger may, e.g., be implemented.

Depending on the phase measurement accuracy several hypotheses for the range may result. These hypotheses may, e.g., be resolved by using complementary measurements (e.g. ToA/TDOA measurements) or iterative decoding.

In some embodiments, the resolution may, e.g., be increased by combining several frequency components.

In general, increasing the bandwidth can be done in different ways.

For example, carriers with higher bandwidth may, e.g., be employed. E.g., the 5G standard supports for FR1 up to 100 MHz. An extension to higher bandwidth per carrier may, e.g., have a significant impact to the standard and related implementations. Furthermore, in many deployments the bandwidth licensed to one operator may be limited or the licensed spectrum may be non-contiguous or other constraints on the resource allocation may apply prohibiting the use of the full bandwidth of the carrier.

According to some embodiments, the bandwidth may, e.g., be increased using carrier aggregation. A transmitter and a receiver may, e.g., be employed which support higher bandwidth. Beside the impact to the hardware a full coordination of the scheduling of the slots used for wideband signals may, e.g., be employed.

In some embodiments, carrier aggregation of adjacent carriers may, e.g., be conducted. For example, the two or more adjacent carriers can be considered as one carrier with higher bandwidth, but each part can be decoded separately. Or, the adjacent carrier may, e.g., be implemented by two modulator/demodulator and the two modulator/demodulator are fully coherent. Or, the adjacent carrier may, e.g., be implemented by two modulator/demodulator and the modulator are not fully coherent According to some embodiments, carrier aggregation of a non-contiguous/“fragmented” spectrum may, e.g., be employed.

In an embodiment, a sequential transmission of signals with different center frequencies similar to frequency hopping may, e.g., be conducted.

In an embodiment, if the sum of the bandwidth of the frequency components and the gap between the components is lower than the supported bandwidth of the modulator/demodulator, and if the carriers are synchronized in frequency and framing, an utilization of a non-contiguous spectrum with one modulator/demodulator may, e.g., be employed. In other embodiments relating to other cases, it may, e.g., be assumed that for each frequency component a dedicated modulator/demodulator entity may be used. This does not exclude the sharing of processing resources like hardware accelerators. But the related scheduling of resources and synchronization status may, e.g., be independent, at least to a certain extent.

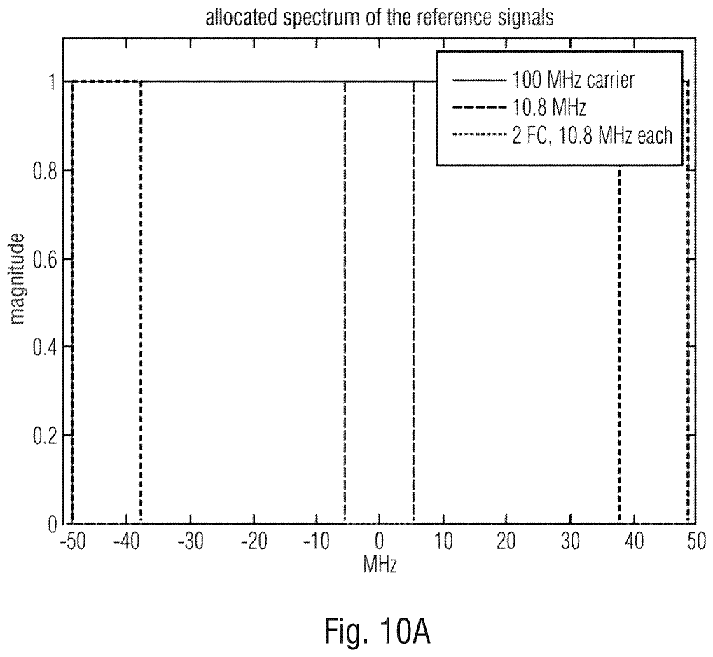

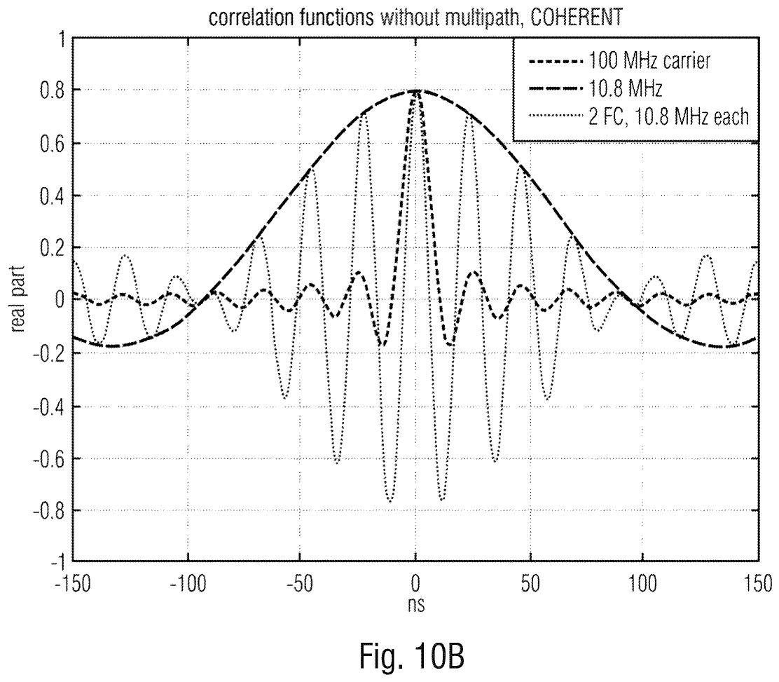

FIG. 10A and FIG. 10B illustrate carrier aggregation of two 10 MHz carrier versus a wideband signal and one 10 MHz carrier. In particular, FIG. 10A and FIG. 10B depict the allocated spectrum and the resulting correlation function assuming ideal propagation conditions.

In FIG. 10A and FIG. 10B, the correlation of the reference signal using two frequency components are combined assuming a perfect linear phase and ideal propagation conditions (no multipath). If the independent modulator/demodulator entities may, e.g., be used or the performance of the (analog) RF components are non-ideal the frequency response of the phase may be no longer linear (see FIG. 8A to FIG. 9B). This may have an impact to the combined signal.

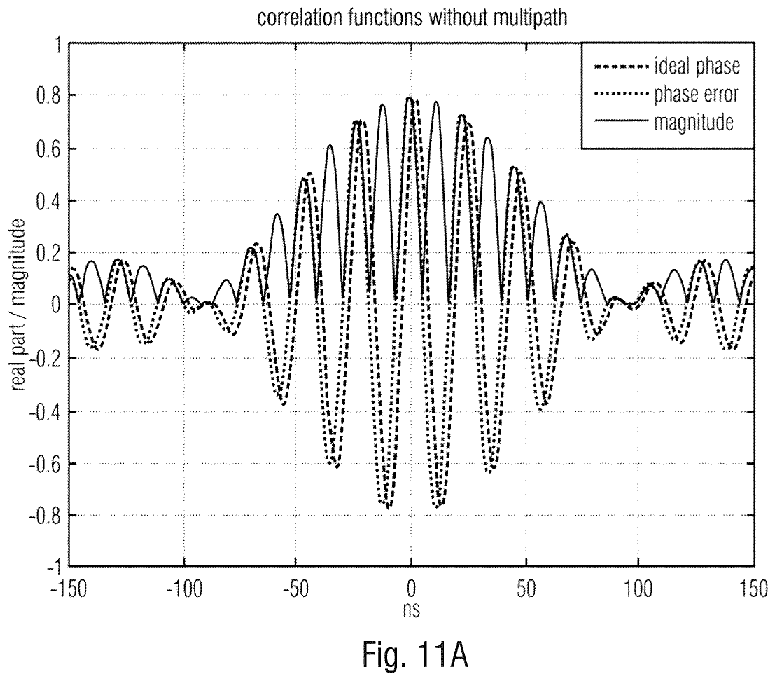

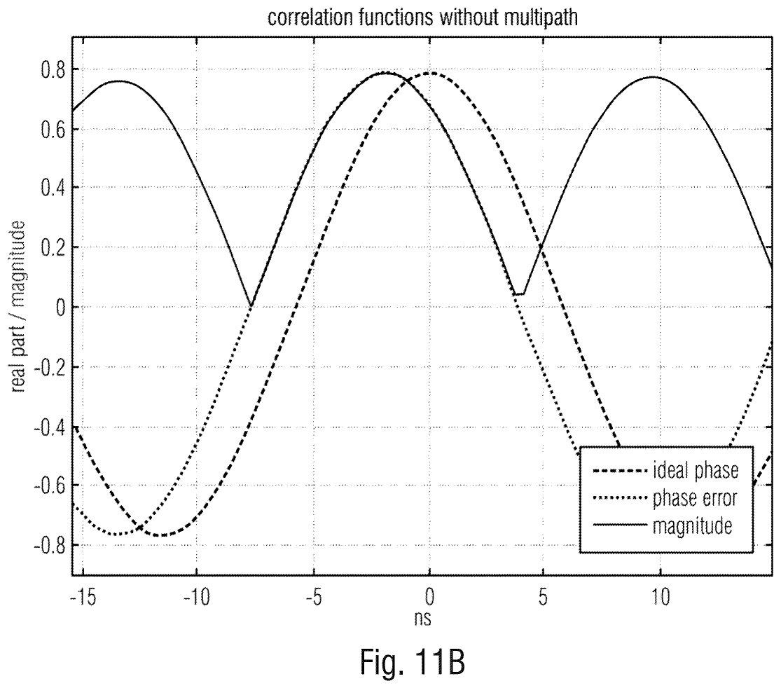

An example is provided in FIG. 11A and FIG. 11B. FIG. 11A and FIG. 11B illustrate an impact of the phase to the combined signal. In particular, FIG. 11B is a zoom of FIG. 11A. “0 ns” represents the true time-of-arrival. It is observed that the correlation peak of the combined correlation is no longer at the expected position represented by the correlation function generated for an ideal linear phase response. Moreover, it is noted that the correlation peak is shifted by app. 2.5 ns for the example. This is equivalent to a distance error of approximately 80 cm. Hence, if “cm accuracy” is targeted, the phase may, e.g., be taken into account for the combining of the signals.

Based on the above concepts, in some embodiments, a transmit signal comprises several FCs with different λᵢ.

According to some embodiments, each FC may be a bandwidth limited signal and λᵢ represents the mean wavelength of the signal with said bandwidth.

In some embodiments, the frequency components may, e.g., be
different parts of the (contiguous spectrum of) wideband signal (e.g., a 100 MHz 5G signal)
different bandwidth parts (BWPs) of a carrier, wherein the BWPs may non-contiguous parts of the spectrum of a wideband carrier
adjacent component carriers (or parts of it) synchronized to the same reference clock
different component carriers (CC) using non-contiguous spectrum, not synchronized or partly synchronized.

According to some embodiments, the TX signal(s) may, e.g., be designed to match the characteristics and constraints of a OFDM modulator in line with the 4G/5G standards.

In some embodiments, the phase values φ_{TX,i} of the transmitter may, e.g., be reported to the receiver or the φ_{TX,i} value is known by the receiver, and may, for example, be employed for “one way” ranging.

Different receiving algorithms and related reporting can be considered. For some embodiments, the phase values φ_{TX,i} of the transmitter may, e.g., be not required.

In the following, TX signal design and related reporting is discussed.

With respect to the type of TX signal, nearly any reference signal (RS) as already supported by the 5G standard may be useful, for example, SRS, DL-PRS, CSI-RS or any other reference signal. Moreover, other control signals or other data signals may, e.g., be employed.

The RS shall allow the phase calculation per FCi. Hence, in embodiments, new signal types may, e.g., be used or the existing reference signals are modified.

Especially for the sidelink (SL), some embodiments, may, e.g., employ new reference signals.

The reference signal may, e.g., match with the frame structure of the 3GPP standards. An implementation using the IFFT of the OFDM modulator may, e.g., be realized. The RS may, e.g., be described in the construction of the sequence as input to the IFFT of the OFDM modulator.

For OFDM based systems φ_{RX,i} may, e.g., be derived from the frequency domain representation of the “cyclic correlation”. In embodiments, the cyclic correlation may, e.g., calculate the phase φ_{RX (k)} per subcarrier k.

If frequency component FCi includes several subcarriers, the phase value φ_{RX,i} may, e.g., be the mean of the φ_{RX (k)} for the subcarriers k related to the FCi.

Instead of using the mean of φ_{Rx (k)} other estimation methods for φ_{RX,i} can be applied to reduce the impact of multipath components.

In a first embodiment, “TX1”, the TX signal is a wideband SRS signal. In such an embodiment, the TX signal may, e.g., be a SRS in line with existing 5G standard or future versions of it. For SL the SRS may, e.g., be subject of further refinement. The signal may be considered as composite of several sets. For each set of adjacent subcarriers, or for each part of a wideband SRS or each (narrowband) RS, a correction factor may, e.g., be calculated and reported as φ_{TX,i} for the FCi. The bandwidth of a FCi may, e.g., be selected according to the channel characteristics. If a wideband SRS is used the number of FCi may be high (e.g. >=5).

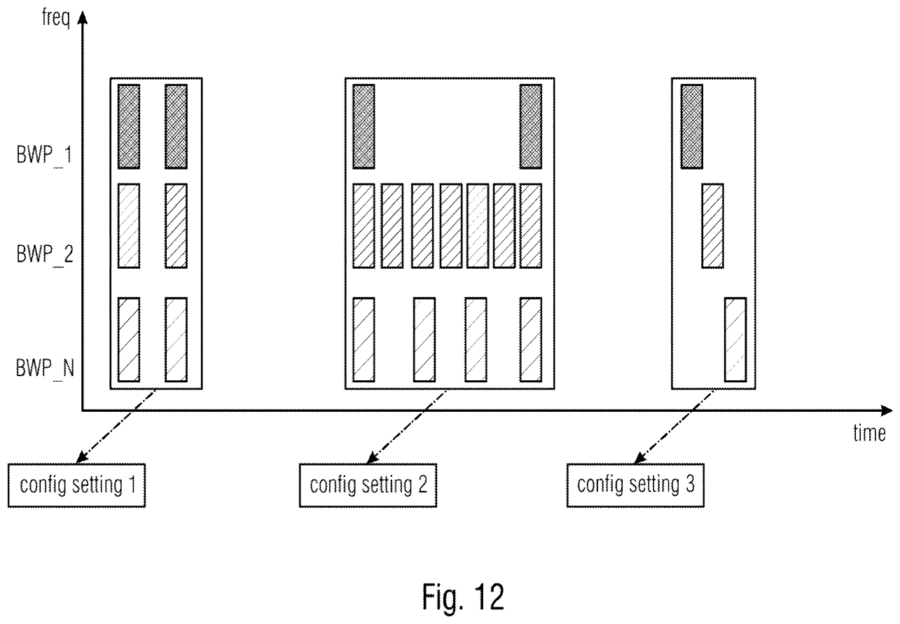

According to a second embodiment, “TX2”, the TX signals may, e.g., be several BWPs of a wideband carrier. Each BWP may, e.g., comprise separate SRS. If several BWP transmit in the same OFDM symbol the resulting signal may be no longer a low PAPR signal, and a new “N band SRS” may, e.g., be used. The N-band SRS may, e.g., be optimized for PAPR. Alternatively the different FCs can be transmitted in several OFDM symbols as “staggered BWP” (FIG. 12, Config setting 3).

In a third embodiment, “TX3”, the TX signal uses adjacent component carrier (CC) or parts of it. Two carrier may, e.g., be considered as a signal demodulated by a higher FFT-length. If base stations are co-located, modulators and demodulators may, e.g., be fully synchronized or even implemented using the same hardware. If base stations are not-co-located, a combining of the frequency components may, e.g., still be useful, although perfect synchronization may become difficult.

According to a fourth embodiment, “TX4”, the TX signal uses non-adjacent component carrier (CC) or parts of it, and the carriers may, e.g., be synchronized. Typically several modulator/demodulator are employed for implementing such an embodiment. If only one modulator/demodulator is employed, the FCs may be transmitted at different time using different OFDM symbols. In this case the frequency stability and phase changes resulting from switch of the carrier frequency may limit a coherent transmission. Different OFDM parameters (“numerologies”) may, e.g., be used for the FCs, and a maximum gap and/or a minimum gap may, e.g., be defined.

In a fifth embodiment, “TX5”, the TX signal uses several component carriers (CC) or parts of it, not or only partly synchronized. A “synchronized status” with at least three values may, e.g., be introduced. Asynchronous (frequencies (carrier frequencies and/or framing) may, e.g., not be synchronized. Synchronization may, e.g., only be present in frequency, while the relative phase between the RF carrier may, e.g., change. Full synchronization may, e.g., be present, and the TX signals may, e.g., be fully coherent, and the phase (or group delay) of the frequency response may, e.g., be constant. The FCs may, e.g., employ different OFDM parameters (“numerologies”).

In the following, complementary embodiments relating to the TX signal and/or configuration parameters according to embodiments are presented.

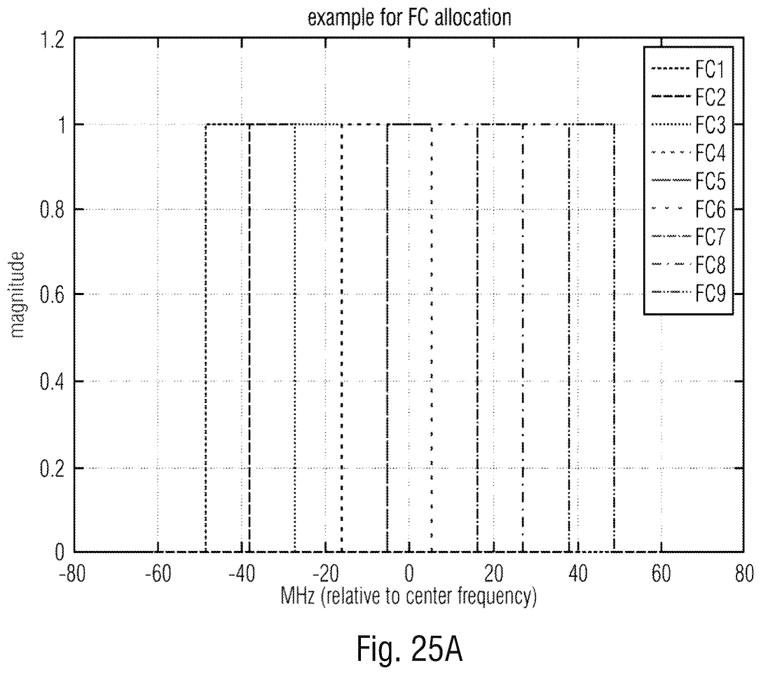

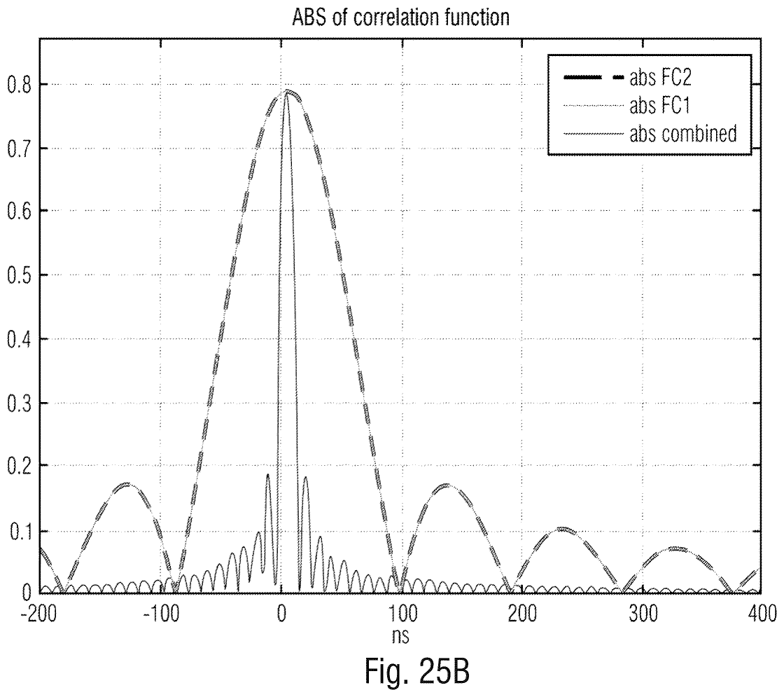

In an embodiment, a contiguous spectrum may, e.g., be split in a configurable number of FCi. Each FCi may, e.g., have the same bandwidth FCi (FIG. 25A)

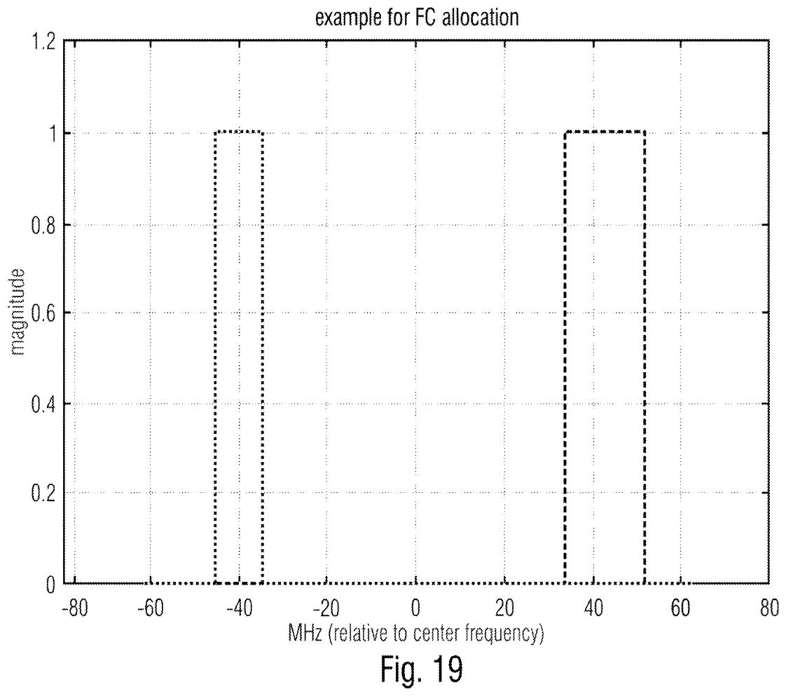

According to an embodiment, the different frequency components may, e.g., exhibit different bandwidth (FIG. 19). E.g., one FCi may, for example, use a high bandwidth and may be used to estimate a first ToA (e.g. for RTT based ranging). Other FCi's may, e.g., use a lower bandwidth. The FCi's may, e.g., be placed symmetrical to the center frequency or an asymmetrical selection of the FCi's center frequencies is selected.

If a periodic or semi-persistent allocation of the RS is selected, in an embodiment, the FCi parameter may, e.g., be static or may change for each occurrence.

According to an embodiment, the first FCi may, e.g., use a static allocation of the center frequency, whereas for other FCi's the center frequencies is dynamically changed.

In an embodiment, for at least one FCi frequency hopping may be applied, and, e.g., the bandwidth of the FCi's may, e.g., change.

According to an embodiment, for some slots, a higher bandwidth may, e.g., be used for higher accuracy RTT measurements.

In an embodiment, the other FCs may use a bandwidth sufficient for phase measurements.

According to an embodiment, the number of FCs may change per occurrence of a set of FCi.

FIG. 12 illustrates example configurations for frequency allocation according to an embodiment. In FIG. 12, Config Setting 1 shows the split of the spectrum in 3 FCs. The FCs of Config Setting 1 are transmitted at the same time (same OFDM symbol or same OFDM symbol of two or more OFDM modulator. Config Setting 2 depicts a different periodicity for the FCs. Config Stetting 3 illustrates an example for “staggering”. In Config Setting 3, the FCs (related to a positioning reference signal) are transmitted in different OFDM symbols.

In the following, receive algorithms according to particular embodiments are described.

At first, phase measurement concepts according to some embodiments are provided.

According to an embodiment, for each FCi the phase may, e.g., be reported. The receiver may, e.g., calculate the channel response. The phase may, e.g., be calculated in the frequency domain. Averaging may, e.g., be applied. Alternatively, the phase may, e.g., be derived from the correlation function by reading out the complex valued sample of the correlation function related to the FAP. The phase offset for the φ_{TX,i} for the FCi resulting from implementation effects may, for example, be compensated or reported to the receiver.

In some embodiments, the frequency response measurement is conducted by employing a “cyclic correlation”.

In such embodiments, the receiver may, e.g., detect the start of the OFDM symbol.

The received signal may, e.g., be transformed into the frequency domain using a FFT.

In the frequency domain, the signal is multiplied with the conjugate complex value of the FFT of the transmitted OFDM symbol (without cyclic prefix):

$$FR = FFT ( x ( {n}_{0} + n ) ) * conj ( FFT ( ref ( n ) ) )$$

wherein
x represents the input signal
n0 is the derived from the OFDM symbol timing recovery and represents the time when the OFDM symbol (after cyclic prefix removal) starts
ref is the transmitted signal
n is defined as n=[0 . . . (fftlength−1)]

It should be noted that if the transmitted signal does not have constant magnitude versus frequency, the frequency response of the transmit signal is to be taken into account. For a SRS with constant magnitude of all subcarriers the “cyclic correlation” represents the frequency response for the bandwidth according the used subcarriers.

If the transmit signals exhibit a rectangular spectrum, the phase response of the transmit signal is removed by the multiplying in the frequency domain the received signal with the conjugate complex value of the transmitted signal.

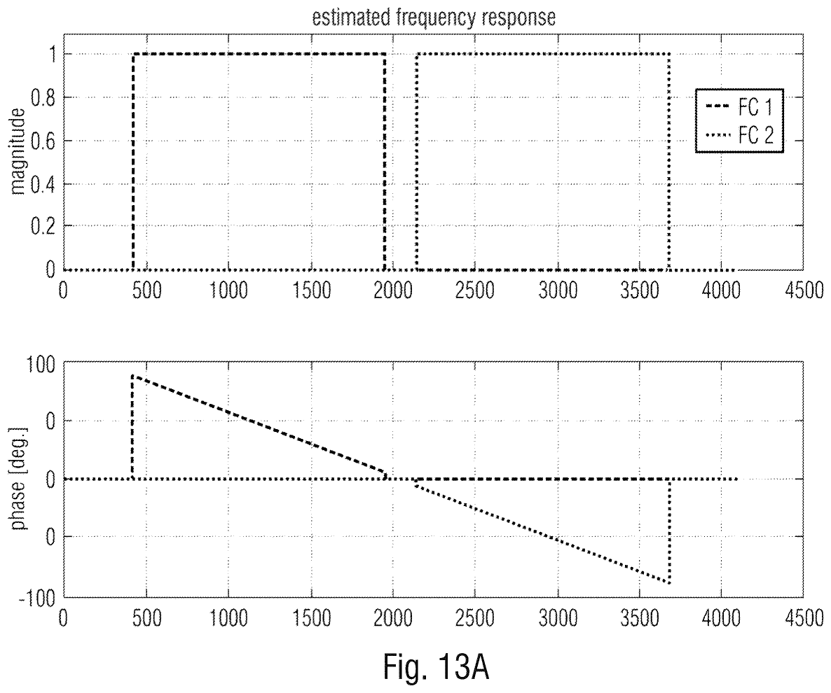

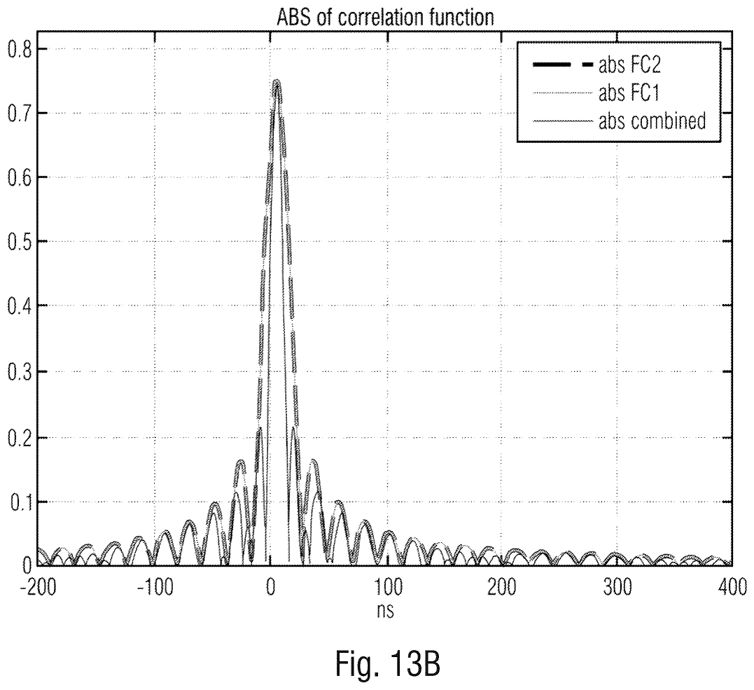

An example for the resulting frequency response/correlation is provided in FIG. 13A and FIG. 13B. In particular, FIG. 13A illustrates the frequency response with respect to magnitude (FIG. 13A, upper diagram) and phase (FIG. 13A, lower diagram) in the frequency domain. FIG. 13B illustrates the magnitude of the correlation in the time domain.

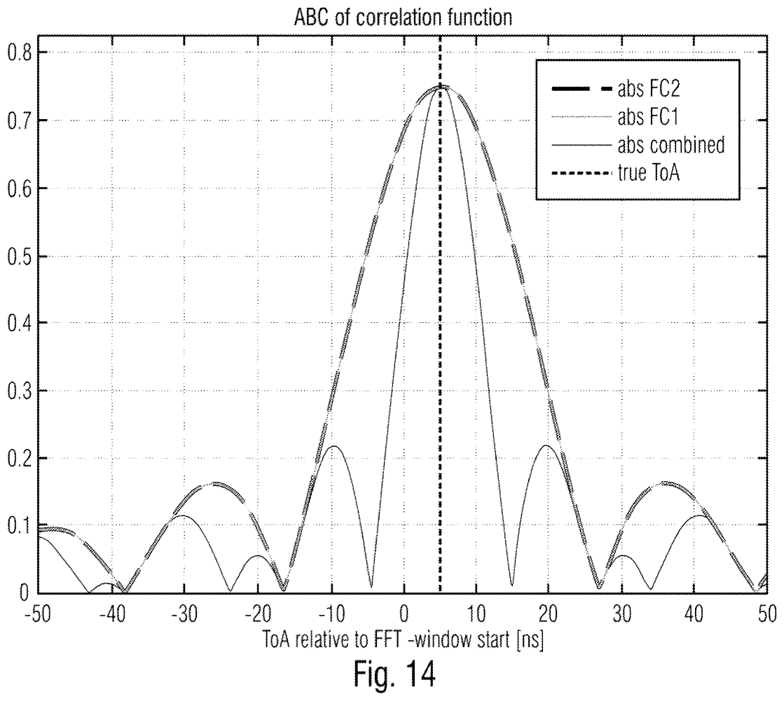

FIG. 14 shows details of the correlation function. In particular, FIG. 14 illustrates a zoom of the first arriving path of FIG. 13A and FIG. 13B. For the example given in FIG. 13A and FIG. 13B, a delay of 5 ns was applied resulting in the frequency domain in a phase ramp and in the time domain a shift of the correlation peak. For the example the transmit signal was considered as two fully coherent frequency components (“FC1” and “FC2”). If the modulator/demodulator phases are linear and the related oscillators are fully locked a common phase ramp results. The two signal components can be combined (e.g. added in the time or frequency domain). More, particularly, FIG. 14 shows details of the “first arriving path” for the correlation per frequency component and the combined signal. Without multipath and with ideal phase response of the transmitter and receiver the peaks are at the same position and at the expected position according the delay.

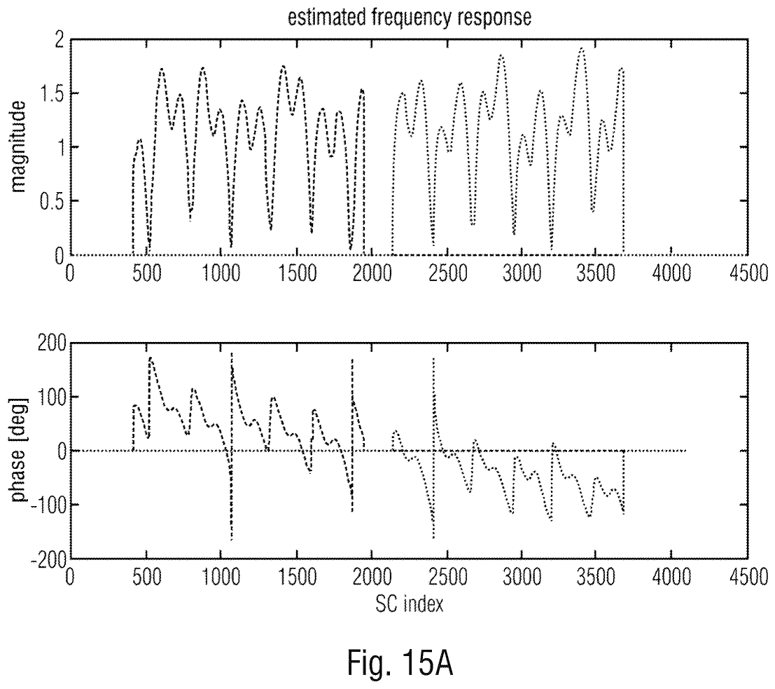

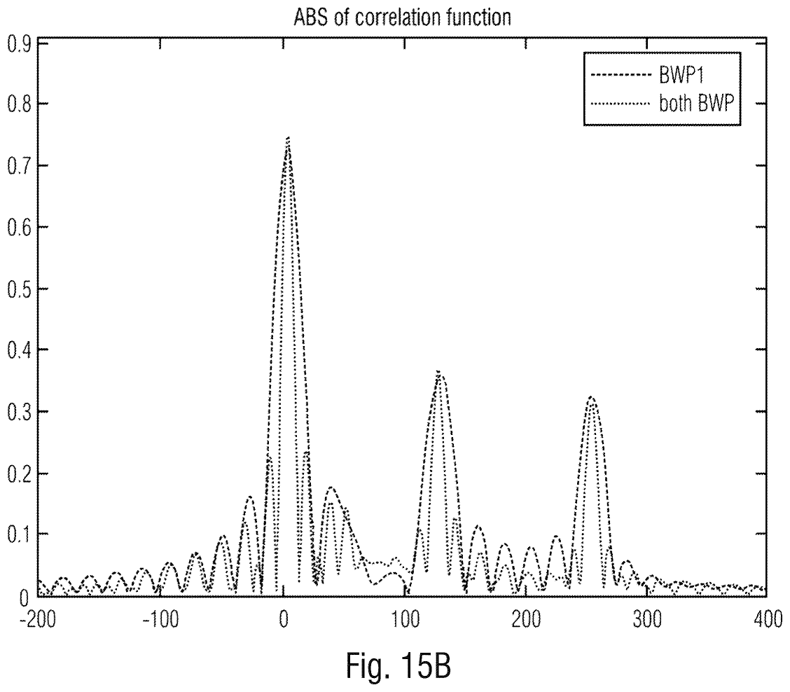

For practical implementations the multipath components may, e.g., be taken into account. FIG. 15A and FIG. 15B illustrate the channel response with multipath, namely for a channel with three (at 55 ns, 123 ns and 255 ns) multipath taps with different amplitude and phase. In particular, FIG. 15A depicts the frequency domain representation, wherein as X-axis the subcarrier index is used representing the frequency. More particularly, FIG. 15A, upper diagram, depicts the magnitude of the estimated frequency response, FIG. 15A, lower diagram, depicts the phase of the estimated frequency response, and FIG. 15B depicts the time domain representation of the channel response measured with one BWP only and with both BWPs. The first arriving path (FAP) arrives with 5 ns delay (relative to the OFDM symbol start time).

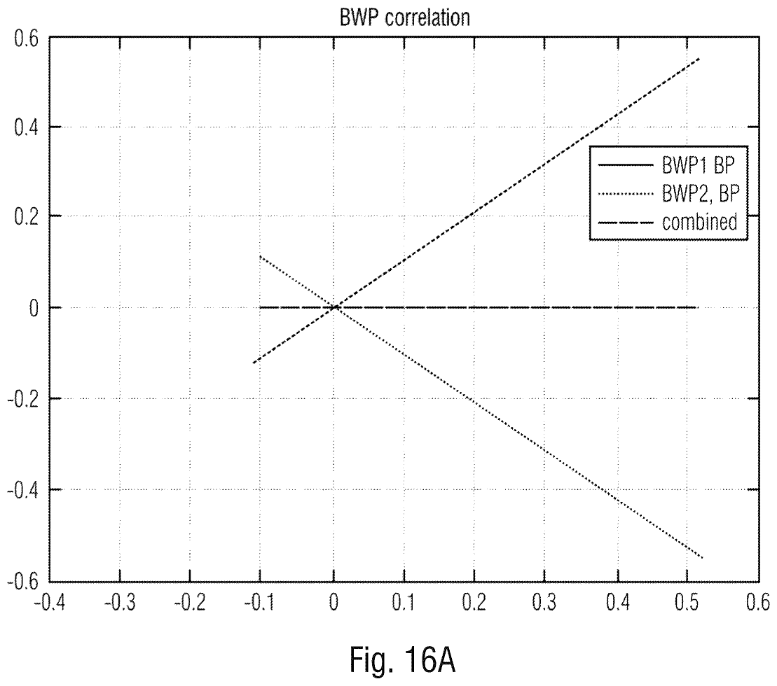

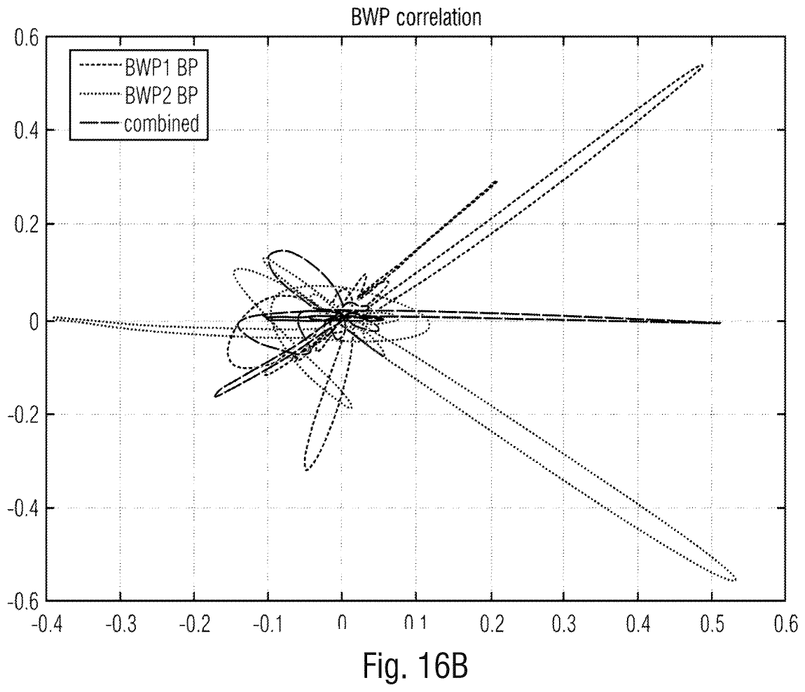

Instead of measuring the phase in the frequency domain, the phase can be derived from the complex valued correlation function. FIG. 16A and FIG. 16B illustrate an I/Q diagram of the correlation function, wherein FIG. 16A depicts the no multipath scenario, and wherein FIG. 16B depicts the multipath scenario. More particularly, FIG. 16A and FIG. 16B show the correlation function as IQ-Diagram, wherein the x-axis represents the real part, and wherein the y-axis the imaginary part. The peaks shown in FIG. 16A and FIG. 16B corresponds to a “needle” in the IQ-Diagram. The angle of these needles represents the phase. In the correlation domain the “needles” related to the FAP and to the multipath components can be separated and the phase of the corresponding parts separated.

According to an embodiment, if several FCs are used the time domain and/or frequency domain correlation may, e.g., be calculated per FCi and evaluated.

In an embodiment, the reporting may, e.g., be performed per FCi.

According to an embodiment, “equally spaced path reporting” may, e.g., be conducted. The equally spaced path reporting reports the relevant part of the correlation function in the time domain as equal spaced complex valued samples to other processing entities. This reduces the amount of data to be reported, while providing sufficient details of the correlation function for further analysis/processing by other entities.

In an embodiment, phase-based distance calculation may, e.g., be combined with RTT (round trip time). As mentioned above, for the phase based distance calculation several hypotheses may result. The ambiguity may, e.g., be reduced or completely resolved by calculating a first estimate for the distance using the RTT method. For RTT, a two-way exchange of RS signals is employed. In contrast, for phase-based distance estimation a “one way” RS transmission may, e.g., be sufficient. According to an embodiment, the RTT method may, e.g., be used for an initial distance measurement. The phase-based method may, e.g., be employed for higher accuracy and continuous update of the distance measurements. Different update rates may, for example, be employed. E.g., an initial measurement may, e.g., be conducted for acquisition, and a high update rate may, e.g., be employed for tracking.

In embodiments, several FCs may, e.g., be employed to increase the accuracy of ToA-measurements.

For example, the correlation function of two or more FCs may, e.g., be combined. According to a first option, coherent transmission and reception may, e.g., be assumed. According to a second option 2, the FCs are non-coherent, and preprocessing of the phase may be performed before combining.

For each FC, a first ToA-Estimate may, e.g., be calculated. Due to the limited accuracy resulting from the limited bandwidth and multipath propagation the measurements may provide different results for different FCs. In the simplest case this can be considered as “measurement diversity” and an average is calculated. More advanced algorithms may combined the measurements. The combining of the signal may, e.g., be performed by the measurement units or the measurements for each FC are reported to the LMF, for example, and the LMF performs the further evaluation. Related reporting is described below.

If more than one FCs is transmitted several ToA and phase calculations may, e.g., be derived. For each FC a ToA may, e.g., be calculated. Together with the ToA, reliability information may, for example, be calculated and the most reliable measurements may, e.g., be selected. For each FC a measurement set (ToA and related meta data) may, e.g., be reported to the positioning algorithm.

The correlations of the FCs can be combined to generate a correlation with a higher resolution according. Using several FCs may, e.g., provide a similar gain as increasing the bandwidth. If several FCs are combined the “coherency status” is to be taken into account. In the simplest case, the FCs may, e.g., be fully synchronized and a linear phase behavior of the transmitter and receiver may, e.g., be assumed. In this case the FCs can be combined (added) without further processing. If the FCs are not fully coherent and/or the phase of the transmitter or receiver or both is not linear, the combined correlation may, e.g., be corrected, for example, depending on report information.

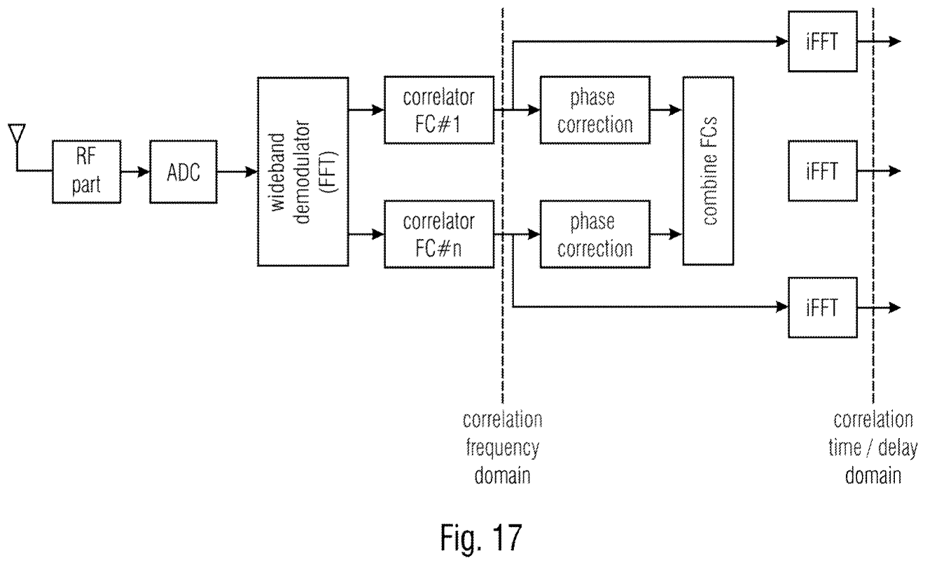

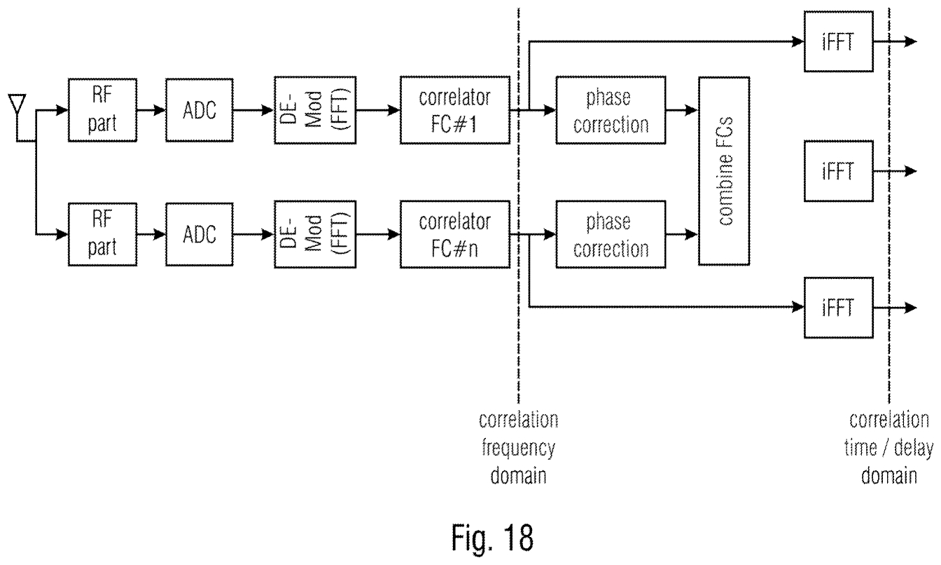

FIG. 17 and FIG. 18 show examples for possible receiver architectures and the processing steps. In particular, FIG. 17 illustrates an apparatus according to an embodiment comprising a receiver, wherein frequency components are combined using wideband demodulator. FIG. 18 illustrates an apparatus according to another embodiment comprising a receiver, wherein frequency components are combined using two (or more) demodulators.

In FIG. 17, a wideband demodulator is employed. This may be the solutions, if the FCs are transmitted frequency synchronized using the same subcarrier grid and fully synchronized framing and the supported bandwidth of the receiver can cover all FCs. If the FCs are, for example, in a bandwidth of 100 MHz, and a subcarrier spacing of 30 kHz is used, a demodulator in line with the 5G numerology may, e.g., be employed as wideband demodulator processing the FCs as different bandwidth parts (BWP) of a wideband signal. For each FC the correlation may, e.g., be calculated in the frequency domain. Before combining the signals, a phase correction may be needed to compensate effects resulting from non-linear phase or not fully synchronized modulator. From the frequency domain correlation the time domain correlation may, e.g., be derived by using an inverse FFT (iFFT). Alternatively the phase correction can be also applied in the time domain.

In FIG. 18, two (or more than two) demodulators are employed. Each demodulator may, e.g., be tuned to a different carrier frequency. The architecture of FIG. 18 may be advantageous, if the frequencies used for the FCs exceed the capabilities of a wideband demodulator or the FCs are not fully synchronized.

In a third embodiment the positioning reference signals may, e.g., be transmitted at different times. In this case one demodulator may, e.g., be sufficient and the demodulator is retuned to the center frequency of the other FC in the gap between two or more RS transmissions.

In a first example, two FCs placed in a bandwidth of 100 MHz and a wideband demodulator in line with FIG. 17 is assumed. Moreover, in such an example, FCs with different bandwidth are assumed. The wideband modulator may, e.g., be tuned to a center frequency in between the two FCs. The resulting spectrum is depicted in FIG. 19. In particular, FIG. 19 illustrates an example for an allocation of two frequency components.

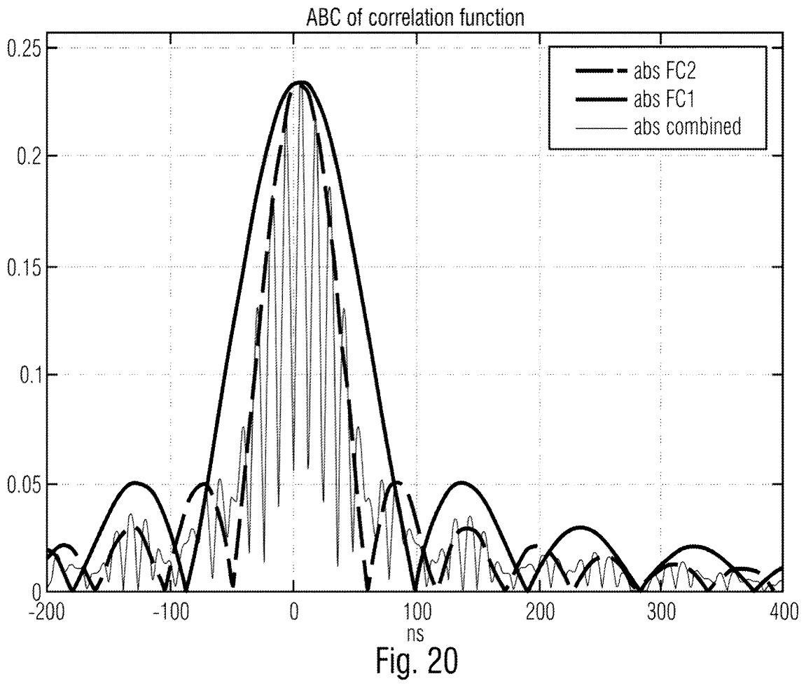

In the example, a channel without multipath propagation is assumed. In line with the architecture provided in FIG. 17, three correlations can be calculated. The magnitude of the resulting correlation function is depicted in FIG. 20.

In particular, FIG. 20 illustrates a correlator output in a time domain according to an embodiment. The two frequency components use a different bandwidth. Accordingly, the correlation functions have different peak width. The characteristics of the combined signal depends on the width of the gap between the two FCs and the bandwidth of each FC. It can be observed that the correlation of the combined signal shows narrow peaks. This allows the calculation of the ToA (time-of-arrival) with higher accuracy.

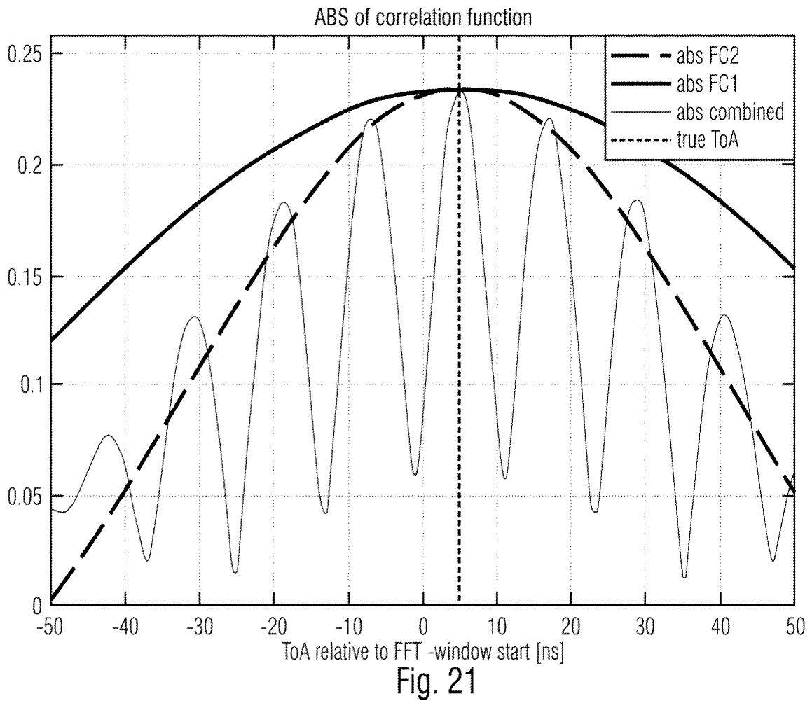

FIG. 21 illustrates a zoom of the correlation peak of FIG. 20. In particular, FIG. 21 shows details of the correlation peak in relationship to the expected ToA (“true ToA”). It is noted that the peak of the combined signal matches the expected ToA. An ideal synchronization of the two FCs and ideal linear phase of the transmitter and receiver was assumed for this example.

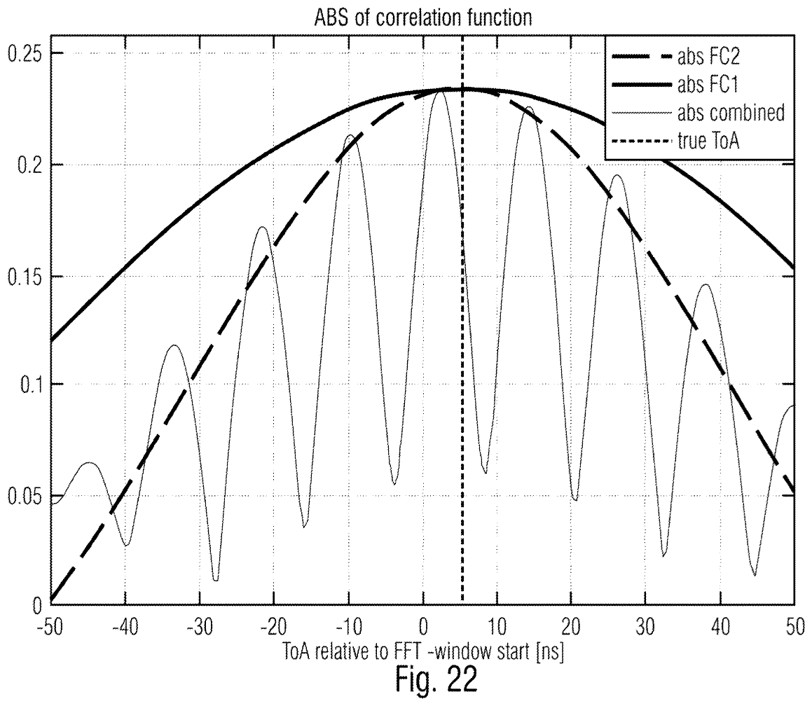

FIG. 22 illustrates an example for the correlator output with a non-ideal phase/non-ideal combining in case of phase offsets. It is noted that although the peak of the correlation function is still located closely to the true ToA, it deviates to some degree from the true ToA. and does not achieve the accuracy of ideal combining.

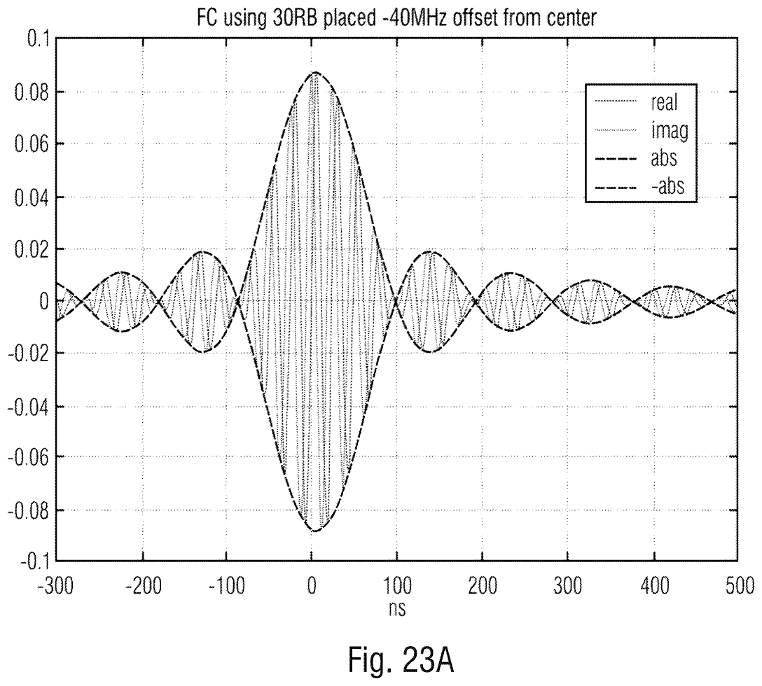

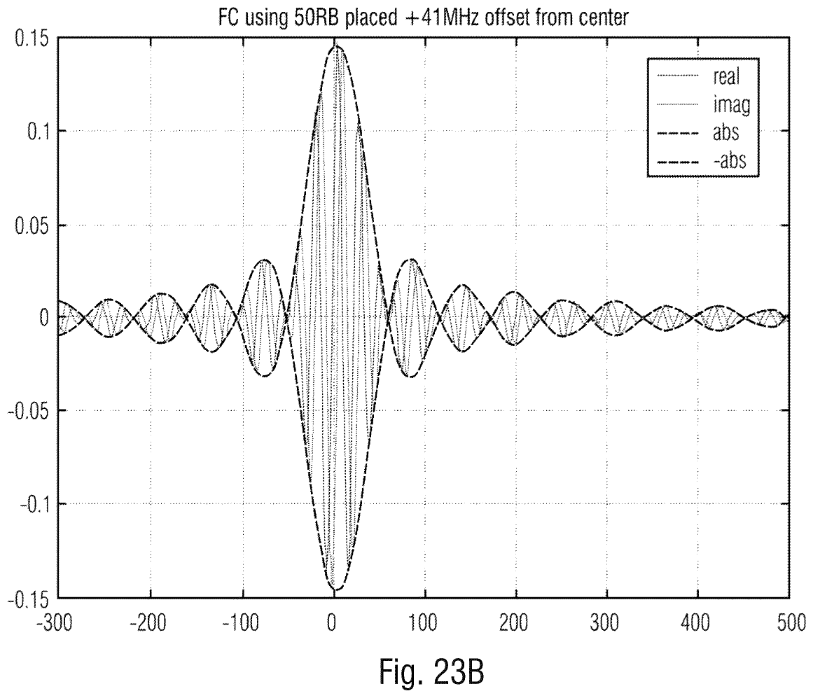

FIG. 23A and FIG. 23B illustrate a correlation function of FCs at an intermediate frequency (“IF”) (FC configuration as given in FIG. 19). In particular, FIG. 23A and FIG. 23B illustrate the characteristic of the correlation function of the bandwidth limited signals placed at a frequency offset as given in FIG. 19. The bandwidth of the FC defines the envelope (depicted as “abs” and “−abs”). The period of the underlying complex valued correlation function depends on the frequency offset. In the example two correlation function of with these characteristics are combined (in the simplest case added). The result depends on the phase. The correlation per FC may, e.g., be performed at baseband (the signal is shifted to the center frequency 0). For the combining, the signals remain at or are shifted back to the “intermediate frequency” (IF) with the same relative spacing as the high frequency signal (RF).

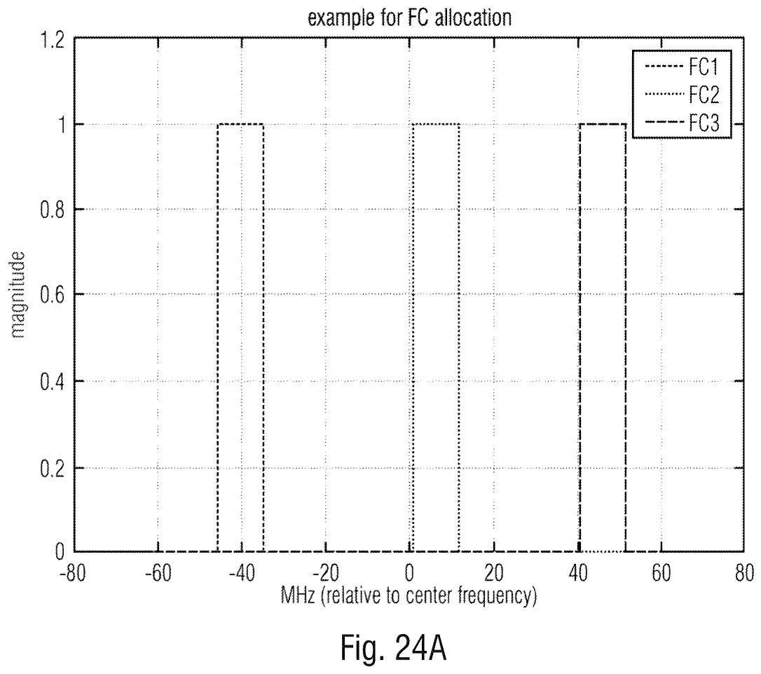

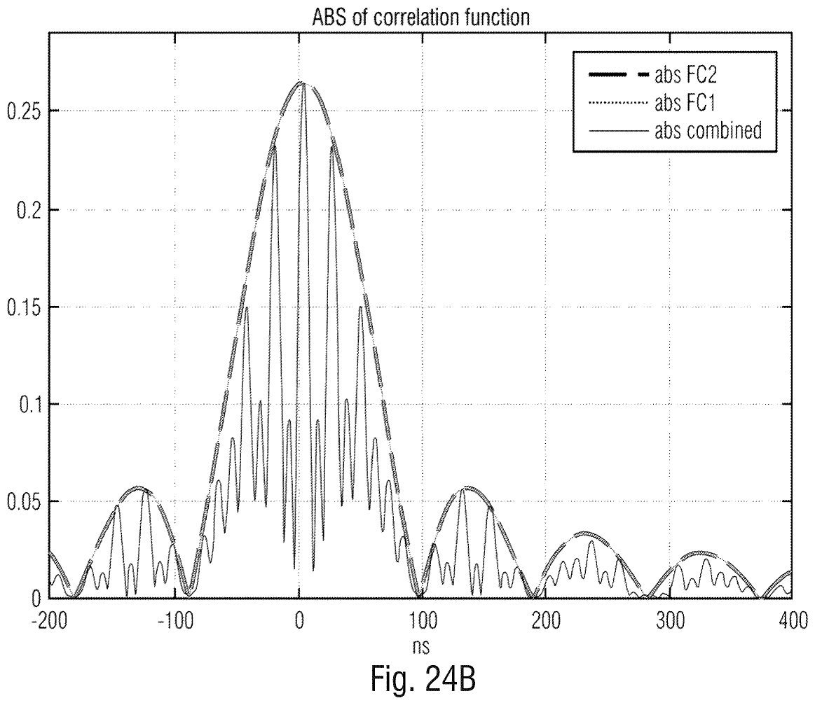

FIG. 24A and FIG. 24B and FIG. 25A and FIG. 25B provide further examples for frequency component configurations.

In particular, FIG. 24A and FIG. 24B illustrates a configuration with three frequency components, wherein FIG. 24A depicts the frequency allocation, and wherein FIG. 24B depicts the correlation. The three FCs with equal bandwidth are placed at different offsets. Equal and non-equal spacing and symmetrical and non-symmetrical arrangements may be considered.

In the example of FIG. 25A and FIG. 25B, a wideband reference signal is split in nine (contiguous) frequency components. Instead of calculating a wideband correlation a correlation per FC is calculated and evaluated before combining. For each FC a phase correction value may be provided and the phase correction value is applied before combining.

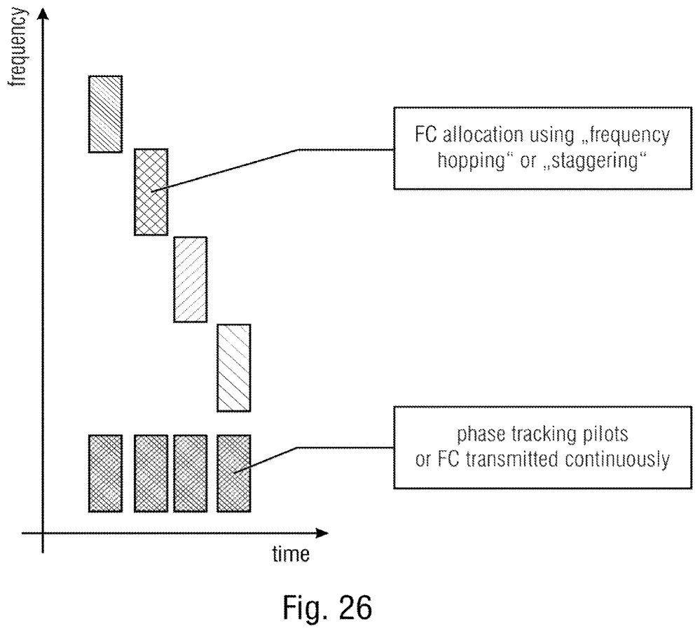

The example given in FIG. 25A and FIG. 25B can be combined with “frequency hopping” or staggering, see FIG. 12, Config Setting 3. An example for a frequency allocation pattern with “frequency hopping”/“staggering” is shown in FIG. 26. Each FC may, e.g., use a different OFDM symbol or set of OFDM symbols. If the FCs are transmitted in different symbols phase drifts resulting from frequency offset may become relevant. Reporting the phase relative to a pilot signal (phase tracking subcarrier, for example) or relative to the phase of a FC occurring in several symbols may, e.g., help to overcome this issue.

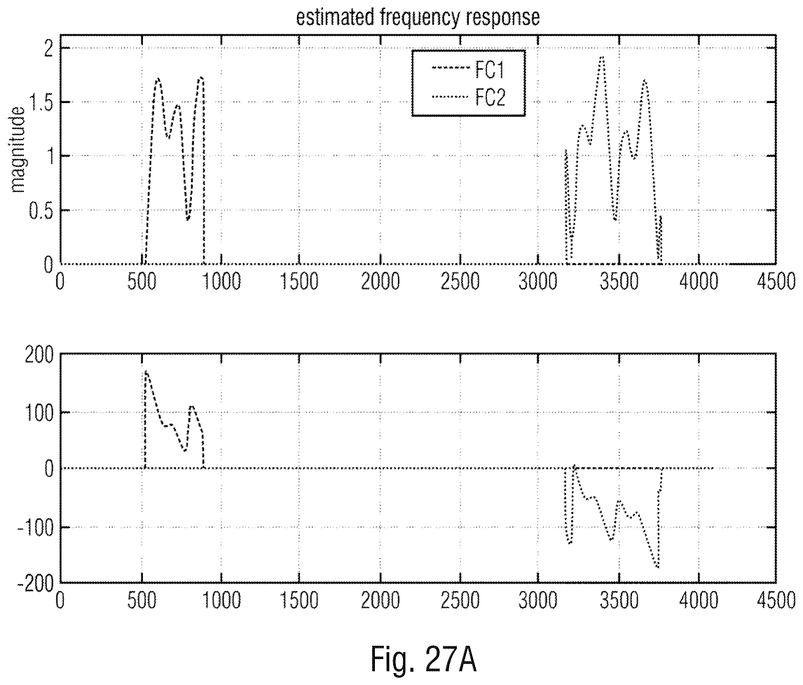

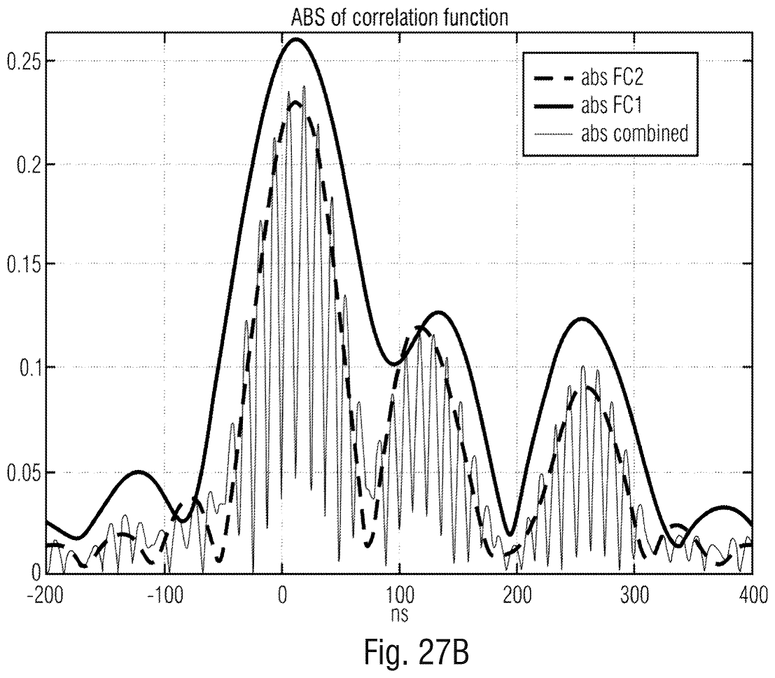

FIG. 27A and FIG. 27B illustrate a combined correlation with multipath according to an embodiment, wherein FIG. 27A depicts the frequency domain, and wherein FIG. 27B depicts the time domain. With multipath propagation, the peak is no longer at 5 ns. This may result in a ToA measurement error.

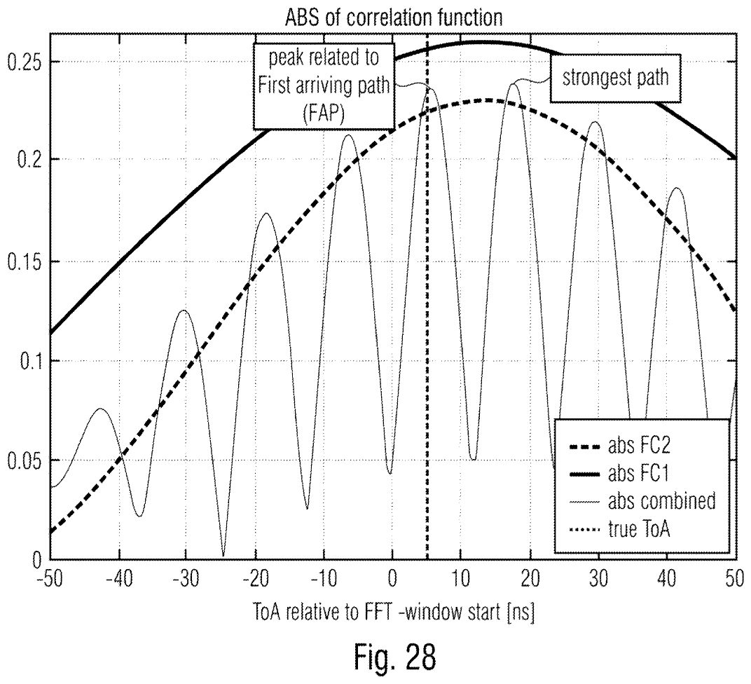

FIG. 28 illustrates a zoom of the of the correlation function at the expected delay. In particular, FIG. 28 illustrates a zoom of the correlation peaks related to the expected ToA of the FAP (first arriving path) according to an embodiment. Close to the true ToA of 5 ns delay a peak is observed, but other peaks have higher magnitude, and an ambiguity for the selection of the peak related to the FAP may arise.

In the following, combining for non-coherent frequency components is considered.

If the transmitter and/or receiver is not capable to transmit/receive coherently, the use of several FCs still provides a performance gain. As an example, three frequency components with narrow bandwidth are considered, in particular, three 5.4 MHz FCs placed at frequencies −38 MHz, 6.5 MHz and 44 MHz. In non-coherent mode, the (random) phase relationship may be replaced by a deterministic value. In the example, the phase offset of the BWP was set to 0. In case of multipath, the narrowband FC may provide a ToA with a high error (in the example the same channel impulse response as in the examples above was selected).

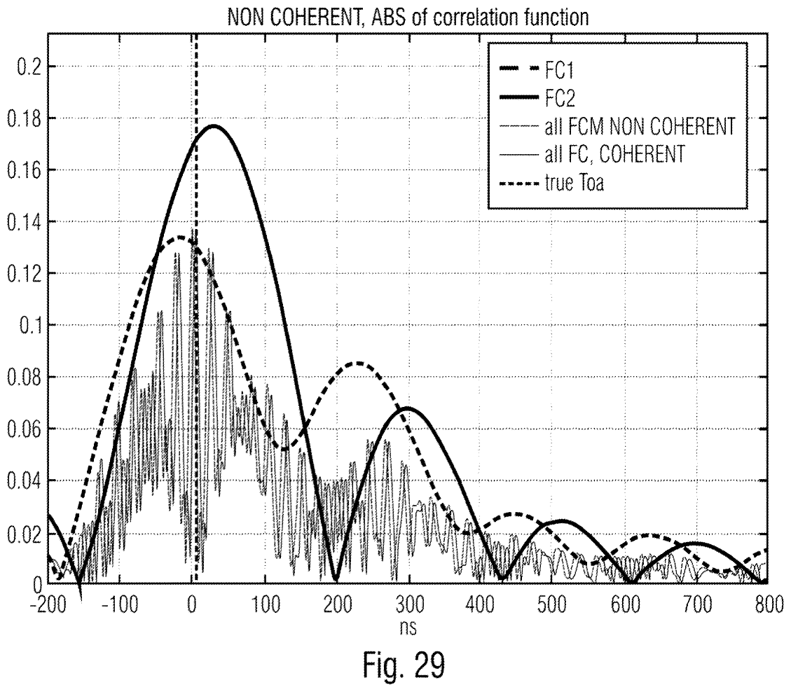

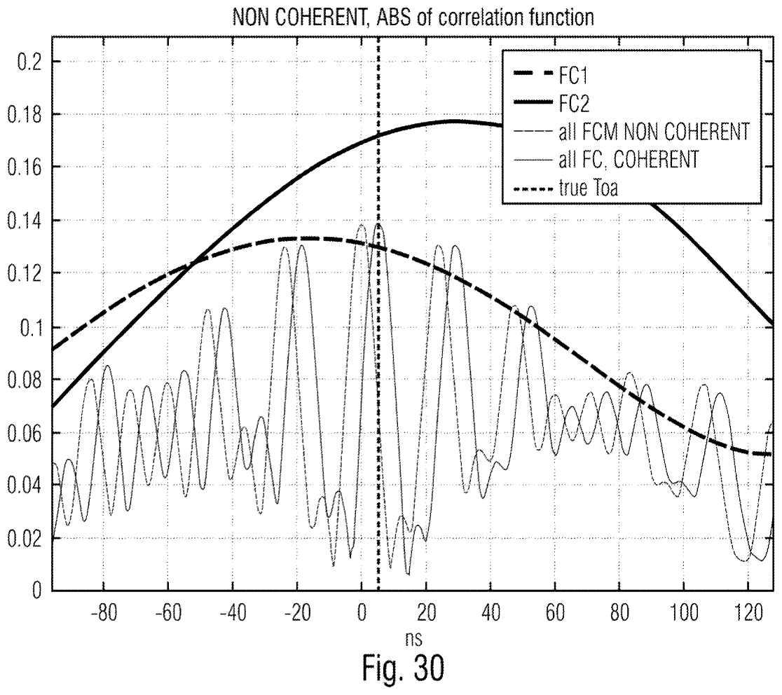

FIG. 29 illustrates an example for non-coherent combining according to an embodiment. FIG. 30 illustrates a zoom into FIG. 29. In case of coherent combining one correlation peak of the combined signal has a match with the true ToA. In case of non-coherent processing the related peak is shifted resulting in an error of approximately 1 m. Furthermore, it is observed that the correlation peaks of the narrow band signal are at different position. Hence, if ToA is derived from several FCs a random error may result and averaging can be applied, for example, to reduce the mean error.

In the following, reporting according to embodiments is considered.

At first, reporting the coherency status according to embodiments is described.

If several FCs are used, the coherency status may, e.g., be reported by the transmitter and the receiver. The further processing steps and the feasible accuracy may, e.g., depend on the “coherence status”. The status may, e.g., depend on the modulator or demodulator capabilities.

In the following, examples for the status of the transmitter (that may, e.g., be reported) are provided:
The modulator may, e.g., transmit all FCs fully coherent. The modulators are locked to the same reference frequency, the phase relationship is known and the phase offset can be compensated before transmission. In this case the reported phase offset may be zero.
The transmitter may not compensate the phase offset. The phase offset may be or continuously measured (e.g. measure the phase relationship of the oscillators related to two FCs). In this case the transmitter may report the (constant or time-variant) phase offset to the receiver.
The FCs may, e.g., be locked to the same reference clock, but the phase offset is not known. In this case the status may be “frequency coherent only”.
If the phase offsets are not known the transmitter may, for example, indicate “non-coherent”.

In the following, examples for the status of the receiver (that may, e.g., be reported) are provided:
For the FCs different demodulators may, e.g., be used. Typically, the receiver recovers the transmitter carrier frequency from received signals. If the frequency recovery is not synchronized the demodulator may work “non-coherent.”
If several FCs are used, the related demodulators may, e.g., use a common carrier frequency recovery. In this case the demodulator may, e.g., be “coherent in frequency”.
Furthermore, the phase relationship between the demodulators for different FCs may, e.g., be known. In this case the phase offset introduced by the receiver may, e.g., be known and can be subtracted from the phase of the received signal to determine the “channel phase” (or the phase of the transmit signal plus phase of the channel). In this case the receiver may, e.g., work coherent in “phase and frequency”.

For example, regarding the cyclic correlation described above, the frequency response is obtained by

$$FR = FFT ( x ( {n}_{0} + n ) ) * conj ( FFT ( ref ( n ) ) ) .$$

In a particular embodiment, the phase offset of the receiver may, e.g., be subtracted from the phase of the received signal in the frequency domain FFT(x(n₀+n)) before multiplying with conj(FFT (ref(n)), and thus, a (receiver-)phase-corrected frequency response is obtained. “Subtracting the phase” in the frequency domain or time domain can be typically implemented by multiplying the signals for each FCᵢ with e^{-j·Δφ}^{ᵢ}, where Δφᵢ is the phase correction value for the FCᵢ.

Alternatively or additionally, in a particular embodiment, the phase offset of the transmitter may, e.g., be “subtracted” from the phase of the transmitted signal in the frequency domain FFT (ref(n)) before multiplying with FFT(x(n₀+n)), and thus, a (transmitter-)phase-corrected frequency response is obtained. According to an embodiment, the transmitter may either transmit its phase offset (or its phase correction value) to the receiver, and the receiver may, e.g., take the transmitter offset into account when determining the frequency response. Or, in another embodiment, the transmitter may, e.g., itself correct the phase of its transmitted signal by the transmitter phase offset before transmitting.

Regarding reporting, in an embodiment, the transmitter may, e.g., report the transmitter phase correction value φ_{TX,i} of the frequency components to the receiver.

The transmitter phase correction value φ_{TX,i} can be either set to a known value and implementation impacts are compensated before transmission. For example, all φ_{TX,i} may, e.g., be identical. Or, φ_{TX,i} are selected to optimize the signal properties (e.g. PAPR). Or, φ_{TX,i} may change versus time and may report a correction value relative to another reference.

Phase based ranging may, e.g., also be applicable, for example, using the DL-PRS or SRS as RS. For the reporting of φ_{TX,i} the DL-PRS or (wideband) SRS signal can be considered as set of FCi and for each FCi a φ_{TX,i} is reported.

Regarding reporting for device-to-device ranging (two-way or one-way), two scenarios are distinguished: In the first scenario, the receiving device is the “consumer”. Then, only TX to RX reporting is needed. In the second scenario, the transmit device is the “consumer”, then the reporting is conducted similar to the reporting for TDOA.

Regarding reporting for TDOA (UL-TDOA and UE-assisted OTDOA), the “Measurement unit” (MU)(For UL-TDOA the gNB, for UE assisted OTDOA the UE) reports to the LMF according the configured measurement parameter, for example, φ_{RX,i} per FCi, and optionally, e.g., a related quality indicator (e.g. SINR, received power, etc.). The reports may be combined with reports related to TDOA. A report of “raw data” (calculated correlation or parts of it) may, e.g., be conducted, and the MU may report the correlation function in the frequency domain or in the time domain. If reported in the time domain the complex valued correlation function may, e.g., be reported with a reduced sampling rate according the bandwidth of the FCi. Only parts of the correlation function (e.g., if reported in the time-domain the “correlation lobe” related to the estimated FAP), and ESPR reporting (=equally spaced path reporting=representing parts of the correlation function with equally spaced samples) may, e.g., be conducted. A time stamp related to the correlation function may, e.g., be reported. For example, a time of arrival related to the first sample of the ESPR may, e.g., be reported.

Regarding ESPR reporting for FCs/ESPR preprocessing, the scope of the ESPR (equal spaced path reporting) is the reporting of parts of the measured channel impulse response relevant for positioning applications. A possible implementation may, e.g., be the reporting of the (complex valued) samples related to the first arriving path (FAP) with a sampling frequency according to the bandwidth of the FC. For the ESPR reporting the receiver may, e.g., calculate a first estimate of the FAP and may report the samples of the correlation function around the FAP. Taking into account the reduced bandwidth of the FC, the correlation function around the FAP may, e.g., be represented with a reduced sampling frequency resulting in a reduced number of samples for a given time window length (or with a given number of samples an extended time window can be covered). The receiver (e.g., measurement unit for ToA measurement) may, e.g., provide the ESPR samples together with a first ToA estimate to another network component (the LMF, for example) for further processing. Using advanced algorithms and/or reports from several receivers (UL mode) or several signals (DL mode) a new (better) ToA estimate can be derived.

With respect to a reporting of capabilities, for example, of a UE to the network or to one or more other UEs in case of sidelink, support of parallel transmission of two or more BWP, for example, in a same CC or in an adjacent CC may, e.g., be reported.

High accuracy frequency recovery (the UE may synchronize to the network (or another UE)) may, e.g., also be reported. The remaining frequency offset may be subject of implementation, but the expected accuracy can be defined as “capability”. Alternatively, the synchronization status and related expected accuracy can be reported.

A frequency offset resulting from Doppler shift (moving/stationary device, speed of the device) may, e.g., be reported. In case of moving devices it may be difficult to distinguish between remaining frequency offset and Doppler shift resulting from movement. A UE may know its speed and can report the speed. For stationary devices (e.g., RSU (road side units) at a fixed position) the UE may indicate “speed=0”=stationary.

Moreover, in case of sequential FCs transmission the frequency stability versus time may be reported. If the frequency offsets are very low the apparatus may report the capability of high accuracy frequency recovery. In this case a (nearly) coherent decoding may be also possible if the RS per FC are transmitted in different symbols or slots.

Furthermore, a support of “N-band SRS” may, e.g., be reported. Currently it is not expected that a UE can transmit several BWPs in one symbol (for communication purpose this is not required. Either a wideband SRS is used (to capture the full bandwidth) or a SRS with the bandwidth used for the data is sufficient). According the embodiment described above several (independent and bandwidth limited) SRS in a symbol are employed for positioning purpose. A “N-band SRS” may be constructed by several independent SRS or by splitting a SRS in non-contiguous parts.

Moreover, transmitting two SRS in at the same time in one OFDM symbol will “destroy” the low-PAPR properties of the RS. Therefore, the support may be subject of capabilities and may, e.g., be reported.

New RS signal designs may be introduced to the standard in new releases of the standard. The support of these new or modified RS may be subject of the capability reporting.

A configuration/signaling may, e.g., be reported, for example, to configure RS according parameters given in TX signal design, or to enable/disable “extended bandwidth” (e.g. duplicate related signaling from adjacent carrier), or, e.g., OOC signaling.

In the following, procedures according to particular embodiments are described. In particular embodiments, one or more or all of the following steps are conducted.

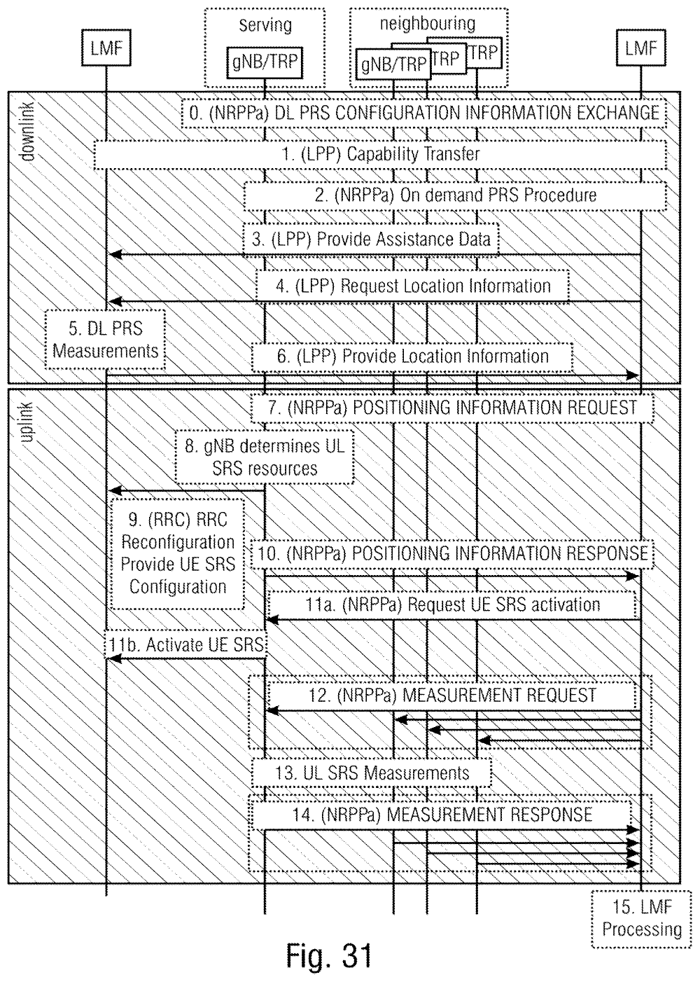

In particular, the procedures for configuring the uplink and the downlink reference signals and for performing measurements are discussed with the help of multi-RTT, with reference to FIG. 31.

FIG. 31 illustrates a positioning procedure using multi-RTT as an example according to an embodiment. The capability transfer applies to both uplink and downlink, although it is kept with downlink procedures above.

As it can be seen in FIG. 31, the multi-RTT procedures comprise procedures for the downlink part and for an uplink part, which may be put in a different order or parts of uplink procedures may overlap with parts of downlink procedures. In the following, it is explained how the existing signaling mechanism may be enhanced to enable some of the embodiments of this invention.

In the following, uplink/downlink operation (multi-RTT) according to particular embodiments are described.

### Step 0 Relates to DL PRS Configuration Information Exchange (Between NG-RAN and LMF):

One NG-RAN node may host several component carrier and related DL-PRS configuration. The LMF may acquire information about DL-PRS from at least one NG-RAN node, wherein the NG-RAN (which represents both ng-eNB and gNB) node provides the LMF the available PRS configuration for at least one TRP hosted by the NG-RAN node. For each DL.PRS frequency layer pair the capabilities and current status according the coherency status may be indicated.

The LMF determines that certain TRP configuration information is desired (e.g., as part of a periodic update or as triggered by OAM) and sends a TRP INFORMATION REQUEST message via NRPPa to the gNB. This request includes an indication of which specific TRP configuration information is requested.

The gNB responds either with TRP_INFORMATION_RESPONSE or TRP_INFORMATION_RESPONSE_FAILED.

In general, the following information is exchanged between the NG-RAN and the LMF, for Rel. 16,

PCI, GCI, and TRP IDs of the TRPs served by the gNB
Timing information of TRPs served by the gNB
DL-PRS configuration of the TRPs served by the gNB
SSB information of the TRPs (the time/frequency occupancy
of SSBs)
Spatial direction information of the DL-PRS Resources of the
TRPs served by the gNB
Geographical coordinates information of the DL-PRS
Resources of the TRPs served by the gNB

In accordance with the embodiments of this invention, the coherency status between one or more DL-PRS transmitted by the TRPs served by the gNB may be indicated.

In line with this embodiment, a resource may be indicated to have a certain coherence status with one or more resources. Where the coherency status is indicated, then this may be at least one of the following:
a. Frequency, time and phase coherence
b. Frequency and time coherence
c. Frequency coherence
d. No coherence indicated

In case no coherency status is indicated to the LMF, the LMF assumes that there is no coherency between the resources.

The exchanged coherency status may be part of the TRP_INFORMATION_RESPONSE message transmitted over the NRPPa protocol.

Step 1 Relates to a Capability Exchange (Between UE and LMF and/or Between UEs in Sidelink):

The UE transmits its capability to support coherent transmission of uplink reference signals in two or more FCs and/or reception of downlink PRS resources in one or more frequency layers. For the downlink, this may be indicated as support of coherent reception of resources on multiple frequency layers. The capability of UE to receive and/or transmit on two resources in different frequency components (e.g. frequency layers in downlink and/or BWPs in uplink and/or other FCs) may be specific for a particular band or a frequency range. The separation distance between the two FCs that a UE is able to process and/or receive and/or transmit coherently may be indicated for one or more radio transmission and reception parameters (such as bands and/or ranges). In some variants of implementation, the separation distance may be related to the bandwidth that a RF chain can process (e.g. within a certain band/band combination). The capability can be different for uplink and downlink.

For the uplink. This may either be signaled as ability to transmit phase coherently on BWP on one or more component carriers. Alternatively, the capability to indicate two BWP on the CC, wherein the second bandwidth part is activated for the purpose of positioning only. The ability of the UE to activate a second bandwidth part just for positioning purposes may be indicated to the LMF. In this case, when the UE is triggered a resource or a resource set on the active bandwidth part, then the resource indicated with a phase coherency status, may be triggered automatically. Alternatively, the two resources may be triggered with an explicit reference to trigger both resources or the resource on active bandwidth part only. In the sidelink, two UEs may exchange the capability information between themselves, indicating their support of certain features.

The UE may indicate what level of coherency status it is able to support in uplink and downlink.

A UE may have different support of the ability to coherently transmit and/or resources in different frequency range, frequency bands, or bandwidth. This may be separately indicated for each supported bandwidth, frequency bands and/or range and so forth.

In accordance with this embodiment, the LMF shall assume Rel. 16 behaviour, i.e. two DL-PRS resources where no coherency status is indicated do not have any time, frequency and phase coherency between them.

### Step 2 Relates to an On-Demand PRS Procedure:

In response to the UE capabilities, the LMF may request the NG-RAN node hosting the TRPs, to which the UE is expected to perform channel measurements, to transmit at least a pair of DL-PRS resources, where the resources are transmitted coherently according to the coherency status. In one variant, the LMF may make an explicit request specifying all or a part of parameters and/or it may simply indicate the NG-RAN node to provide a set of coherent resources.

In accordance with this embodiment, the explicit parameters that the LMF can send to the NG-RAN node while requesting the NG-RAN node to provide at least two resources that are transmitted with the indicated coherency status. The coherency status may be indicated incorporating the information described above. Further parameters that may be indicated in the request include:
1. Start/end time of DL PRS transmission
2. DL PRS resource bandwidth
3. DL-PRS resource set IDs
4. DL PRS resource IDs
5. DL PRS transmission periodicity and offset
6. DL PRS resource repetition factor
7. Number of DL PRS symbols per DL PRS resource
8. DL PRS muting patterns
9. DL PRS QCL information
10. NumberofTRPs
11. Number of PRS resources per PRS resource set
12. Number frequency layers or frequency layer indicator
13. Beam directions
14. Combsize, start PRB, Point A of DL PRS
15. ON/OFF indicator of the DL PRS

One alternative way the phase coherency may be indicated is by enhancing the QCL information to further indicate phase coherency status between the resources. Instead of current QCL types, a new QCL type or types may be determined to indicate the time, frequency and phase coherence between one or more resources.

If the NG-RAN node is unable to support the parameters set requested by the LMF, the NG-RAN node may suggest alternative configuration where the indicated coherency status may be fulfilled. Alternatively, an error may be raised indicating that the indicated type of resource cannot be provided by the NG-RAN node at the indicated time.

### Step 3 Relates to Providing Assistance Data:

In the downlink, the LMF may provide assistance data, wherein in the assistance data coherent transmission between two or more resources in two or more frequency layers may be indicated. This information may be carried within the configuration corresponding to the definition of DL-PRS resource. The second resource may be indicated by signalling at least one of the following: the identifier for the frequency layer, the identifier for the TRP, the identifier for the DL-PRS-ResourceSetID and an identifier for the DL-PRS-Resource. A resource may be phase coherent with more than one TRP, in which case a list of phaseCoherentResources may be indicated. Furthermore, within the assistance data, information may be provided to indicate the expected offset in phase between two or more resources, so that the UE may be able to estimate and perform measurement combining two frequency components (i.e. DL-PRS resources in different frequency layers).

A IE element phaseCoherenceResourceID may be added to the description of DL-PRS resource, wherein the information in the phaseCoherenceID indicates the second PRS the first DL-PRS resource is transmitted with phase coherency. An example of the IE phaseCoherenceResourceID is indicated as follows:

phaseCoherenceResourceID ::= SEQUENCE {

| nr-DL-PRS-PositioningFrequencyLayerID-r18 | NR-DL-PRS-PositioningFrequencyLayerID-r18, OPTIONAL -NEED R | |
|---|---|---|
| dl-PRS-ID-r16 | INTEGER (0..255), | |
| nr-DL-PRS-ResourceSetID-r16 | NR-DL-PRS-ResourceSetID-r16, | OPTIONAL -- NEED R |
| nr-DL-PRS-ResourceID-r16 | NR-DL-PRS-ResourceID-r16, | OPTIONAL -- NEED R |

coherencStatus -r18

| ENUMERATE(CoherenceFrequencyTimePhase, CoherenceTimeFrequency, | |
|---|---|
| CoherenceFrequency, NoCoherencyIndicated), | OPTIONAL --NEED R |
| phaseCorrection INTEGER (−minVal .. maxVal), | OPTIONAL -NEED R |

}

A UE which receives an indication that two resources have phase coherence during transmission is expected to receive and process the resource such that phase coherency is maintained during reception. This may be subject to capabilities of the receiver.

Step 4 Relates to Request Location Information

In the request location Information, the field nr-RequestedMeasurements-r16 may be enhanced to enable the LMF to request either measurement obtained by phase coherent combining of two frequency components or it may provide diversity measurements. To this end, one way of expressing the extended nr-RequestedMeasurement-r16 may be expressed by the following snippet in ASN.1 syntax.

| | |
|---|---|
| nr-RequestedMeasurements-r18 | BIT STRING { prsrsrpReq(0), phaseRequestFCs(1), |
| | coherentMeasurementRequest(2), diversityMeasurementArequest(3), |
| | esprReporting(4)} (SIZE(1..16)), |

wherein the coherentMeasurementRequest indicates the UE to process the indicated resources with the indicated coherency status coherently and report the measurements, if phaseRequestFCs is requested, the phase difference or phase on different component may be indicated, if diversity is requested, then the measurements on each of the FCs are reported individually, if ESPR is requested, then the samples of correlation functions equally spaced are reported. The measurements in this context may mean one or more of the following ToA, TDoA, Rx-Tx-Time difference, RSRP and so on.

### Step 5 Relates to UE Measurements:

a. If the UE is configured to make measurements on two or more resources in two or more different frequency components in a phase coherent manner, it performs such measurements subject to its capability and/or implementation. The coherence status is indicated above. If the resources are indicated to have a coherency status of ‘Frequency, time and phase coherence’, then the UE subject to its capability may determine the ToA by combining the reference signals transmitted on one or more resources in one or more frequency layers coherently.

If the UE receives a request to make such measurement, and the measurement is not supported, the fallback behaviour may be any one of the following:
(i) the UE shall report diversity measurements if the UE capability to process multiple frequency layer at a time is supported.
(ii) The UE shall processes the resource on the active bandwidth part and ignores the other FCs. It may indicate that the reported measurement is obtained only from the resource within the active BWP.
(iii) The UE shall process on one selected resource and indicate the used resource as a part of ProvideLocationMeasurement

### Step 6 Relates to Providing Location Measurement Information:

Subject to UE capability, the UE provides the measurement response, where in the UE may report one or more of the following:
i) Measurement report on combined signal generated by coherently combining the signal of at least two frequency components
ii) Different hypothesis on possible ToA combination. A quantity indicating the relative likelihood of at least two of the hypothesis may be specified optionally
iii) Measurement report on each individual FC separately
iv) Measurement on only one FC (e.g the active BWP) The measurement report may be one or more of the following RSRP, DL-TDOA, DL-AoD.

In case of multi-RTT, the UE reports the difference in time between the reception of the configured downlink resource and the transmission of the uplink resource or resources.

Furthermore, the UE may also report the RSRP on each of the FCs or the RSRP difference between the FCs.

As an example, the UE may report one or more of the following:
a) One set of ToA/TDOA/RxTxTimeDiff values corresponding to the combined bandwidth
b) Several sets of ToA/TDOA/RxTxTimeDiff values, where each set corresponds to a different bandwidth, which may be measured and/or reported simultaneously
c) Several sets of ToA/TDOA/RxTxTimeDiff values, where each set corresponds to a different bandwidth, which may be measured and/or reported at different times

As a fallback, when the UE is configured to report a measurement made by processing two or more resources in a phase coherent manner but its capabilities do not support it, the UE reports the measurement on the active BWP.

Step 7 Relates to NRPPa Positioning Information REQUEST (i.e. Requesting SRS Configuration from NG-RAN Node Hosting the Serving gNB of the UE):

The NRPPs message Positioning Information REQUEST contains the requested UL-SRS transmission characteristics that the LMF requests to the NG-RAN node (i.e. gNB) hosting the serving cell TRP. The request according to Rel. 16 consists of the following information:

Number Of Transmissions/duration for which the UL-SRS is requested
Bandwidth
Resource type (periodic, semi-persistent, aperiodic)
Number of requested SRS resource sets and SRS resources per set
Pathloss reference:
PCI, SSB Index
DL-PRS ID, DL-PRS Resource Set ID, DL-PRS Resource ID
Spatial relation info
PCI, SSB Index
DL-PRS ID, DL-PRS Resource Set ID, DL-PRS Resource ID
NZP CSI-RS Resource ID
SRS Resource ID
Positioning SRS Resource ID

In line with this embodiment, subject to the UE capability, the LMF may request the serving cell to configure the UE to transmit two or more SRS resources with a certain phase coherency status as indicated above. The LMF may indicate the serving cell the bandwidth of each of the resource, the frequency separation gap between two and more resources, and further configuration describing the SRS.

Furthermore, the LMF signal the NR-ARFCN of two frequency components, wherein the at least two frequency components may be within the component carrier and/or outside the component carrier. They could also be signaled using a combination of CC index, BWP index, Resource Set and Resource ID indices.

Step 8 Relates to that the gNB Determines UL SRS Resources:

The gNB takes into account the Positioning information request and determines suitable UL SRS resources. The UL SRS resources may follow the requested configuration from LMF or the gNB may choose its own configuration and/or update the configuration.

The gNBs may optionally interact with each other either using proprietary interface or using the Xn interface, where they may exchange the SRS configurations between one another.

### Step 9 Relates to Providing the SRS Configuration to the UE:

The gNB provides the SRS configuration to the UE via RRC reconfiguration. It may optionally also deliver part of SRS configuration via other means—such as position system information delivery or via RRC message delivered through subsequent or small data transmission (SDT) mechanism. The provided configuration may indicate the coherence requirements between two resources, or simply an indication that coherence transmission is expected for this resource.

The NG-RAN node may configure the UE with one or more SRS resources in a phase coherent manner, and the NG-RAN node sends the configuration to the LMF. The NG-RAN node signals the UE the two uplink SRS resources that are to be transmitted in phase coherent manner, subject to UE capability. The two SRS resources may be configured within the same BWP or component carrier, they may be SRS resources in two BWPs belonging to different component carrier, contiguous or not.

The capability to transmit SRS coherently in non-contiguous frequencies may be subject to UE processing capability. The capability may be indicated to the LMF using LPP message Provide UE capabilities.

The UE receives a SRS configuration, wherein the NG-RAN node indicates the UE to transmit at least two resources in a phase coherent manner. A new field phaseCoherentResource may be added either to SRS resource or SRS resource set level, where the coherent resource may be identified by specifying the component carrier ID, BWP ID within the CC, SRS resource set ID and SRS resource ID. In an alternate version, instead of component carrier ID and/or BWP ID, NARFCN id may be provided together with SRS resource set ID and SRS resource ID to identify the resource outside the active bandwidth part, which the UE is expected to transmit coherently.

This information may be carried within the srsConfig IE carried within the RRC_Reconfiguration message.

### Step 10 Relates to a Positioning Information Response:

The gNB provides the SRS configuration it has provided to the UE in Step 9 to the LMF.

### Step 11 Relates to an Activation of the SRS:

In case of periodic SRS configuration, this step is not needed since SRS will be activated automatically after receiving the SRS configuration. In case of aperiodic and semi-persistent SRS transmissions, the LMF may trigger the NG-RAN node hosting the serving cell of the UE, which in turn triggers the activation of the said SRS at the UE.

The gNB provides the SRS configuration it has provided to the UE in Step 9 to the LMF.

Step 12 Relates to a NRPPa Measurement Request (i.e. Making Request to Several TRPs to Measure the Uplink SRS):

The LMF may signal one or more NG-RAN nodes to perform measurement on two or more SRS resources coherently. One way to do so would be to indicate configuration of two or more SRS resources to NG-RAN node indicated and indicate the phase coherency requirement by signalling that the ID of the second SRS resource that is phase coherent with the other resources.

In general, the LMF may select a set of TRPs that need to make measurement on a certain UL-SRS configuration, and send one of more of the following information to configure the TRP to make measurements.

TRP ID of the TRP to receive UL-SRS
UE-SRS configuration
UL timing information together with timing uncertainty, for reception
of SRS by candidate TRPs
Report characteristics for the measurements
Measurement Quantities

In accordance with the embodiments of this invention, the information exchanged between the gNBs (hosting the aforesaid TRPs) and the LMF may further include the indication of coherency status between two or more resources.

In accordance with this embodiment, the IE phaseCoherentResource may contain information about the phase coherency status. Furthermore, it may also optionally indicate additional information about phase correction.

Step 13 Relates to UL-PRS (e.g. SRS) Measurements:

The NG-RAN node may perform, subject to its capabilities, the measurements where the two resources where phase coherency is indicated by receiving and processing them in a phase coherent manner. If the LMF makes a request to an NG-RAN node, which cannot process the resources in a phase coherent manner, it may either issue an error response in Step 14 or may provide the measurement made on the first resource as a fallback.

### Step 14 Relates to NRPPa Positioning Measurement Response:

In the measurement response, in the downlink the UE and the NG-RAN node in the uplink may be configured to report one or more of the following:
i) Measurement report on combined signal generated by coherently combining the signal in at least two frequency components
ii) Different hypothesis on possible ToA combination. A quantity indicating the relative likelihood of at least two of the hypothesis may be specified optionally.
iii) Measurement report on each individual part of it separately
iv) Measurement on only one FC

The type of measurement reports may be signaled explicitly by indicating phase coherent measurements or diversity measurements, or measurement on a single FC by indicating the type of measurement.

In case of measurements for several hypothesizes, at least two hypothesizes for each resource may be reported. The hypothesizes may be related to the first arriving path or to distinct multipath components. The reported hypothesizes and/or multipath measurements may be processed at LMF by classification algorithms (e.g. using machine learning or deep learning) to extract the different features of the received signal and estimate the correct delay.

The UE and/or the TRP may report time differences and/or phase difference and/or signal strength differences between the different hypothesizes and/or multipath components of the FCs and/or the combined signal.

### Step 15 Relates to LMF Procedures (or UE Procedures in Case of UE-Based)

The measurements made by UE and/or NG-RAN node may be processed at the LMF or the UE respectively in case of LMF-based and UE-based solution to determine the positioning solution.

In the following, an extension to sidelink according to some particular embodiments is described. The reference signals already defined within the standard or modified versions of it may be also used for the sidelink, e.g. a SRS and/or DL-PRS and/or CSI-RS signals may be also selected for positioning applications using the sidelink. The RS for positioning applications using the sidelink are referenced as SPRS (sidelink positionion reference signal).

The resources for positioning signal measurements may, e.g., be configured by the network in case of in-coverage, partial coverage or out-of-coverage by the network while it is in RRC_CONNECTED state and/or from the system information available either via another UE in partial coverage or another UE in out-of-coverage. The UE transmitting the SRS may indicate to the other UE, which two or more resources it is transmitting in the phase coherent manner. This information may be shared as assistance data or as system information.

In an alternate version, the recommended phase coherency expected between two reference signals may be indicated by the network to the UEs. The reference signals where phase coherency is indicated may be indicated by providing specifying one of the following:

Case 1: Carrier aggregation between two component carriers in sidelink: The CC ID, BWP ID and reference signal configuration ID (e.g. reference signal set configuration, and reference signal configuration).

Case 2: Fragmented spectrum within a component carrier The CC ID, BWP ID and reference signal configuration of the active bandwidth part and either the BWP ID and reference signal configuration within an inactive BWP part or an FC identifier ID and its associated reference signal configuration, wherein the FC may be specified by specifying the NR-ARFCN ID.

Alternatively, the two FCs for transmitting the sidelink reference signals may be specified by specifying parameters comprising at least one of the following: NR-ARFCN, bandwidth, resource length in symbols, begin and end of symbols. Each parameter may be identified by an identifier and this identifier may be included in the configuration of other resource to indicate the coherency.

A subset of sequences may be used when the UEs is transmitting the two resources, whereas a different subset of sequences may be used when the two resources are not transmitted in a phase coherent manner.

The receiver UE may, e.g., be able to make request to the transmitting UE to transmit the resources in phase coherent manner, if it has been able to detect the resources individually. The UE receiving the request may transmit in a phase coherent manner or may implicitly deny the request.

The UE is configured to receive and transmit signals in different FCs, for example, different BWPs, and/or different CC. For network-based positioning the UE (for DL signals) and/or gNB (for UL signals) may, e.g., report the measured ToA, coherency status and other measurements (signal quality, ESPR, etc.), e.g., for each signal to the LMF.

For UE based positioning the gNB (or another measurement unit) may, e.g., report the measurements (ToA, SINR, optional ESPR samples) together with the coherency status to the UE.

Regarding uplink operation (UL-TDOA), the network may, e.g., configure the UE to transmit several FCs. The measurements units may, e.g., be the gNB or “receive only” location measurements units (LMUs). The measurement units may, e.g., report for each FC to the LMF (for network-based positioning) or the UE (UE based positioning) the measurements together with the coherency status. The UE may report the frequency coherency status for the transmitted RS to the LMF.

Regarding downlink only operation (DL-TDOA or OTDA), e.g., the gNBs (or other transmit points like “transmit only RSU (road side units)”, may, e.g., configured to transmit several FCs. The UE will receive several FCs and may, e.g., either provide reports for each FCs to the network (network based positioning). The report may include the coherency status; or may combine the received signals related to different FCs (UE based positioning, for example) and/or may report the combined signal to the network. Each transmitter may, e.g., provide the related frequency coherency status to the “combiner”.

Regarding sidelink, in-coverage operation, a UE or gNB may, e.g., be selected as target of the transmission (“spatial relationship”). For a UE to gNB operation the spatial relationship may, e.g., selects the reference signal for power control, and/or supports the selection of the spatial filter for transmission. The UE may, e.g., request RS signal transmissions from other UE, if “connected”. In an embodiment, the UE may, e.g., directly request RS signal transmissions. In other embodiments, the request may, e.g., be send to the network and the network may, e.g., configure the UE. According to an embodiment, if a connection is lost, the UE may, e.g., stop transmission. A setup of the SRS by an s-gNB may, e.g., be conducted. The LMF may, e.g., request the SRS transmissions. Measurements may, e.g., be requested from, e.g., a UE and/or from e.g., a gNB. Measurements may, e.g., be reported.

Regarding sidelink, Out-of-coverage operation, the ranging UE may, e.g., measure the distance to neighboring UEs, e.g., using the 5G-RTT method. To increase the accuracy FCs/BWPs may, e.g., be used. Alternatively or complementary to the RTT method, tracking, the phase-based one-way ranging may, e.g., be used. Each ranged UEs may, e.g., use a different set of FCs.

Sidelink may, e.g., be used for ranging, relative and absolute positioning. The most important mode is ranging, e.g. to determine a one-dimensional distance between, e.g., vehicles. If sidelink is operated in mode 2, i.e. OOC, two-way-ranging may, e.g., be applied. Assuming a first UE (“UE1”) wants to measure the distance to one or multiple other UEs (UE2 to UE4) the procedure may, e.g., be as follows:
1. UE1, in the following called the ranging UE, may, e.g., transmit a message that addresses the UEs, in the following called the ranged UEs, to which it wants to measure the distance The message may, e.g., comprise a configuration message for the SPRS (sidelink positioning reference signal) and/or may, e.g., indicate capability support for transmission and/or reception on two or more CCs. Moreover, the message may, e.g., comprise time and frequency allocation for response. Furthermore, the message may, e.g., comprise a primary and a secondary frequency part, where the secondary BWP depends on the capability of the ranging UE, it supports.
2. UE1 may, e.g., transmit a signal, for example some kind of RS, like a SPRS.
3. Each ranged UE that has been addressed for ranging (e.g. UE2 to UE4) may, e.g., receive the RS and may, e.g., determine the accurate timing of reception using the information of the configuration message in step 1.
4. In an embodiment, each ranged UE may, e.g., adjusts its transmitter timing according to the measured reception timing; the UE can report the timing alignment to the entity determining the range. In an alternating option, the UE may, e.g., report an Rx-Tx timing reports according to the UE local time wherein the Rx is associated to the time the UE receives the signal transmitted from UE1 and Tx is associated with time of the transmission of the SPRS from the ranging UE in step 5.
5. The ranged UEs may, e.g., transmit some kind of RS, like a SPRS, within a defined time period. This time period used for positioning is known to the ranging UE. E.g., it is either a specified default value or has been configured by a host UE or in case of coverage by the network.
6. From the time difference between its RS transmission and the RS receptions from the ranged UEs considering the known processing times, the entity determining the range may, e.g., compute the distances to the ranged UEs. The entity may, e.g., be in this example UE1, and/or one or more of the ranging UEs and/or a network entity receiving the information of the OOC at later time instants (offline processing).

In out-of-coverage, the configuration may, e.g., provided by any UE via a sidelink. A default configuration has to be used as long as that UE was not in coverage in the past and thus could not get a configuration from the network.

According to a particular embodiment, measurements of phase differences or a change of the phase difference between two antenna ports are conducted.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

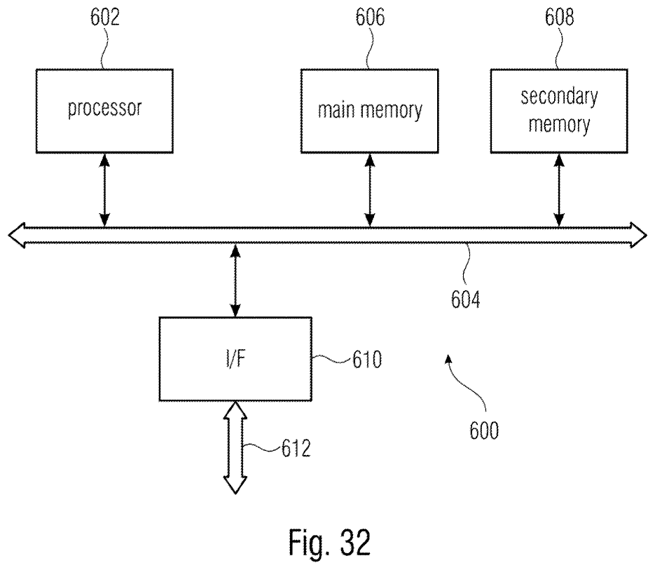

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 32 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[Lipka. 2019] Lipka M., Sippel E. Vossiek M.: An Extended Kalman Filter for Direct, Real-Time, Phase-Based High Precision Indoor Localization, IEEE Access, 2019
[RedFIR] von der Gruen, Thomas and Franke, Norbert and Wolf, Daniel and Witt, Nicolas and Eidloth, Andreas, “A Real-Time Tracking System for Football Match and Training Analysis,” Springer, Berlin, Heidelberg, 2011-12.
[R1-1901186] Fraunhofer IIS, Fraunhofer HHI: Carrier Phase enhanced potential solution for NR positioning schemes, 3GPP TSG RAN WG1 Ad-Hoc Meeting 1901, Taipei, Taiwan, Jan. 21-25, 2019

ABBREVIATIONS

| Abbreviation | Definition |
|---|---|
| 3GPP | third generation partnership project |
| 5GC | 5G core network |
| BS | base station |
| CSI-RS | channel state information reference signal |
| DMRS | demodulation reference signal |
| DOA | direction of arrival |
| E-CID | enhanced cell ID |
| eNB | evolved node b |
| E-SMLC | evolved serving mobile location center. |
| E-UTRA | evolved UMTS terrestrial radio access |
| gNB | next generation node-b |
| GPS | Global Positioning System |
| LMF | location management function |
| LMU | location measurement unit |
| LPP | LTE positioning protocol |
| LTE | Long-term evolution |
| NG | next generation |
| ng-eNB | next generation eNB |
| NG-RAN | either a gNB or an ng-eNB |
| NR | new radio |
| NRPPa | new radio positioning protocol a |
| OTDOA | observe time difference of arrival |
| PRS | positioning reference signal |
| PTRS | phase tracking reference signal |
| QCL | quasi colocation |
| RAN | radio access network |
| RP | reception point |
| RSTD | reference signal time difference |
| RTOA | relative time of arrival |
| 3GPP | third generation partnership project |
| RTT | round trip time |
| SA | Standalone |
| SRS | sounding reference signal |
| TDM | Time Domain Multiplexing |
| TOF | time of flight |
| TRP | transmission reception point |
| RS | reference signal |
| QCL | quasi co-located |
| AoA | Angle of Arrival |
| AoD | Angle of Departure |
| PAS | Power Angular Spectrum |
| NR | New Radio |
| gNB | next generation node-b |
| GPS | Global Positioning System |
| LMF | location management function |
| LMU | location measurement unit |
| LPP | LTE positioning protocol |
| LTE | Long-term evolution |
| NG | next generation |
| ng-eNB | next generation eNB |
| NG-RAN | either a gNB or an ng-eNB |
| NR | new radio |
| CA | carrier aggregation |
| CAM | Cooperative Awareness Message |
| DAS | distributed antenna systems |
| DL | Downlink |
| FL | Frequency layer |
| FC | Frequency component. This is either a BWP of a |
| | wideband carrier or |
| GNSS | Global navigation satellite system |
| OOC | Out-Of-Coverage |
| 3GPP | third generation partnership project |
| PSFCH | Physical Sidelink Feedback Channel |
| P-UE | Pedestrian UE: should not be limited to pedestrians, |
| | but represents any UE |
| RS | Reference signal |
| RE | resource elements |
| SINR | Signal to interference and noise ratio |
| SL | Sidelink |
| SPRS, SP- | Sidelink positioning reference signals |
| V2X | Vehicle to anything |
| VRU | Vulnerable road user |
| V-UE | Vehicular UE |
| BWP | Bandwidth Part |
| TEG | Timing Error Group |
| ZC | Zadoff-Chu sequence |
| UE | User equipment |
| UL | Uplink |
| Uu (interface) | Interface between UE |
| ToA | Time of Arrival |
| TDOA | Time Difference of Arrival |

1. An apparatus of a wireless communication system,
wherein, for each frequency component of two or more frequency components, a transmitter of the wireless communication system is configured to transmit, within said frequency component, a transmit signal of said frequency component, wherein the transmit signal is a reference signal or is a control signal or is a data signal or is a portion of the reference signal or of the control signal or of the data signal, and wherein a receiver of the wireless communication system is configured to receive, within said frequency component, the transmit signal of said frequency component, which has been transmitted by the transmitter, as a received signal of said frequency component,
wherein each frequency component of the two or more frequency components represents a bandwidth limited signal, which comprises one or more signal portions, and which exhibits a center frequency, wherein the center frequency of each of the two or more frequency components is different from the center frequency of any other one of the two or more frequency components,
wherein the apparatus is configured to receive and/or to process and/or to transmit phase relationship information, wherein the phase relationship information comprises information on a transmitter-specific phase relationship between the two or more frequency components and/or comprises information on a receiver-specific phase relationship between the two or more frequency components, and
wherein the apparatus is configured to use the phase-relationship information for determining positioning information, or is configured to report the phase-relationship information or information derived from the phase-relationship information to another apparatus of the wireless communication system for determining the positioning information; wherein the positioning information comprises information on a distance and/or a distance change between the transmitter and the receiver and/or a position of the transmitter and/or a position of the receiver.

2. An apparatus according to claim 1,
wherein the one or more signal portions of the frequency component of each of the two or more frequency components are a plurality of orthogonal signal portions of said frequency component, which exhibit the center frequency of said frequency component; or
wherein the receiver is configured to receive the information on the transmitter-specific phase relationship from the transmitter; or
wherein the receiver is configured to receive the information on the transmitter-specific phase relationship from the transmitter; and the receiver comprises a first receiver unit for receiving the received signal of each of the two or more frequency components, and a second receiver unit for receiving the information on the transmitter-specific phase relationship.

3-4. (canceled)

5. An apparatus according to claim 1,
wherein the information on the transmitter-specific phase relationship comprises transmitter status information, wherein the transmitter status information comprises at least one of:
information that the transmitter-specific phase relationship is not known and may change,
information that a phase difference between the two or more frequency components is not known, but is constant,
information that the phase difference between the two or more frequency components is known and constant and can be reported,
information that the phase difference between the two or more frequency components is known and may change versus time and can be reported,
information that the phase between the two or more frequency components is known and compensated before the transmit signal of the two or more frequency components leaves the transmitter,
information which indicates that the transmitter-specific phase relationship is defined by a transmit signal specification, if no compensation of the transmitter-specific phase relationship is needed; or
wherein the information on the receiver-specific phase relationship comprises receiver status information, wherein the receiver status information comprises at least one of:
information that the receiver-specific phase relationship is not known and may change,
information that a phase between the two or more frequency components is not known, but is constant,
information that the phase between the two or more frequency components is known and constant and can be reported,
information that the phase difference between the two or more frequency components is known and may change versus time and can be reported,
information that the phase difference between the two or more frequency components is known and is taken into account for further processing.

6-7. (canceled)

8. An apparatus according to claim 1,
wherein the apparatus is configured to determine a combined correlation depending on the transmit signal, depending on the received signal of each of the two or more frequency components, and depending on the phase relationship information;
wherein the apparatus is configured to use the combined correlation for determining the positioning information, or is configured to report the combined correlation to the other apparatus of the wireless communication system for determining the positioning information.

9. An apparatus according to claim 8,
wherein, for each frequency component of the two or more frequency components, the apparatus is configured to determine a phase-offset corrected version of the transmit signal and/or a phase-offset corrected version of the received signal of said frequency component depending on the phase relationship information, wherein the apparatus is configured to determine a transmit combination signal by summing or weighted summing the transmit signal or the phase-offset corrected version of the transmit signal of each of the two or more frequency components, wherein the apparatus is configured to determine a receive combination signal by summing or weighted summing the received signal or the phase-offset corrected version of the received signal of each of the two or more frequency components, and wherein the apparatus is configured to determine the combined correlation in the time domain or in the frequency domain by correlating the transmit combination signal and the receive combination signal; or
wherein, for each frequency component of the two or more frequency components, the apparatus is configured to determine a phase-offset corrected version of the transmit signal and/or a phase-offset corrected version of the received signal of said frequency component depending on the phase relationship information, and the apparatus is configured to determine a correlation signal for said frequency component by correlating the transmit signal or the phase-offset corrected version of the transmit signal of said frequency component and the received signal or a phase-offset corrected version of said frequency component, wherein the apparatus is configured to determine the combined correlation in the time domain or in the frequency domain by summing or weighted summing the correlation signal of each of the two or more frequency components; or
wherein the apparatus is configured to determine time-of-arrival information from the combined correlation being represented in the time domain by identifying a local maximum or a local minimum or a global maximum or a global minimum of the magnitude of the correlation signal, wherein a position of the local maximum or the local minimum depends on a time duration from a first point-in-time when the transmit signal of one of the two or more frequency components is transmitted by the transmitter until a second point-in-time when the received signal of said one of the two or more frequency components, which comprises the signal components originating from the transmission of said transmit signal in said frequency component, is received by the receiver; or
wherein the apparatus is configured to determine time-of-arrival information from the combined correlation being represented in the time domain by conducting rising edge detection; or
wherein the apparatus is configured to use the combined correlation to determine the distance and/or the distance change between the transmitter and the receiver and/or the position of the transmitter and/or the position of the receiver; or
wherein, if the transmitter-specific phase relationship is known or can be measured, the apparatus is configured to receive phase information on the transmitter-specific phase relationship for at least one frequency component of the two or more frequency components from the transmitter; or
wherein, if the receiver-specific phase relationship is known or can be measured, the apparatus is configured to transmit the receiver-specific phase information for at least one frequency component of the two or more frequency components to the other apparatus of the wireless communication system for determining the positioning information.

10-17. (canceled)

18. An apparatus according to claim 9,
wherein, for each of the two or more frequency components, the apparatus is configured to determine the correlation signal of said frequency component in a frequency domain such that said correlation signal comprises an indication of a phase response in the frequency domain; or
wherein, for each of the two or more frequency components, the apparatus is configured to calculate the correlation in the time domain or to transform the correlation signal of each of the two or more frequency components from the frequency domain to a time domain such that said correlation signal in the time domain comprises an indication of a channel response in the time domain; or
wherein the apparatus is configured to combine the correlation signals, being represented in the time domain, of the two or more frequency components to acquire the combined correlation; or
wherein the phase information on the transmitter-specific phase relationship for the at least one frequency component comprises a phase difference between each of the at least one frequency component and another one of the two or more frequency components, or comprises a phase difference of each of the at least one frequency component and a predefined phase; or
wherein, if the apparatus does not receive the phase information, the apparatus is configured to make the assumption that the received signal of the two or more frequency components are transmitted from a single antenna; or
wherein the phase information on the transmitter-specific phase relationship for the at least one frequency component varies over time, and the phase information on the transmitter-specific phase relationship for the at least one frequency component comprises, for a plurality of points-in-time, more than one phase differences between each of the at least one frequency component and another one of the two or more frequency components, or comprises more than one phase differences of each of the at least one frequency component and a predefined phase; or
wherein the apparatus is configured to use the phase information on the transmitter-specific phase relationship to determine the correlation signal for at least one frequency component of the two or more frequency components; or
wherein the phase information on the receiver-specific phase relationship for the at least one frequency component comprises a phase difference between each of the at least one frequency component and another one of the two or more frequency components, or comprises a phase difference of each of the at least one frequency component and a predefined phase; or
wherein the apparatus is configured to use the phase information on the receiver-specific phase relationship to determine the correlation signal for at least one frequency component of the two or more frequency components and/or for generating the combined correlation for the two or more frequency components.

19-24. (canceled)

25. An apparatus according to claim 1,
wherein, to determine the positioning information, the apparatus is configured to determine a time of arrival for each frequency component of the plurality of frequency components depending on the transmit signal or a phase-offset-corrected version of the transmit signal and depending on the received signal or a phase-offset-corrected version of the received signal of each of the two or more frequency components; or
wherein the apparatus is configured determine the positioning information using the phase-relationship information; or
wherein the apparatus is configured to determine the distance and/or the distance change between the transmitter and the receiver and/or the position of the transmitter and/or the position of the receiver, by determining a first estimation thereof depending on a round trip time concept and by determining the distance and/or the distance change between the transmitter and the receiver and/or the position of the transmitter and/or the position of the receiver by using one or several frequency components or by using a combined version thereof.

26-27. (canceled)

28. An apparatus according to claim 1,
wherein the apparatus comprises the receiver and is configured to receive a reporting on at least one of
capabilities with respect to a parallel transmission of the transmitter on at least two of the two or more frequency components,
capabilities for high accuracy frequency recovery and/or for achieving or for securing a stability of the transmitter,
a frequency offset resulting from Doppler shift,
latency between a frequency component switching and a coherent timing maintenance, and
support of parallel transmission of several sounding reference signals within one Orthogonal Frequency Division Multiplexing symbol,
wherein the apparatus is configured to determine the combined information depending on the reporting.

29. An apparatus according to claim 1,
wherein the transmitter is configured to use several component carriers or parts thereof and is configured to provide a synchronization status to an entity or to another apparatus, wherein the apparatus comprises the receiver, wherein the receiver is configured to apply the synchronization information to perform a measurement; or
wherein the apparatus comprises the receiver, wherein the receiver is configured to assume a full synchronization if the receiver is configured with multiple component carrier resources and does not receive the synchronization status.

30. (canceled)

31. An apparatus according claim 1,
wherein the phase relationship information depends on building blocks of the transmitter and/or receiver; or
wherein information on a transmitter-specific phase relationship or on a receiver-specific information is transmitted as additional information; or
wherein the transmitter-specific phase relationship and/or the receiver-specific phase relationship is constant; or
wherein the transmitter-specific phase relationship and/or the receiver-specific phase relationship changes over time; or
wherein the two or more frequency components are transmitted by the transmitter by different RF chains or different antennas; or
wherein a frequency relationship between the two or more frequency components depends on frequency offsets and/or an angle-of-arrival, and/or an angle-of-departure of the transmit signal; or
wherein the phase relationship information is encoded as:
one phase value per frequency component, wherein the phase value represents the mean value of the frequency response of the bandwidth limited signal, or
several phase values per frequency component, or
one or more phase difference values between frequency components, or one or several group delay values per frequency component, or
a group delay relative to a reference point, wherein the reference point is a group delay of another frequency component; or
wherein a phase or a group delay is represented as a distance or distance offset depending the wavelength of the signal.

32-38. (canceled)

39. An apparatus according to claim 1,
wherein the apparatus comprises the receiver and does not comprise the transmitter; or
wherein the apparatus comprises the receiver and does not comprise the transmitter, wherein the receiver comprises two or more oscillators, wherein the phase relationship information comprises information on a receiver-specific phase relationship between the two or more oscillators of the receiver used to demodulate the two or more frequency components.

40. (canceled)

41. An apparatus according to claim 39,
wherein the apparatus is a user equipment.

42. An apparatus according to claim 41,
wherein the apparatus comprises a transceiver, which comprises the receiver and another transmitter being different from said transmitter, wherein the other transmitter is configured for a plurality of transmission purposes; or
wherein the other transmitter is configured to transmit the phase-relationship information or the information derived from the phase-relationship information to another apparatus of the wireless communication system; or
wherein the other transmitter is configured to transmit another transmit signal to the receiver to allow or support positioning, wherein the other transmit signal is a reference signal or is a control signal or is a data signal.

43-44. (canceled)

45. An apparatus according to claim 1,
wherein the apparatus is a location management server or is configured to implement a location management function; or
wherein the apparatus is a base station; or
wherein the apparatus implements a subset of a base station, wherein the apparatus implements one or more location measurement functions.

46-47. (canceled)

48. An apparatus of a wireless communication system,
wherein the apparatus comprises a transmitter,
wherein, in each frequency component of two or more frequency components, the transmitter is configured to transmit a transmit signal in said frequency component, such that a receiver of the wireless communication system receives a signal as a received signal in said frequency component, wherein the received signal comprises signal portions originating from the transmitting of the transmit signal in said frequency component by the transmitter, wherein each of the two or more frequency components is a bandwidth limited signal comprising a center frequency, wherein the center frequency of each of the two or more frequency components is different from the center frequency of any other one of the two or more frequency components,
wherein the transmit signal is a reference signal or a control signal or a data signal, wherein the transmitter is configured to transmit phase-relationship information or information derived from the phase-relationship information to the receiver or to another apparatus of the wireless communication system for supporting to determine, at the other apparatus, information on a distance and/or a distance change between the transmitter and the receiver and/or a position of the transmitter and/or a position of the receiver;
wherein the phase relationship information comprises information on a transmitter-specific phase relationship between the two or more frequency components; or, if the phase-relationship information is not known, the phase relationship information comprises one or more default values to indicate a default phase relationship or comprises an indication that the phase-relationship information is not known.

49. An apparatus according to claim 48,
wherein, if the apparatus does not provide information on a synchronization status, the apparatus is expected to comprise a single transmission antenna for the two or more frequencies; or
wherein, if the apparatus does not provide information on a synchronization status, the apparatus is expected to comprise a single transmission antenna for the two or more frequencies, wherein the transmitter is configured to transmit the information on the transmitter-specific phase relationship to the receiver; or
wherein the information on the transmitter-specific phase relationship comprises transmitter status information, wherein the transmitter status information comprises at least one of:
information that the transmitter-specific phase relationship is not known and may change,
information that a phase difference for the two or more frequency components is not known, but is constant,
information that the phase difference for the two or more frequency components is known and constant and can be reported,
information that the phase difference for the two or more frequency components is known and may change versus time and the phase relationship versus time may be reported,
information that the phase difference for the two or more frequency components is known and considered as nearly ideal and/or compensated before the transmit signal of the two or more frequency components leaves the transmitter; or
wherein, if the transmitter-specific phase relationship is known or can be measured, the apparatus is configured to transmit phase information on the transmitter-specific phase relationship for at least one frequency component of the two or more frequency components to the receiver.

50-52. (canceled)

53. An apparatus according to claim 48,
wherein the transmitter is configured to use several component carriers or parts thereof and is configured to provide a synchronization status to an entity or to another apparatus; or
wherein the transmitter is configured to use several component carriers or parts thereof and is configured to provide a synchronization status to an entity or to another apparatus, wherein the synchronization status comprises information on group delay; or
wherein the apparatus is a base station, wherein the apparatus comprises a transceiver, which comprises the transmitter and another receiver being different from the receiver; or
wherein the apparatus implements a subset of a base station, wherein the apparatus implements one or more location measurement functions, wherein the apparatus comprises a transceiver, which comprises the transmitter and another receiver being different from the receiver.

54-58. (canceled)

59. An apparatus according to claim 48,
wherein the apparatus comprises a transceiver, which comprises the transmitter and another receiver being different from said receiver, wherein the other receiver is configured for a plurality of receiving purposes; or
wherein the apparatus comprises a transceiver, which comprises the transmitter and another receiver being different from said receiver, wherein the other receiver is configured for a plurality of receiving purposes, wherein the other receiver is configured to receive another transmit signal from the transmitter for positioning, wherein the other transmit signal is a reference signal or is a control signal or is a data signal; or
wherein the transmitter comprises two or more oscillators, the transmitter is configured to report the transmitter-specific phase relationship between the two or more oscillators of the transmitter used to modulate the two or more frequency components to the receiver or to another apparatus of the wireless communication system; or
wherein the transmit signal and the received signal of at least one of the two or more frequency components is a sounding reference signal or is a downlink positioning reference signal or is a channel state information reference signal; or
wherein the transmit signal of each of the two or more transmit signals is to be modulated by an Orthogonal Frequency Division Multiplexing modulator of the transmitter, wherein the received signal of each of the two or more received signals is to be demodulated by an Orthogonal Frequency Division Multiplexing demodulator; or
wherein at least two of the two or more frequency components are at least two bandwidth parts of a wideband carrier; or
wherein at least two frequency components of the two or more frequency components are assigned to at least two adjacent component carriers and each of the at least two adjacent component carriers comprises one or more of the at least two frequency components; or
wherein at least one frequency component of the two or more frequency components is related to a not adjacent component carrier; or
wherein the two or more frequency components are transmitted fully synchronized in frequency and phase; or
wherein the two or more frequency components are not synchronized, or
wherein the two or more frequency components are partially synchronized; or
wherein a gap between the frequency components is assigned to other component carrier.

60-84. (canceled)

85. A system comprising,
a first apparatus,
wherein, for each frequency component of two or more frequency components, a transmitter of the wireless communication system is configured to transmit, within said frequency component, a transmit signal of said frequency component, wherein the transmit signal is a reference signal or is a control signal or is a data signal or is a portion of the reference signal or of the control signal or of the data signal, and wherein a receiver of the wireless communication system is configured to receive, within said frequency component, the transmit signal of said frequency component, which has been transmitted by the transmitter, as a received signal of said frequency component,
wherein each frequency component of the two or more frequency components represents a bandwidth limited signal, which comprises one or more signal portions, and which exhibits a center frequency, wherein the center frequency of each of the two or more frequency components is different from the center frequency of any other one of the two or more frequency components,
wherein the first apparatus is configured to receive and/or to process and/or to transmit phase relationship information, wherein the phase relationship information comprises information on a transmitter-specific phase relationship between the two or more frequency components and/or comprises information on a receiver-specific phase relationship between the two or more frequency components, and
wherein the first apparatus is configured to use the phase-relationship information for determining positioning information, or is configured to report the phase-relationship information or information derived from the phase-relationship information to another apparatus of the wireless communication system for determining the positioning information; wherein the positioning information comprises information on a distance and/or a distance change between the transmitter and the receiver and/or a position of the transmitter and/or a position of the receiver; and
a second apparatus,
wherein the second apparatus comprises a transmitter,
wherein, in each frequency component of two or more frequency components, the transmitter is configured to transmit a transmit signal in said frequency component, such that a receiver of the wireless communication system receives a signal as a received signal in said frequency component, wherein the received signal comprises signal portions originating from the transmitting of the transmit signal in said frequency component by the transmitter, wherein each of the two or more frequency components is a bandwidth limited signal comprising a center frequency, wherein the center frequency of each of the two or more frequency components is different from the center frequency of any other one of the two or more frequency components, wherein the transmit signal is a reference signal or a control signal or a data signal,
wherein the transmitter is configured to transmit phase-relationship information or information derived from the phase-relationship information to the receiver or to another apparatus of the wireless communication system for supporting to determine, at the other apparatus, information on a distance and/or a distance change between the transmitter and the receiver and/or a position of the transmitter and/or a position of the receiver,
wherein the phase relationship information comprises information on a transmitter-specific phase relationship between the two or more frequency components; or, if the phase-relationship information is not known, the phase relationship information comprises one or more default values to indicate a default phase relationship or comprises an indication that the phase-relationship information is not known;
wherein, in each frequency component of two or more frequency components, the second apparatus is configured to transmit a transmit signal in said frequency component, and the first apparatus is configured to receive a signal as a received signal in said frequency component, wherein the received signal comprises signal portions originating from the transmitting of the transmit signal in said frequency component by the transmitter.

86-89. (canceled)

90. A method,
wherein, for each frequency component of two or more frequency components, a transmitter of the wireless communication system transmits, within said frequency component, a transmit signal of said frequency component, wherein the transmit signal is a reference signal or is a control signal or is a data signal or is a portion of the reference signal or of the control signal or of the data signal, and wherein a receiver of the wireless communication system receives, within said frequency component, the transmit signal of said frequency component, which has been transmitted by the transmitter, as a received signal of said frequency component,
wherein each frequency component of the two or more frequency components represents a bandwidth limited signal, which comprises one or more signal portions, and which exhibits a center frequency, wherein the center frequency of each of the two or more frequency components is different from the center frequency of any other one of the two or more frequency components,
wherein the method comprises receiving and/or processing and/or transmitting phase relationship information, wherein the phase relationship information comprises information on a transmitter-specific phase relationship between the two or more frequency components and/or comprises information on a receiver-specific phase relationship between the two or more frequency components, and
wherein the method comprises using the phase-relationship information for determining positioning information, or comprises reporting the phase-relationship information or information derived from the phase-relationship information to another apparatus of the wireless communication system for determining the positioning information; wherein the positioning information comprises information on a distance and/or a distance change between the transmitter and the receiver and/or a position of the transmitter and/or a position of the receiver.

91. A method,
wherein, in each frequency component of two or more frequency components, the method comprises transmitting, by a transmitter, a transmit signal in said frequency component, such that a receiver of the wireless communication system receives a signal as a received signal in said frequency component, wherein the received signal comprises signal portions originating from the transmitting of the transmit signal in said frequency component by the transmitter, wherein each of the two or more frequency components is a bandwidth limited signal comprising a center frequency, wherein the center frequency of each of the two or more frequency components is different from the center frequency of any other one of the two or more frequency components, wherein the transmit signal is a reference signal or a control signal or a data signal,
wherein the method comprises transmitting phase-relationship information or information derived from the phase-relationship information to the receiver or to another apparatus of the wireless communication system for supporting to determine, at the other apparatus, information on a distance and/or a distance change between the transmitter and the receiver and/or a position of the transmitter and/or a position of the receiver;
wherein the phase relationship information comprises information on a transmitter-specific phase relationship between the two or more frequency components; or, if the phase-relationship information is not known, the phase relationship information comprises one or more default values to indicate a default phase relationship or comprises an indication that the phase-relationship information is not known.

92. A non-transitory digital storage medium having a computer program stored thereon to perform the method, wherein the computer program is configured to implement the method of claim 90, when said computer program is run by a computer.

93. A non-transitory digital storage medium having a computer program stored thereon to perform the method, wherein the computer program is configured to implement the method of claim 91, when said computer program is run by a computer.

94. An apparatus according to claim 1,
wherein the transmit signal and the received signal of at least one of the two or more frequency components is a sounding reference signal or is a downlink positioning reference signal or is a channel state information reference signal; or
wherein the transmit signal of each of the two or more transmit signals is to be modulated by an Orthogonal Frequency Division Multiplexing modulator of the transmitter, wherein the received signal of each of the two or more received signals is to be demodulated by an Orthogonal Frequency Division Multiplexing demodulator; or
wherein at least two of the two or more frequency components are at least two bandwidth parts of a wideband carrier; or
wherein at least two frequency components of the two or more frequency components are assigned to at least two adjacent component carriers and each of the at least two adjacent component carriers comprises one or more of the at least two frequency components; or
wherein at least one frequency component of the two or more frequency components is related to a not adjacent component carrier; or
wherein a gap between the frequency components is assigned to other component carrier; or
wherein the two or more frequency components are transmitted fully synchronized in frequency and phase; or
wherein the two or more frequency components are not synchronized; or
wherein the two or more frequency components are partially synchronized.
